(19) United States
(12) Patent Application Publication
(10) Pub. No.: US 2026/0273453 A1
(43) Pub. Date: Sep. 17, 2026

(54) METHOD FOR THE BONDING, TRANSPORT, REACTION ACTIVATION, CONVERSION, STORAGE AND RELEASE OF WATER-SOLUBLE GASES

(71) Applicant: Ulrich Dietz, Wiesbaden (DE)

(72) Inventor: Ulrich Dietz, Wiesbaden (DE)

(21) Appl. No.: 19/554,099

(22) Filed: Mar. 2, 2026

Related U.S. Application Data
(63) Continuation of application No. 18/007,014, filed on Jul. 27, 2021, now abandoned.

(30) Foreign Application Priority Data
Jul. 27, 2020 (DE) 10 2020 004 542.1

(51) Int. Cl. B01D 53/14; B01D 53/62; B01D 53/96; B01D 61/42

(52) U.S. Cl. CPC B01D 53/1475; B01D 53/1425; B01D 53/62; B01D 53/965; B01D 61/422; B01D 2257/504

(57) ABSTRACT

The present invention relates to methods for selective binding, selective membrane transport and storage of carbon dioxide (CO₂) in aqueous media. The method of the present invention comprises providing an aqueous acceptor solution containing at least one acceptor compound having a free guanidino and/or amidino group, which is contacted with a gas containing carbon dioxide to bind the carbon dioxide in the acceptor solution. The acceptor solutions containing bound carbon dioxide obtained thereby are useful for storing carbon dioxide in aqueous media, for again releasing the carbon dioxide, and for use in electrochemical processes, such as electrodialysis, to selectively transport bound carbon dioxide through separation membranes into aqueous media. The present invention further relates to the preparation of carbonates starting from acceptor solutions containing bound carbon dioxide.

This application is a continuation of U.S. patent application Ser. No. 18/007,014, filed Jan. 26, 2023, which is a U.S. national stage application of PCT Patent Application No. PCT/EP2021/071081, filed Jul. 27, 2021, which claims priority to German Patent Application 102020004542.1 filed on Jul. 20, 2020, each of which is incorporated by reference in their entireties.

### FIELD

The present invention relates to methods for selective binding, selective membrane transport and storage of carbon dioxide (CO₂) in aqueous media. The method of the present invention comprises providing an aqueous acceptor solution containing at least one acceptor compound having a free guanidino and/or amidino group, which is contacted with a gas containing carbon dioxide to bind the carbon dioxide in the acceptor solution. The acceptor solutions containing bound carbon dioxide obtained thereby are useful for storing carbon dioxide in aqueous media, for re-releasing carbon dioxide, and for use in electrochemical methods, such as electrodialysis, to selectively transport bound carbon dioxide through separation membranes into aqueous media. The present invention further relates to the preparation of carbonates and hydrogen carbonates starting from acceptor solutions containing bound carbon dioxide.

### STATE OF THE ART

Gaseous elements or element molecules or gaseous molecular compounds are often sought-after starting materials for chemical synthesis. Therefore, attempts are made to obtain these elements or element molecules or compounds in pure form, often requiring a large technical effort or energy input. In the state of the art, methods for the recovery of technical gases by means of separation using separation membranes are known. In the case of air mixtures, very low concentrations of the gaseous elements or element molecules or gaseous molecular compounds to be separated are usually present. The separation efficiency is usually not in the desired range, especially if the elements or element molecules or gaseous molecular compounds involved differ only slightly from one another in terms of their physicochemical properties.

In the case of gaseous elements or element molecules or gaseous molecular compounds that can betaken up in a liquid, separation of gaseous elements or element molecules or gaseous molecular compounds that are not taken up/dissolved in the liquid or only to a small extent can be carried out. This is particularly the case if the gaseous element or element molecule or gaseous molecular compound in an aqueous medium leads to dissociation of water molecules and a water-soluble compound, e.g. an acid form, of the gaseous element or element molecule or gaseous compound is formed. This is the case, for example, with gaseous compounds of carbon and oxygen or sulfur and oxygen, such as carbon dioxide (CO₂) or sulfur dioxide (SO₂), where, for example, carbonic acid or sulfuric acid are formed in low concentrations in an aqueous medium. These gaseous molecular compounds such as carbon dioxide (CO₂) or sulfur dioxide (SO₂), which leads to dissociation of water molecules in an aqueous medium and forms a water-soluble acid form, are also referred to as acid gases in the prior art. Ionic or ionizable compounds, e.g. salts, can be separated with or from the liquid. For separation from an aqueous medium, methods such as electrodialysis using suitable membranes are known in the prior art. Electrodialysis is a method for separating ions in salt solutions. Desalination, separation and concentration of salts, acids and bases are the possible applications of the electrodialysis method. The necessary separation of ions is achieved by means of an electric field applied via an anode and a cathode and ion exchange membranes or semi-permeable, ion-selective membranes. Electrodialysis is thus an electrochemically driven membrane method in which ion exchange membranes are used in combination with an electrical potential difference to separate ionic compounds from, for example, uncharged solvents or impurities.

For example, electrodialysis devices are known from the prior art which consist of an alternating arrangement of anion and cation exchange membranes arranged between two electrodes, and wherein the externally attached electrodes are separated from the methods taking place on the membranes and are surrounded in a separate chamber by an electrically conductive, aqueous electrode solution which is electrolytically decomposed. Hydrogen gas is produced at the cathode and oxygen gas at the anode. The problem is that if the concentration of compounds of water-soluble gases dissolved in the liquid or gaseous compounds that react chemically with water on contact with it, such as carbonic acid or sulfur dioxide, is only low, the electrophoretic separation performance in the electrochemical method of electrodialysis is limited and there is an energetic loss due to the electrolysis of the water molecules that takes place simultaneously during electrodialysis. Furthermore, there is usually the problem that the receiving medium, i.e. the medium in which the compound to be separated, or its reaction product with water, is concentrated, must also be water-based in order to establish electrical conductivity, and the separated compound, or its reaction product with water, must first be returned to a gaseous state for use. Therefore, there is no method in the prior art in which a gas or gaseous compound is first dissolved in an aqueous medium and then selectively transported into another aqueous medium (receiving medium) in order to recover it as a gas phase or to be able to release it again as a gas or gaseous compound.

A well-known method for the purification of biogas from sulfur and carbon dioxide is so-called pressurized water scrubbing. In pressurized water scrubbing, water and the raw biogas are purified under pressure in an absorber using the countercurrent principle, whereby the gases to be separated and a small part of the methane contained dissolve in the scrubbing solution. However, a subsequent material utilization of e.g. CO₂ is not possible with pressurized water scrubbing.

Another well-known method for separating carbon dioxide, hydrogen sulfide and other acid gases from gas mixtures in natural gas processing is so-called amine scrubbing. In amine scrubbing, slightly alkaline aqueous solutions of amines, such as diethanolamine and monoethanolamine, but also methyldiethanolamine, diisopropylamine, diisopropanolamine and diglycolamine, which can reversibly chemically absorb acid gas components (chemisorption), are used. The gas to be purified is usually introduced into the aqueous amine solution at a pressure of approx. 8 bar and at temperatures of approx. 40° C. When CO₂ is absorbed in the amine/water mixture, the CO₂ first dissolves in the water and forms carbonic acid. The carbonic acid formed initially decomposes to H⁺ and HCO³⁻ ions. These can then react with the amine so that the absorbed CO₂ is chemically reversibly bound, forming carbamates that can be redissolved in a desorber. In the desorber, the chemical equilibrium is reversed at high temperature and low pressure, thus removing and releasing the bound acid gas from the amine solution. However, amine scrubbing has the particular disadvantage that the amines used in the method are harmful to health and are considered the third leading cause of workplace-related cancer.

Therefore, there is a great need for a method in which, on the one hand, a gaseous element or element molecule or gaseous compound, in particular carbon dioxide, is dissolved or absorbed in an aqueous liquid and brought into an ionized or ionizable state and then passed through a separation membrane by means of a diffusive or electrophoretic process step and transferred into a further aqueous medium (a receiving medium), whereby a gas and/or a reactive compound of the separated compound is present in the aqueous medium, which is reacted with another element or element molecule or compound or is released as a gas from the aqueous medium and separated. Preferably, the solubility and ionizability of the gaseous element or element molecule or gaseous compound should be increased in such a way that energy-efficient transport of the compound to be separated is made possible.

Thus, the task of the present invention is to provide a new method for the binding or absorption and subsequent storage of a gaseous element or element molecule or gaseous compound, especially acid gases and in particular carbon dioxide (CO₂), in aqueous media, as well as the recovery of pure gaseous elements or element molecules or gaseous compounds, especially carbon dioxide (CO₂). The task of the present invention therefore relates to the provision of methods for the dissolution/binding/transport/reaction activation/chemical conversion as well as selective release of a gaseous compound soluble in water, in particular carbon dioxide.

This task is solved according to the invention by the technical teachings of the independent claims. Further advantageous embodiments of the invention result from the dependent claims, the description, the FIGURES as well as the examples.

### DETAILED DESCRIPTION

Surprisingly, it was found that the task is solved by providing aqueous acceptor media containing organic acceptor compounds which have at least one amidino and/or guanidino group and simultaneously exhibit hydrophilic properties. It has been found that dissolution/binding/transport/reaction activation/chemical conversion as well as selective release of a water-soluble gaseous compound can be enabled thereby. In this context, water-soluble means that the gaseous substance/gaseous compound reacts chemically with water on contact therewith, e.g. to form an acid anhydride or an acid. It is then present in water as an organic or inorganic acid or, after dissociation in water, as the corresponding anion.

When gaseous compounds are brought into contact with water, water-soluble reaction products can be formed. In the case of carbon dioxide, reaction with water results in the formation of hydrogen carbonate (HCO₃⁻) and carbonate (CO₃²⁻), which are subsequently also referred to as carbon dioxide derivatives.

In the prior art, it is known that the solubility in water of gaseous elements or element molecules or gaseous compounds that react with water to form water-soluble derivatives can be increased by using alkaline solutions. This applies in particular to acid gases such as carbon dioxide or sulfur dioxide.

In the prior art, for the preparation of alkaline solutions, alkaline solutions of alkali and earth alkali metals are used, e.g. aqueous solutions of sodium hydroxide or potassium hydroxide. Using these compounds to dissolve and absorb gaseous compounds in an aqueous medium, leads to the formation of carbonates or hydrogen carbonates (the salts of carbonic acid) in the presence of carbon dioxide, and these precipitate as solids, such as calcium carbonate, which is practically insoluble in water. This is undesirable if the gaseous compound that has passed into the aqueous solution is to be recovered in a pure and gaseous state.

It is also known from the prior art that compounds which contain tertiary or quaternary nitrogen compounds and are suitable for creating a basic environment in an aqueous medium, such as ammonia, also improve the solubility of gases and gaseous compounds in an aqueous medium. The disadvantage here is that the tertiary or quaternary nitrogen compounds present in the prior art are electrokinetically transported toward the cathode in aqueous solution in the DC electric field. Therefore, they are unsuitable for performing electrophoretic separation, such as in an electrochemical process like electrodialysis.

Surprisingly, it has been found that it is possible to enhance the reaction of gases/gaseous compounds with water, leading to the formation of water-soluble compounds of the gas/gaseous compound, by using basic amino acids dissolved in an aqueous acceptor medium. As used herein, basic amino acids are defined as amino acids having an amino group or N atoms with free electron pairs in the amino acid residue (side chain). If these N atoms accept a proton, a positively charged side chain is formed. The amino acids histidine, lysine and arginine belong to the basic amino acids. Preferred herein according to the invention are basic amino acids which bear at least one guanidino and/or amidino group, such as arginine. When using aqueous solutions of amino acids which have at least one guanidino and/or amidino group and which dissolve readily in an aqueous medium and accept or are capable of accepting a proton, which are present dissociated in the aqueous solution, as well as by the dissolution of which in water a basic pH is established, it was documented that a very rapid uptake of gaseous carbon dioxide occurred in such solutions when a gas or gas mixture was brought into contact with such an acceptor solution. It was also found that one hydrogen carbonate anion or carbonate anion is bound per guanidino or amidino group. Surprisingly, when the pH of the solution is >8, there is only a very low dissociation rate of the bound hydrogen carbonate anions or carbonate anions, so that pressurization of the aqueous acceptor medium with a gas consisting of or containing carbon dioxide is not necessary to bind carbonate/hydrogen carbonate anions rapidly and completely. Thus, water-soluble compounds having one or more free guanidino and/or amidino group(s) can be used, on the one hand, to achieve very good dissolution or absorption of carbon dioxide in an aqueous medium and, at the same time, to ensure very stable binding of carbonate/hydrogen carbonate anions to free guanidino/amidino groups. It was shown that these properties of the acceptor media according to the invention can also be used to dissolve and bind other organic and inorganic gases/gaseous compounds, such as hydrogen sulfide or chlorine gas. In this way, the absorption capacity of gases/gas mixtures that are soluble in water and react with it to form water-soluble compounds can be significantly increased. In particular, the uptake capacity for carbon dioxide in water can be significantly increased by the presence of water-soluble compounds bearing one or more free guanidino and/or amidino group(s). Thereby, the uptake into the aqueous medium, the reaction with water as well as the binding of carbon dioxide and its derivatives in water is increased or accelerated.

Thus, compounds containing at least one free guanidino and/or amidino group were found to have reaction-promoting and binding properties towards carbon dioxide and its derivatives in water (carbonate/hydrogen carbonate anions). The physicochemical interactions that are effected between carbon dioxide or its derivatives in water and compounds having at least one free guanidino and/or amidino group give the compounds bearing at least one free guanidino and/or amidino group acceptor properties that allow both dissolution and binding, as well as reaction promotion and chemical conversion, and also storage of carbon dioxide or its derivatives in water. Compounds having a free guanidino and/or amidino group are therefore hereinafter called acceptor compounds and a medium in which at least one compound having at least one free guanidino and/or amidino group is present is hereinafter called acceptor medium.

Therefore, an aqueous solution in which at least one compound having at least one free guanidino and/or amidino group is present and which is present in dissolved form can be used to provide an acceptor solution.

Preferred herein is a method in which the solubility of a gaseous compound is increased in an aqueous acceptor medium, i.e., an acceptor solution. Particularly preferred herein is a method wherein the gaseous compound is carbon dioxide. According to the invention, an aqueous acceptor medium, i.e. an acceptor solution containing at least one acceptor compound having a free guanidino and/or amidino group, is provided which has the technical effect of increasing the solubility of a gaseous compound, in particular carbon dioxide. The term solubility in this context refers to the dissolving of water-soluble gases that chemically react with water upon contact therewith, such as acid gases that form an acid or weak acid when dissolved in water.

Preferred is a method in which an aqueous acceptor solution is provided containing at least one acceptor compound having at least one free guanidino and/or amidino group and is contacted with a gas or gas mixture. Therefore, the present invention more particularly relates to a method wherein an aqueous acceptor solution containing at least one acceptor compound having a free guanidino and/or amidino group is provided and the aqueous acceptor solution is contacted with a gas or gas mixture containing carbon dioxide to bind the carbon dioxide from the gas or gas mixture.

Preferred is a method in which an aqueous acceptor medium, i.e. an acceptor solution, and a gas/gas mixture containing at least one gaseous compound that dissolves in water to form an acid and/or an anion are contacted, wherein the at least one gaseous compound that dissolves in water to form an acid and/or an anion is bound by the at least one acceptor compound present in the acceptor medium, i.e. in the acceptor solution.

Preferred is a method for increasing the solubility and binding of gases that form an acid/anionic compound in water and/or are present in anionic form, i.e. acidic gases, in an aqueous acceptor medium, wherein at least one acceptor compound is present that is a hydrophilic organic compound having at least one amidino and/or guanidino group. Preferred is a method in which gaseous compounds in an aqueous acceptor medium are anionically bound to the acceptor compound. Anionically means that the bound gaseous compound dissociates in the acceptor solution and is present in the aqueous solution as an anion and the acceptor compound is protonated and forms the counter ion. According to the invention, the acceptor compound has a free guanidino and/or amidino group that can be protonated to provide the cation as the counter ion to the anion of the gaseous compound in the acceptor solution.

The method of the present invention therefore comprises at least the steps of:
(a) providing an aqueous acceptor solution comprising at least one acceptor compound having a free guanidino and/or amidino group; and
b) contacting a gas comprising carbon dioxide with the acceptor solution of step a).

Preferred is a method in which at least one hydrophilic organic compound having at least one amidino and/or guanidino group is present in an aqueous acceptor medium to dissolve, neutralize and bind gaseous compounds that form acids upon contact with water or are present herein in anionic form and/or to contact and react the compound with other compounds or to selectively release the bound gaseous compound as a gas. Preferred is a method in which at least one hydrophilic organic compound having at least one amidino and/or guanidino group is present in an aqueous acceptor medium to dissolve, neutralize and bind acidic gases, in particular carbon dioxide. Furthermore, the aqueous acceptor medium containing the bound acid gases, in particular carbon dioxide, can be brought into contact with other compounds in order to convert the bound acid gases, in particular carbon dioxide, for example, in the case of carbon dioxide, into carbonates or hydrogen carbonates which are insoluble in water or sparingly soluble in water, or to selectively release the bound acid gases, in particular carbon dioxide, as a gas, in particular as gaseous carbon dioxide.

The present invention therefore relates to a method for selectively binding and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing the acceptor solution containing bound carbon dioxide/carbon dioxide derivatives from step b).

Preferred embodiments comprise step c):
c) storing the acceptor solution containing bound carbon dioxide/carbon dioxide derivatives from step b) at atmospheric pressure.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium.

Alternatively formulated, the present invention therefore relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting carbonate/hydrogen carbonate anions in the acceptor solution of step b) through a separation membrane into an aqueous uptake and release medium.

The present invention preferably relates to a method for selective binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium,
c2) releasing carbon dioxide as a gas phase from the uptake and release medium containing bound carbon dioxide/carbon dioxide derivatives of step c).

Alternatively formulated, the present invention therefore relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting carbonate/hydrogen carbonate anions in the acceptor solution of step b) through a separation membrane into an aqueous uptake and release medium.
c2) releasing carbon dioxide as a gas phase from the uptake and release medium containing carbonate/hydrogen carbonate anions of step c).

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) contacting the acceptor solution of step b) containing bound carbon dioxide/carbon dioxide derivatives with a reaction compound.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; and
d2) adding a reaction compound to the uptake and release medium containing bound carbon dioxide/carbon dioxide derivatives from step c).

Alternatively formulated, the present invention therefore relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting carbonate/hydrogen carbonate anions in the acceptor solution of step b) through a separation membrane into an aqueous uptake and release medium.
d2) adding a reaction compound to the uptake and release medium containing carbonate/hydrogen carbonate anions from step c).

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or storing the acceptor solution containing bound carbon dioxide/carbon dioxide derivatives from step b).

Alternatively formulated, the present invention therefore relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing the acceptor solution containing bound carbon dioxide/carbon dioxide derivatives from step b); and/or
transporting bound carbon dioxide/carbon dioxide derivatives in the acceptor solution of step b) through a separation membrane into an aqueous uptake and release medium.

The present invention therefore preferably relates to methods for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a);
c) transporting bound carbon dioxide/carbon dioxide derivatives in the acceptor solution of step b) through a separation membrane into an aqueous uptake and release medium; or
storing the acceptor solution containing bound carbon dioxide/carbon dioxide derivatives from step b); and
c2) releasing carbon dioxide as a gaseous phase from the uptake and release medium containing bound carbon dioxide/carbon dioxide derivatives from step c); or
d2) adding a reaction compound to the uptake and release medium containing bound carbon dioxide/carbon dioxide derivatives from step c).

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing the acceptor solution containing bound carbon dioxide/carbon dioxide derivatives from step b); and/or
transporting bound carbon dioxide/carbon dioxide derivatives in the acceptor solution of step b) through a separation membrane into an aqueous uptake and release medium; and
c2) releasing carbon dioxide as a gas phase from the uptake and release medium containing bound carbon dioxide/carbon dioxide derivatives of step c); or
d2) adding a reaction compound to the uptake and release medium containing bound carbon dioxide/carbon dioxide derivatives from step c).

Preferred is a method for dissolving carbon dioxide in an aqueous medium to form carbonate/hydrogen carbonate anions, in which stable physicochemical bonding of the resulting carbonate/hydrogen carbonate anions in the aqueous acceptor medium is established simultaneously.

Preferred is a method in which the dissolution of carbon dioxide as well as the bonding of the carbonate/hydrogen carbonate anion formed thereby is effected through/at free guanidino and/or amidino groups in an aqueous acceptor medium.

Preferred is a method in which the water-soluble acceptor compounds are compounds bearing free guanidino and/or amidino groups which, when dissolved in water, accept or are capable of accepting at least one proton.

Preferred is a method in which the water-soluble acceptor compounds are amino acids having at least one guanidino and/or amidino group and are capable of binding or accepting at least one proton in aqueous solution.

Preferred is a method in which the water-soluble acceptor compounds for dissolving carbon dioxide and for binding and transporting carbon dioxide, or its derivatives in water, and the carbonate/hydrogen carbonate anions formed thereby are arginine and/or arginine derivatives.

Particularly preferred is therefore a method wherein the at least one acceptor compound having a free guanidino and/or amidino group is an arginine derivative or most preferably arginine. Acceptor solutions containing at least one arginine derivative or most preferably arginine have been found to be particularly advantageous and effective for the binding and storage of carbon dioxide in an aqueous medium.

Surprisingly, it has been found that it is possible to completely remove carbon dioxide contained in a gas mixture from the gas mixture using the methods of the invention.

Complete removal means that after contacting a gas mixture containing carbon dioxide with an acceptor solution, the content of carbon dioxide in the treated gas/gas mixture is <1 ppm.

The contacting of the gas or gas mixture with the aqueous acceptor medium can be carried out in various process embodiments known in the prior art. For example, the contacting of the two phases may be accomplished by introducing the gas phase into the liquid phase, or the gas phase may be passed over a surface wetted with the liquid phase. In a preferred method embodiment, methods for bringing the gas and liquid phases into contact are used that effect a very large interface between the phases. These are devices such as homogenizers/dynamic mixers, but also static mixers, as well as packed gas scrubbing devices.

Preferred is a method in which a gas/gas mixture is contacted with an acceptor medium.

Preferred is a method in which contacting a gas/gas mixture with an acceptor medium causes the carbon dioxide content therein to dissolve completely in the acceptor medium and to be bound therein.

Preferred is a method in which, by bringing a gas/gas mixture into contact with an acceptor medium, the proportion of carbon dioxide present therein and/or the reaction products of carbon dioxide with water is/are completely bound by an acceptor compound.

A preferred method is one in which a large interface is established between the aqueous acceptor medium and the gas phase containing carbon dioxide.

In particular, the enormous advantage resulting from the stable bonding between the free guanidino and/or amidino groups and the carbonate/hydrocarbonate anions is that, despite a high concentration of dissolved carbon dioxide in the acceptor medium, re-dissociation to the gaseous state does not occur, so that pressurization of the acceptor medium is not required to maintain a high concentration of dissolved carbon dioxide, or its reaction products with water.

Preferred is a method in which the dissolving and binding of carbon dioxide, as well as of its derivatives, is performed without pressurization of the acceptor solution. Preferred is a method in which the dissolving and binding of carbon dioxide is performed at atmospheric pressure. Preferred is a method in which the dissolving and binding of carbon dioxide is achieved without overpressure. According to standards, the mean atmospheric pressure (atmospheric pressure) at sea level is 101,325 Pa=101.325 kPa=1013.25 hPa≈1 bar. Preferred is a method in which the dissolving and binding of carbon dioxide occurs at normal pressure. Preferred is a method in which the dissolving and binding of carbon dioxide is achieved at normal pressure of 101.325 kPa. Preferred is a method in which the dissolving and bonding of carbon dioxide is performed without pressure.

Preferred embodiments of the method according to the invention comprise step b):
b) contacting a gas comprising carbon dioxide with the acceptor solution from step a), wherein the contacting in step b) is performed at normal pressure or atmospheric pressure.

Preferred embodiments of the method according to the invention comprise step b):
b) contacting a gas comprising carbon dioxide with the acceptor solution from step a), wherein the contacting in step b) is performed at normal pressure.

Preferred embodiments of the method according to the invention comprise step b):
b) contacting a gas comprising carbon dioxide with the acceptor solution of step a), wherein the contacting in step b) is performed at atmospheric pressure.

Preferred embodiments of the method according to the invention comprise the step b):
b) contacting a gas comprising carbon dioxide with the acceptor solution of step a), wherein the contacting in step b) is performed without pressurization.

Preferred embodiments of the method according to the invention comprise step b):
b) contacting a gas comprising carbon dioxide with the acceptor solution from step a), wherein the contacting in step b) is performed without pressurization.

Here, contacting at normal pressure or at atmospheric pressure or without pressurization means that the acceptor solution is provided under normal pressure or atmospheric pressure or without pressurization.

The present invention preferably relates to a method for selectively binding, transporting and storing carbon dioxide in aqueous media, comprising the steps of:
a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or
storing the acceptor solution containing bound carbon dioxide/carbon dioxide derivatives from step b),
wherein the contacting in step b) is at atmospheric pressure and/or wherein the acceptor solution from step c) is stored at atmospheric pressure. Preferred embodiments are wherein the contacting in step b) is at atmospheric pressure; and wherein the acceptor solution from step c) is stored at atmospheric pressure.

Preferably, the present invention relates to a method for selectively binding, transporting and storing carbon dioxide in aqueous media comprising the steps of:
(a) providing an aqueous acceptor solution containing at least one acceptor compound having a free guanidino and/or amidino group;
b) contacting a gas containing carbon dioxide with the acceptor solution of step a); and
c) storing the acceptor solution containing bound carbon dioxide/carbon dioxide derivatives from step b); and/or
transporting bound carbon dioxide/carbon dioxide derivatives in the acceptor solution of step b) through a separation membrane into an aqueous uptake and release medium,
wherein the contacting in step b) is performed at atmospheric pressure and/or wherein the acceptor solution from step c) is stored at atmospheric pressure. Preferred embodiments are wherein the contacting in step b) is performed at atmospheric pressure and wherein the acceptor solution from step c) is stored at atmospheric pressure.

This aspect of the invention gives rise to further particularly advantageous effects for further method embodiments. For example, it is possible to store the carbon dioxide absorbed in the acceptor solution, or its reaction products with water, without pressure (i.e. unpressurized), i.e. without positive pressure, or at atmospheric pressure or normal pressure, for a period of >6 months without loss. Thus, the non-corrosive acceptor solution containing bound carbon dioxide, or its reaction products with water, can be stored hazard-free and transported in containers. Here, transporting means transferring the acceptor solution containing bound carbon dioxide into a transportable vessel, such as a large tank, container or barrel, etc. Suitable transport containers for transporting liquids are well known to the skilled person. The hazard-free storage and transport here does not refer to transporting the bound carbon dioxide/carbon dioxide derivatives in the acceptor solution containing bound carbon dioxide through a separation membrane into an aqueous uptake and release medium. Transporting the bound carbon dioxide/carbon dioxide derivatives in the acceptor solution containing bound carbon dioxide through a separation membrane into an aqueous uptake and release medium may therefore also be referred to herein as membrane transport.

Preferred is a method in which the dissolving and binding of gaseous carbon dioxide as well as reaction products thereof with water is performed without pressurization of the acceptor solution. Preferred is a method in which the dissolving and binding of gaseous carbon dioxide, as well as its reaction products with water into the acceptor solution is performed at atmospheric pressure or at normal pressure.

Preferred is a method in which the contacting of a gas containing carbon dioxide with the acceptor solution is performed without pressure (i.e. unpressurized). Preferred is a method in which the contacting of a gas comprising carbon dioxide with the acceptor solution is performed at atmospheric pressure.

Preferred is a method in which the storage and/or transport (in a transport container) of the acceptor solution, containing dissolved and bound carbon dioxide, or reaction products thereof with water, is performed without pressure. Preferably, a method in which the storage and/or transport (in a transport container) of the acceptor solution, containing dissolved and bound carbon dioxide, or reaction products thereof with water, is performed at atmospheric pressure.

The present invention preferably relates to a method for selective binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing and/or transporting the acceptor solution containing bound carbon dioxide from step b) in a storage container and/or transport container,
wherein it is preferred herein that the contacting in step b) is performed at atmospheric pressure and/or wherein the acceptor solution from step c) is stored and/or transported at atmospheric pressure in the storage container and/or the transport container.

Furthermore, preferred embodiments are wherein the contacting in step b) is performed at atmospheric pressure and wherein the acceptor solution from step c) is stored or transported in the storage container and/or the transport container at atmospheric pressure.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or
storing and/or transporting the acceptor solution containing bound carbon dioxide/carbon dioxide derivatives from step b),
wherein it is preferred herein that the contacting in step b) is performed at atmospheric pressure and/or wherein the acceptor solution from step c) is stored and/or transported at atmospheric pressure in a storage container and/or a transport container. Further preferred are embodiments wherein the contacting in step b) is performed at atmospheric pressure and wherein the acceptor solution from step
c) is stored or transported at atmospheric pressure in the storage container and/or the transport container.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing and/or transporting the acceptor solution containing bound carbon dioxide/carbon dioxide derivatives from step b); and/or
transporting bound carbon dioxide/carbon dioxide derivatives in the acceptor solution of step b) through a separation membrane into an aqueous uptake and release medium,
wherein it is preferred herein that the contacting in step b) is performed at atmospheric pressure and/or wherein the acceptor solution from step c) is stored or transported at atmospheric pressure in a storage container and/or a transport container. Further preferred are embodiments wherein the contacting in step b) is performed at atmospheric pressure and wherein the acceptor solution from step c) is stored or transported in the storage container and/or the transport container at atmospheric pressure.

Nevertheless, contacting the acceptor medium with the gas/gas mixture containing carbon dioxide, which is performed while pressurizing the gas/gas mixture, can increase the amount of carbon dioxide that is dissolved and bound per unit of time.

Therefore, in another preferred embodiment, enrichment or saturation of the aqueous acceptor solution containing guanidino and/or amidino group-bearing compounds with dissolved carbon dioxide is performed in an enrichment device that allows pressurization. Thereby enabling acceleration of the enrichment or of reaching the point at which saturation has is accomplished. The presence of saturation of the acceptor medium with carbon dioxide can be detected, for example, by an increase in the concentration of carbon dioxide in the gas mixture that has passed through the enrichment device and is exiting. Surprisingly, it has been found that if there is an excess of free guanidino and/or amidino groups of the acceptor compounds, relative to carbon dioxide molecules in a gas/gas mixture, in the aqueous acceptor medium, there is complete or near complete depletion of carbon dioxide when the gas phase is contacted with the acceptor medium for a sufficiently long time. In this context, almost complete means a concentration/portion of </=100 ppm.

In this respect, the method is directed to a complete or nearly complete extraction of carbon dioxide from a gas/gas mixture.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group in an enrichment device that allows pressurization;
b) contacting a gas containing carbon dioxide with the acceptor solution of step a), wherein the contacting in step b) is performed under pressurization, preferably until the acceptor solution is saturated with carbon dioxide.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or storing the acceptor solution containing bound carbon dioxide/carbon dioxide derivatives from step b),
wherein the acceptor solution of step a) is provided in an enrichment device that allows pressurization; and
the contacting in step b) is performed under pressurization, preferably until the acceptor solution is saturated with carbon dioxide.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing the acceptor solution containing bound carbon dioxide/carbon dioxide derivatives from step b); and/or
transporting bound carbon dioxide/carbon dioxide derivatives in the acceptor solution of step b) through a separation membrane into an aqueous uptake and release medium,
wherein the acceptor solution of step a) is provided in an enrichment device that allows pressurization; and
the contacting in step b) is performed under pressurization, preferably until the acceptor solution is saturated with carbon dioxide.

Preferred is a method in which a gas/gas mixture containing carbon dioxide is contacted with the acceptor solution until the gas reaches a carbon dioxide concentration of <100 ppm.

Preferred is a method in which a gas/gas mixture containing carbon dioxide is contacted with the acceptor solution until a carbon dioxide concentration of the gas of <100 ppm is reached, wherein the contacting is performed under pressure.

Preferred is a method in which a gas containing carbon dioxide is contacted with the acceptor solution, in which there is an excess of free guanidino and/or amidino groups of the acceptor compounds relative to the number of carbon dioxide molecules present in the gas/gas mixture, until a carbon dioxide concentration of the gas of <100 ppm is reached.

However, as shown below, the method can also be used to convert the extracted and bound carbon dioxide as well as its derivatives. For this purpose, it is advantageous if the concentration/content of carbon dioxide and/or the carbon dioxide derivatives in water is as high as possible. Therefore, it is preferred to contact an acceptor medium with a gas/gas mixture containing or consisting of carbon dioxide until no further uptake is achieved herein, i.e., until the acceptor medium is saturated with carbon dioxide. This can be recognized, for example, by the fact that in the gas/gas mixture that has been brought into contact with the acceptor medium, the content of carbon dioxide increases again, e.g. to >100 ppm. Thus, the acceptor medium's absorption capacity is exhausted and the acceptor medium is saturated with carbon dioxide.

Preferred is a method for saturating an acceptor medium with carbon dioxide and/or carbonate and/or bicarbonate anions, in which a contacting of the acceptor medium with a gas/gas mixture is performed until the concentration of carbon dioxide in the gas/gas mixture that has been contacted with the acceptor medium increases to >100 ppm.

Preferred is an acceptor medium saturated with carbon dioxide. In preferred embodiments, an acceptor solution saturated with carbon dioxide is obtained in step b) of the method according to the invention.

In a preferred embodiment, following an enrichment phase in which a pressure increased relative to atmospheric pressure has been applied to the gas/gas mixture for saturating an acceptor medium herewith, a depressurization phase is performed in which, under atmospheric pressure or under only slightly increased or decreased pressure, degassing of dissolved gaseous compounds is accomplished which are not intended to be separated or which could interfere with a reaction step that takes place in the further course, such as, for example, nitrogen or oxygen or methane. Surprisingly, it has been found that, even when a negative pressure of 100 mbar is applied, carbon dioxide, or its reaction products with water, is not desorbed or is not released from the solution following saturation of the aqueous acceptor medium with carbon dioxide, although this has been accomplished under elevated pressure. In a preferred embodiment, after contacting the aqueous acceptor medium with a gas/gas mixture containing carbon dioxide, which has been accomplished at atmospheric pressure or an overpressure, removal of gaseous compounds from an aqueous acceptor medium other than carbon dioxide is effected by depressurizing to atmospheric pressure and/or applying a negative pressure to the aqueous acceptor medium. In a preferred embodiment, gases/gas components that do not correspond to carbon dioxide, or its reaction products with water, are removed from the aqueous acceptor medium by depressurizing or applying a reduced (negative) pressure.

In this embodiment, the selective separation of carbon dioxide preferably is performed following the expansion phase. Preferred is a method in which the contacting of a gas/gas mixture with an aqueous acceptor medium is performed under atmospheric pressure or elevated pressure and in which gases/gas components that do not correspond to carbon dioxide are subsequently allowed to escape or are extracted in an expansion phase that is performed under atmospheric pressure or negative pressure.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group in an enrichment device that allows pressurization;
b) contacting a gas comprising carbon dioxide with the acceptor solution of step a), wherein the contacting in step b) is performed under pressurization, preferably until the acceptor solution is saturated with carbon dioxide; and
b′) depressurizing the acceptor solution containing bound carbon dioxide/carbon dioxide derivatives from step b) at atmospheric pressure or at reduced pressure.

Alternatively formulated, the present invention therefore relates to a method for selectively binding and storing carbon dioxide in aqueous media, comprising the steps of:
(a) providing an aqueous acceptor solution containing at least one acceptor compound having a free guanidino and/or amidino group in an enrichment device that allows pressurization;
b) contacting a gas comprising carbon dioxide with the acceptor solution of step a) under pressurization; and
b′) subjecting the acceptor solution that contains bound carbon dioxide/carbon dioxide derivatives from step b) to atmospheric pressure or reduced pressure.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or
storing the acceptor solution containing bound carbon dioxide/carbon dioxide derivatives from step b),
wherein the acceptor solution of step a) is provided in an enrichment device that allows pressurization; and
the contacting in step b) is performed under pressurization, preferably until the acceptor solution is saturated with carbon dioxide,
wherein the method further comprising step b) after step b):
b′) depressurizing the acceptor solution from step b) containing bound carbon dioxide/carbon dioxide derivatives at atmospheric pressure or at reduced pressure.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) storing the acceptor solution containing bound carbon dioxide/carbon dioxide derivatives from step b); and/or
transporting bound carbon dioxide/carbon dioxide derivatives in the acceptor solution of step b) through a separation membrane into an aqueous uptake and release medium,
wherein the acceptor solution from step a) is provided in an enrichment device that allows pressurization; and
the contacting in step b) is performed under pressurization, preferably until the acceptor solution is saturated with carbon dioxide,
wherein the method further comprising step b) after step b):
b′) depressurizing the acceptor solution from step b) containing bound carbon dioxide/carbon dioxide derivatives at atmospheric pressure or at reduced pressure.

In a preferred embodiment, subsequent to contacting a gas/gas mixture containing carbon dioxide with the acceptor solution, the carbon dioxide dissolved in the aqueous acceptor medium, or its reaction products with water, is released as a gas phase.

In general, electrolysis involves conducting a direct electric current via two electrodes through a conducting liquid (electrolyte solution). At the electrodes, electrolysis reaction products are produced from the substances contained in the electrolyte. Surprisingly, it was found that by applying a DC voltage to an aqueous acceptor medium to which carbon dioxide has been added, carbon dioxide is released at both electrodes in the form of gas bubbles. It has been found that this allows the entire content of (bound) carbon dioxide, or its reaction products with water, to be removed/released from the aqueous acceptor medium.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c1) releasing carbon dioxide as a gas phase from the acceptor solution containing bound carbon dioxide/carbon dioxide derivatives from step b).

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c1) releasing carbon dioxide as a gas phase from the acceptor solution containing bound carbon dioxide/carbon dioxide derivatives from step b) by applying a DC voltage to the acceptor solution from step b).

Thus, a preferred embodiment relates to a method for selectively binding and releasing carbon dioxide in aqueous media comprising the steps of:
(a) providing an aqueous acceptor solution containing at least one acceptor compound having a free guanidino and/or amidino group;
b) contacting a gas containing carbon dioxide with the acceptor solution from step a); and
c1) releasing carbon dioxide as a gas phase from the acceptor solution containing bound carbon dioxide/carbon dioxide derivatives from step b) by electrolysis.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a);
c) transporting bound carbon dioxide/carbon dioxide derivatives in the acceptor solution of step b) through a separation membrane into an aqueous uptake and release medium; and
c2) releasing carbon dioxide as a gas phase from the uptake and release medium containing bound carbon dioxide/carbon dioxide derivatives of step c) by applying a DC voltage to the uptake and release medium of step c).

Preferred is a method in which an aqueous acceptor medium is contacted and loaded with carbon dioxide and subsequently the carbon dioxide dissolved/bound in the acceptor medium, or its reaction products with water, is released as carbon dioxide gas by applying a DC voltage to the acceptor medium.

As expected, oxygen is released at the anode and hydrogen at the cathode in addition to carbon dioxide. Surprisingly, it was then found that carbon dioxide can be made available as a high-purity gas phase by using an electrophoretic method to spatially separate the carbonate/hydrogen carbonate anions present in the acceptor solution therefrom and then releasing carbon dioxide by water segregation (separation of water).

It was found that electrophoretic separation of the carbon dioxide dissolved and bound in the aqueous acceptor medium, or of the carbonate/hydrogen carbonate anions, can be accomplished by means of electrodialysis devices available in the prior art.

It was further found that open-pore membranes are suitable to allow electrophoretic passage of dissolved carbon dioxide, or carbonate/hydrogen carbonate anions. In this method, the dissolved carbon dioxide, or carbonate/hydrogen carbonate anions, are electrophoretically transported toward the anode. When a DC electrical voltage is applied to the electrodes, anions migrate to the anode and the anions can pass through a positively charged anion exchange membrane.

It was found that the following experimental arrangement using an electrodialysis unit is particularly suitable for obtaining gaseous carbon dioxide in its purest form: cathode chamber/chamber for receiving the acceptor solution (hereinafter referred to as the acceptor chamber)/chamber in which the release of carbon dioxide is performed in the form of a gas phase (hereinafter referred to as the uptake and release chamber)/anode chamber.

In order to accomplish an electrophoretic separation of dissolved carbon dioxide and its derivatives from the acceptor solution, the acceptor chamber is to be connected on the anode side by an electrically conductive medium to the uptake and release chamber, in which the transported compounds are preferably taken up and/or a release or reaction of these is accomplished. The medium present in the uptake and release chamber is preferably an aqueous solution and is subsequently referred to as the uptake and/or release medium.

Thus, a preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution from step b) through a separation membrane into an aqueous uptake and release medium,
wherein the acceptor solution from step b) is in or is introduced into an acceptor chamber of an electrodialysis device; and
wherein transporting the carbon dioxide/derivatives of step c) is accomplished by means of an electrical gradient established between the acceptor chamber and an uptake and release chamber,
wherein the acceptor chamber and the uptake and release chambers are separated from each other by the separation membrane.

Thus, a preferred embodiment of the present invention relates to a method for selectively binding, transporting and storing carbon dioxide in aqueous media, comprising the steps of:
a) providing an aqueous acceptor solution containing at least one acceptor compound having a free guanidino and/or amidino group;
b) contacting a gas containing carbon dioxide with the acceptor solution of step a); and
c) transporting carbonate/hydrogen carbonate anions from the acceptor solution of step b) through a separation membrane into an aqueous uptake and release medium,
wherein the acceptor solution from step b) is in or is introduced into an acceptor chamber of an electrodialysis apparatus; and
wherein transporting the carbonate/hydrogen carbonate anions according to step c) by means of an electrical gradient established between the acceptor chamber and an uptake and release chamber,
wherein the acceptor chamber and the uptake and release chambers are separated from each other by the separation membrane.

When tap water is used as the uptake and release medium in such an arrangement in the uptake and release chamber, the formation of gas bubbles consisting of carbon dioxide occurs in the uptake and release chamber at the membrane separating this chamber from the acceptor chamber. The formation of gas bubbles that cover the membrane between the acceptor chamber and the uptake and release chamber has been shown to be very disadvantageous, since electrical insulation develops in these areas due to the gas layer, thereby considerably reducing the efficiency of the method. Furthermore, the use of an aqueous medium containing electrolytes is disadvantageous, since solids, e.g. in the form of sodium and/or calcium carbonate, may form. In particular, electrolytes that yield practically water-insoluble carbonates, such as calcium carbonate, are disadvantageous.

Nevertheless, it is necessary for the execution of an electrophoretic method that the uptake and release medium has a high electrical conductivity. Furthermore, the compound that establishes electrical conductivity in the uptake and releasing medium should not itself be electrophoretically transported in the applied DC electric field. Surprisingly, it was found that organic and inorganic acids are suitable to provide the above requirements.

Surprisingly, it was found that water-soluble organic compounds bearing one or more acid groups are particularly suitable for converting dissolved carbon dioxide/carbonate/hydrogen carbonate anion(s), which enter the chamber containing the uptake and/or release medium through a separation membrane, to a gaseous state or to evolve/release them. It is particularly advantageous if this organic compound is not transported in the electric field and/or cannot leave the chamber containing the uptake and/or release medium through the separation membrane due to its molecular size.

Thus, a preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives from the acceptor solution of step b) through a separation membrane into an aqueous uptake and release medium,
wherein the aqueous uptake and release medium comprises an organic or inorganic acid.

Thus, a preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives from the acceptor solution of step b) through a separation membrane into an aqueous uptake and release medium,
wherein the aqueous uptake and release medium comprises an organic or inorganic acid and has a pH in the range between 1 and 7, more preferably between 2 and 6, and more preferably between 3 and 5.

Thus, a further preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution from step a); and
c) transporting bound carbon dioxide/carbon dioxide derivatives from the acceptor solution of step b) through a separation membrane into an aqueous uptake and release medium,
wherein the aqueous uptake and release medium contains an organic acid and preferably has a pH in the range between 1 and 7, more preferably between 2 and 6, and more preferably between 3 and 5.

Preferably, the organic acid is a compound bearing at least one acid group and having an isoelectric point in the pH range between 3 and 5, preferably between 3.5 and 4.5. In preferred embodiments, the organic acid is preferably selected from the group comprising or consisting of citric acid, tartaric acid and ascorbic acid. In particularly preferred embodiments, the organic acid is citric acid. In particularly preferred embodiments, the aqueous uptake and release medium comprises citric acid.

In further preferred embodiments, the aqueous uptake and release medium comprises an organic acid, wherein the organic acid is an acidic amino acid having a carboxylic acid group (COOH) on the side chain. Also preferred herein are embodiments wherein the aqueous uptake and release medium comprises an organic acid, wherein the organic acid is an acid group-bearing amino acid. Also preferred herein are embodiments wherein the aqueous uptake and release medium comprises an organic acid, wherein the organic acid is selected from the group comprising or consisting of aspartic acid and glutamic acid. Also preferred herein are embodiments wherein the aqueous uptake and release medium contains an organic acid, wherein the organic acid is selected from the group comprising or consisting of citric acid, tartaric acid, and ascorbic acid. Particularly preferred is tartaric acid. Also preferred herein are embodiments wherein the aqueous uptake and release medium comprises an inorganic acid, wherein the inorganic acid is preferably selected from the group comprising or consisting of sulfuric acid or diphosphoric acid.

Thus, a preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution from step b) through a separation membrane into an aqueous uptake and release medium containing citric acid,
wherein the acceptor solution of step b) is in or is introduced into an acceptor chamber of an electrodialysis device; and
wherein transporting the carbon dioxide/derivatives of step c) is accomplished by means of an electrical gradient established between the acceptor chamber and an uptake and release chamber,
wherein the acceptor chamber and the uptake and release chambers are separated from each other by the separation membrane.

Acid group-bearing amino acids were found to meet this condition particularly well and are therefore especially preferred.

Preferably, the pH of the uptake and/or release medium is self-adjusted by dissociation of the dissolved amino acids. Amino acids do not exhibit electrophoretic mobility at their isoelectric point. Therefore, it is particularly advantageous if aqueous dissolved amino acids are present at their isoelectric point in the acceptor medium and the uptake and/or release medium, respectively. This results in the particularly advantageous effect that the compounds responsible for the solubilization, which is responsible for the transport on the one hand and for the separation/evolution of carbon dioxide/hydrogen carbonate anions on the other hand, do not mix or are not consumed, since they remain in the respective solutions. It has been shown that electrophoretic separation of carbonate/hydrogen carbonate anions and diffusion-induced transport of dissolved carbon dioxide through an open-pored mesoporous membrane, e.g. in the form of a ceramic filter plate, are possible. In this case, the pH of the acceptor solution and the uptake and release medium also does not change during electrophoresis and a release of carbon dioxide is accomplished in the uptake and release chamber, whereby no voltage drop due to gas bubble formation and adhesion onto the separation membrane is present during electrophoresis. In this respect, the uptake medium according to the invention fulfills the condition that an uptake and binding of carbon dioxide or carbonate/hydrogen carbonate anions is accomplished in the medium and the uptaken/bound carbon dioxide or carbonate/hydrogen carbonate anions can be removed and transported away from the separation medium, so that the release of carbon dioxide can be performed spatially remote from the separation medium or the uptake and release chamber.

Preferred is a method in which dissolution, electrophoretic transport, and separation/evolution of carbon dioxide/carbonate/hydrogen carbonate anions is accomplished by providing basic amino acids in an aqueous acceptor medium and acid group-bearing amino acids in an aqueous uptake and/or release medium at their isoelectric point.

Preferred is a method in which a gas or gaseous compounds as well as their derivatives are bound in an aqueous acceptor medium and, by means of an electrophoretic method, the gas/gaseous compound or their derivatives in water are transported through a separation medium (separation membrane) and thereby enter an uptake and release medium.

Preferred is a method in which a gas or gaseous compounds and derivatives thereof are bound in an aqueous acceptor medium and, by means of an electrophoretic method, the gas/gaseous compound or derivatives thereof are transported in water through a separation medium and thereby enter an uptake and release medium, wherein they are released/evolved as a gas phase and/or chemically reacted.

Preferred is a method in which a release of the carbon dioxide/derivatives transported through the separation medium (separation membrane) is accomplished in the uptake and release chamber in the form of pure carbon dioxide gas.

The preferred basic amino acids are arginine and lysine. The preferred acid group-bearing amino acids are aspartic acid and glutamic acid.

It was found that when an acid which had a pKs >3 was used as the uptake and release medium, the carbon dioxide, or the carbonate/hydrogen carbonate anions, electrophoretically transported therein were not or only to a small extent already released/evolved at the membrane or within the uptake-release chamber as gaseous carbon dioxide. It was found that in this case a complete release of the carbon dioxide dissolved/bound in the uptake and release medium, or of the carbonate/hydrogen carbonate anions, can be achieved outside the uptake and release chamber by passing the uptake and release medium over preferably hydrophobic surfaces in a collection vessel.

It has been found that when a device arrangement in which a high overflow rate of the separation medium (separation membrane) with the uptake and release medium in the uptake and release chamber, in particular by using honeycomb-like spacers which cause a turbulent flow in the uptake and release chamber, is established and this is conveyed into a release device, in which the uptake and release medium is brought into contact with surfaces on which release/evolution of carbon dioxide is accomplished or at which release/evolution of carbon dioxide is brought about by application of a negative pressure, the release of carbon dioxide as a gas is accomplished practically exclusively in the release device and not or only to a very small extent in the uptake and release chamber. Therefore, in a preferred method embodiment, the release of carbon dioxide as a gas from the uptake and release medium is performed in a release device into which the uptake and release medium is introduced from an uptake and release chamber (cf. FIG. 1). Preferred is the provision of interfaces in a release device for the release/evolution of carbon dioxide. Hydrophobic interfaces are preferred.

Suitable devices for increasing interfacial areas are, for example, column packing materials.

Preferred is a method in which, after carbon dioxide/carbonate/hydrogen carbonate anions have been taken up in an uptake and release medium in an uptake and release chamber, the uptake and release medium is introduced into a release device and carbon dioxide is released therein as a gas.

Thus, a preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution from step b) through a separation membrane into an aqueous uptake and release medium,
wherein the acceptor solution of step b) is in or introduced into an acceptor chamber of an electrodialysis device; and
transporting the carbon dioxide/derivatives of step c) is accomplished by means of an electrical gradient established between the acceptor chamber and an uptake and release chamber,
wherein the acceptor chamber and the uptake and release chambers are separated from each other by the separation membrane;
wherein the method comprises, after step c), step c3):
c3) releasing carbon dioxide as a gas phase from the uptake and release medium containing bound carbon dioxide/derivatives from step c) in a release chamber.

In preferred embodiments, carbon dioxide as a gas phase is released by applying a DC voltage to the uptake and release medium from step c3).

Thus, a preferred embodiment of the present invention relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution from step b) through a separation membrane into an aqueous uptake and release medium,
wherein the acceptor solution of step b) is in or is introduced into an acceptor chamber of an electrodialysis device; and
wherein transporting the carbon dioxide/derivatives of step c) is accomplished by means of an electrical gradient established between the acceptor chamber and an uptake and release chamber,
wherein the acceptor chamber and the uptake and release chambers are separated from each other by the separation membrane;
wherein the method comprises, after step c), step c3′):
c3′) introducing the aqueous uptake and release medium containing bound carbon dioxide/carbon dioxide derivatives from step c) into a release device.

In preferred embodiments, the method comprises step c3) after step c3′):
c3) releasing carbon dioxide as a gas phase from the uptake and release medium containing bound carbon dioxide/carbon dioxide derivatives from step c3′) in the release device.

Thus, a preferred embodiment of the present invention relates to a method for selectively binding, transporting and storing carbon dioxide in aqueous media comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution from step b) through a separation membrane into an aqueous uptake and release medium,
wherein the acceptor solution of step b) is in or is introduced into an acceptor chamber of an electrodialysis device; and transporting the carbon dioxide/derivatives of step c) is accomplished by means of an electrical gradient established between the acceptor chamber and an uptake and release chamber,
wherein the acceptor chamber and the uptake and release chambers are separated from each other by the separation membrane;
wherein the method according to step c) comprises steps c3′) and c3):
c3′) introducing the aqueous uptake and release medium containing bound carbon dioxide/carbon dioxide derivatives from step c) into a release device; and
c3) releasing carbon dioxide as a gas phase from the uptake and release medium containing bound carbon dioxide/carbon dioxide derivatives from step c3′) in the release device.

It was further found that the gas evolved/released in the release chamber/release device or from the uptake and release medium consists exclusively or almost exclusively of carbon dioxide. It could be documented that when the method embodiment is performed according to the invention with a release of carbon dioxide as a gas phase in a release device, there is no increase in electrical resistance during the electrophoretic transport of carbon dioxide/carbonate/hydrogen carbonate anions within the electrodialysis device due to gas release/evolution at the separation membrane or gas bubble formation within the uptake and release chamber.

Preferred is a method for recovering and obtaining pure carbon dioxide gas.

A pure gas contains <0.5 vol % of impurities from other compound.

In a further preferred embodiment of the method, ionic liquids are used as the release medium. Ionic liquids are particularly advantageous because they are generally not water soluble and there is no electrophoretic transport of the anionic and cationic compounds that make up the ionic liquid. Therefore, an application of ionic liquids as a release medium in conjunction with an open-pore membrane separating the acceptor chamber from the uptake and release chambers is a particularly preferred embodiment of the method.

Preferred is a method in which a gas or gaseous compounds as well as their derivatives are bound in an aqueous acceptor medium and, by means of an electrophoretic process, the gas/gaseous compound or their derivatives in water are transported through a separation medium (separation membrane) and thereby enter an uptake and release medium, wherein the uptake and release medium is an ionic liquid.

Preferred is a method in which a gas or gaseous compound and its derivatives are bound in an aqueous acceptor medium and by means of an electrophoretic process the gas/gaseous compound or its derivatives are transported in water through a separation medium (separation membrane) and thereby enter an uptake and release medium which is an ionic liquid, wherein they are chemically reacted.

In a particularly preferred embodiment, the separation of carbon dioxide from a gas/gas mixture is semi-continuous or continuous. Preferred for this purpose is a device in which a dissolution/dissociation of carbon dioxide in one of the aqueous acceptor solutions according to the invention is performed and, at the same time, a separation of the dissolved carbon dioxide or carbonate/hydrogen carbonate anions from the acceptor solution is accomplished. The selective separation of the bound carbon dioxide/carbonate/hydrogen carbonate anion(s) is preferably achieved by transport through a separation medium (separation membrane). The use of membranes as separation medium for the separation of dissolved carbon dioxide or carbonate/hydrogen carbonate anions is preferred. Electrophoretic separation is preferred. For this purpose, the use of an electrodialysis unit is particularly preferred. In one embodiment, loading by applying a gas/gas mixture containing carbon dioxide is performed in the chambers containing the acceptor solution. The carbon dioxide-reduced gas/gas mixture leaving this chamber is then passed to the next chamber containing the acceptor solution. This arrangement can be performed any number of times in succession. The loading with gas can be performed both in the chambers containing the acceptor solution of the respective dialysis cell and in a container outside thereof, whereby recirculation is established between the container and the respective chamber of the dialysis unit. Preferred is the finest possible dispersion of the gas/gas mixture in the acceptor medium.

Prior art techniques can be used for this purpose. With such a method arrangement, a gas scrubbing column can be set up so that the carbon dioxide-containing gas stream is sequentially contacted with the acceptor medium several times.

It has been documented that after separation of carbon dioxide/carbonate/hydrogen carbonate anions from an acceptor medium saturated with carbon dioxide, the acceptor medium can be reused to dissolve, bind and transport carbon dioxide. In a particularly advantageous manner, this enables the acceptor medium to be recirculated so that carbon dioxide can be taken up, transported and separated continuously or semicontinuously without loss and the acceptor medium is available as often as required for perform the process again.

A preferred method is one in which reuse of an acceptor medium without loss is performed following separation of carbon dioxide/carbonate/hydrogen carbonate anions from this medium, in order to dissolve and bind carbon dioxide again therein.

It has been shown that gaseous carbon dioxide can be completely solubilized and bound in aqueous solutions of compounds bearing guanidino/amidino groups, provided that non-protonated guanidino/amidino groups of the dissolved acceptor compound are present. It is irrelevant in which ratio the carbon dioxide is present to other gaseous compounds/elements or whether it is a pure carbon dioxide gas stream. Under this condition, depending on the contact time and the interface reached between the aqueous acceptor medium and the gas/gas mixture, a complete (<1 ppm) or almost complete (</=100 ppm) removal of carbon dioxide from the gas/gas mixture is achieved.

Preferred is a method for the removal of carbon dioxide from gas or gas mixtures.

Thus, for the first time, a method can be provided which enables complete or almost complete removal of carbon dioxide from a gas or gas mixture by contacting it with an aqueous acceptor medium at atmospheric pressure and in which subsequently selectively gaseous carbon dioxide can be made obtainable again in highly pure or pure form. In this context, highly pure means a carbon dioxide content of >99.5 vol % and pure means a carbon dioxide content of >98.5 vol %.

In this respect, the method is also directed to the selective separation and recovery and production of pure carbon dioxide.

Preferred is a method for selective separation, recovery and production of carbon dioxide that is pure or highly pure.

It has been found that if a gas/gas mixture contains several gaseous compounds that form an acid in water, these can be taken up in the acceptor medium and thus affect the separation efficiency when only one of the gaseous compounds is to be recovered. This may be the case, in particular, with gases produced during fermentation of organic material or so-called “acidic natural gases” as well as flue or digester gases. Furthermore, flue gases may contain solids that can lead to sooting of the acceptor solution. In a preferred embodiment of the method, before a gas/gas mixture is brought into contact with the acceptor medium, all solid particles/liquids and gaseous compounds that are soluble in an aqueous medium or form water-soluble reaction products therein are separated. This is possible with prior art methods.

Therefore, prepurification of a gas stream in which carbon dioxide is to be bound or bound and recovered is preferred.

Preferably, a method in which, prior to contacting the gas/gas mixture containing carbon dioxide with an acceptor medium, separation/adsorption of liquid and solid components as well as gas components other than carbon dioxide, which dissolve in water or form water-soluble reaction products upon contact with water, is performed.

Thus, a method for the adsorption, transport as well as selective release of carbon dioxide can be provided in which no corrosive or health-hazardous compounds are present and in which the aqueous acceptor medium can be completely recirculated after the separation of the carbon dioxide bound therein and used for the renewed absorption of carbon dioxide.

Preferred is a method in which an aqueous acceptor medium is provided for the absorption, transport as well as selective release of carbon dioxide, in which no corrosive or health hazardous compounds are used and in which the aqueous acceptor medium can be completely recirculated and used for the re-adsorption of carbon dioxide after the separation of the carbon dioxide bound therein.

Preferred is a method, for reversibly binding gaseous compounds to an acceptor compound dissolved in water in an aqueous acceptor medium.

Preferred is a method in which the reversible binding between a gaseous compound and a water-soluble acceptor compound present in an aqueous acceptor medium is accomplished via a reaction product of the gaseous compound with water.

Preferred is a method in which the reaction product of a gaseous compound with the water phase of an aqueous acceptor medium is reversibly bound by a dissolved acceptor compound.

Preferred is a method in which gaseous compounds in an aqueous acceptor medium are bound by an acceptor compound and in which the bound gaseous compounds can be released again as gas by a change in the pH of the acceptor solution, displacement of the gaseous compound by an addition of anionic compounds or by an electrophoretic separation.

Preferably, the method involves binding gaseous compounds in an aqueous acceptor medium and subsequently releasing the gaseous compound, regenerating the acceptor compound and subsequently providing the acceptor medium for rebinding a gaseous compound.

It was found that further method embodiments can be realized by the method of the invention for absorption, transport as well as selective release of carbon dioxide.

It was found that hydrogen is released during the process of dissolving carbon dioxide in an aqueous acceptor medium. Between 0.5 and 2 moles of hydrogen can be produced for each mole of carbon dioxide that is bound in the acceptor medium. The hydrogen enters the gas/gas mixture as a gas, which escapes after being brought into contact with the acceptor medium. Hydrogen is a sought-after raw material; therefore in a preferred embodiment of the method, recovery of the quantities of hydrogen obtainable in the method embodiments according to the invention is performed. In a preferred method embodiment, adsorption of hydrogen that is generated during the process embodiment is performed. Methods and devices for adsorption and separation of hydrogen are known in the prior art. For example, the gas/gas mixture collected after being brought into contact with the acceptor medium can be passed through a medium suitable for binding and/or separating hydrogen therein and recovered and/or reacted directly or in a secondary circuit. In this respect, the method is also directed to the production and recovery of hydrogen.

Preferred is a method in which hydrogen is produced by bringing a gas/gas mixture containing carbon dioxide into contact with an acceptor medium and the hydrogen produced is adsorbed and/or separated and recovered. Preferred is a method for the production and recovery of hydrogen in which a gas/gas mixture is brought into contact with an acceptor medium. Preferred are acceptor media for the production and recovery of hydrogen.

Surprisingly, it was found that by the presence or by the addition of cationic compounds in/to an aqueous acceptor medium according to the invention, in which carbon dioxide is taken up or in which carbon dioxide is already bound, there is spontaneous formation of carbonates. It has been found that in the presence of sodium or calcium ions in the aqueous acceptor medium, when brought into contact with a gas containing water-soluble gaseous compounds, solids are formed. It has been found that when the water-soluble gaseous compound is carbon dioxide, sodium or calcium carbonate is formed.

Preferred is a method in which gaseous compounds are bound in an acceptor medium and contacted herein with one or more compounds, wherein a physicochemical or chemical reaction is accomplished between the gaseous compound bound to the acceptor compound or between the anionic form of the gaseous compound and at least one other compound.

Preferred is a method in which gaseous compounds in an acceptor medium are bound by an acceptor compound that enables and/or catalyzes a reaction between the bound gaseous compound(s) or between the anionic form of the gaseous compound(s) and one or more other compounds.

It was then found that salts of alkali and alkaline earth metals dissolved very readily in an aqueous acceptor medium according to the invention. Surprisingly, no reaction or a very small exothermic reaction occurred compared to a dissolution process in water. This applies in particular to the dissolution of calcium, iron and aluminum salts, such as calcium, iron or aluminum chloride. Surprisingly, this results in further particularly advantageous opportunities in the production of carbonates and hydrogen carbonates.

When an acceptor solution according to the invention, in which, for example, aluminum chloride or iron chloride was dissolved, was introduced into an acceptor solution saturated with carbon dioxide, very fine white or light brown solid particles were formed, which were present as a suspension under agitation and sedimented after the agitation had ceased. It could be documented that the solids were aluminum or iron carbonate. Surprisingly, when the acceptor solution containing the dissolved salt was mixed into an acceptor solution saturated with carbon dioxide, there was no or minimal release of carbon dioxide in gaseous form under atmospheric conditions. Thus, a method can be provided to enable virtually complete or total chemical conversion of carbon dioxide/carbonate/hydrogen carbonate anions bound in an acceptor medium under normal pressure conditions as well as at room temperature.

Thus, in a very advantageous manner, a compound (reaction compound) with which a chemical conversion with carbon dioxide and/or carbonate and/or hydrogen carbonate anions is to be performed can be completely dissolved in an acceptor medium containing at least one acceptor compound and brought into contact with carbon dioxide/carbonate/hydrogen carbonate anions easily, quickly and without causing an exothermic reaction in the aqueous medium, and without release of carbon dioxide. It has been found that these beneficial effects also result when a reaction compound is provided in the same manner in an uptake and releasing medium or a reaction medium for chemical conversion.

Preferred is a method in which at least one reaction compound is brought into solution together with an acceptor compound and the reaction compound(s) dissolved therein is/are brought into contact with carbon dioxide and/or carbonate and/or hydrogen carbonate anions to chemically react with carbon dioxide and/or carbonate and/or hydrogen carbonate anions.

It has further been found that when an acceptor solution in which cations/cationic compounds which can form carbonates and/or hydrogen carbonates are already present in dissolved form is brought into contact with a gas/gas mixture containing carbon dioxide, carbonates and/or hydrogen carbonates are formed and precipitate in the course of gas application.

Preferred is a method in which gaseous compounds can be chemically reacted in an aqueous acceptor medium by binding them in the form of the reaction product with water to a dissolved acceptor compound and bringing them into contact with other compounds in this form.

Preferred is a method in which at least one water-soluble inorganic or organic compound is dissolved by the acceptor compound dissolved in the aqueous acceptor medium, or solubilization is achieved so that the at least one compound is partially or completely dissolved in the acceptor medium, and the acceptor medium is brought into contact with at least one gaseous compound simultaneously with or subsequent to the dissolution of the at least one compound, whereby a physicochemical or chemical reaction is effected between the at least one gaseous compound and the at least one compound dissolved in the acceptor medium.

In a further preferred embodiment of the method, the introduction of cation/cationic compounds that can form carbonates or hydrogen carbonates is performed by selectively introducing them into the acceptor solution by means of an electrophoretic method. This is preferably performed in a method arrangement in which an electrolyte solution in which the cation(s)/cationic compound(s) suitable for carbonate or hydrogen carbonate production is/are present in dissolved form is/are introduced in an electrodialysis apparatus into an electrolyte chamber which, instead of a uptake and release chamber, is connected to one of the acceptor chambers containing the acceptor solution, a cation-selective membrane being located between the electrolyte chamber and the acceptor chamber, by means of which the chambers are electrically coupled to one another. By applying a DC voltage between the anode and cathode chambers, electrophoretic transport of cation/cationic compounds from the electrolyte chamber to the acceptor chamber is achieved. Optionally, the acceptor chamber may contain an acceptor solution that is already saturated with carbon dioxide or that is continuously charged with carbon dioxide during the dialysis process. As disclosed in more detail below, chemical conversion of carbon dioxide and/or carbonate and/or hydrogen carbonate is also possible with other compounds. Compounds which can react or be reacted with carbon dioxide and/or carbonate and/or hydrogen carbonate by being in or transported into an acceptor medium, or conversion is accomplished outside the acceptor medium with carbon dioxide and/or carbonate and/or hydrogen carbonate anions dissolved and transported by means of an acceptor medium, are hereinafter referred to as reaction compounds.

Thus, it was possible to establish a conversion method by which it is possible to bring reaction compounds into contact with carbonate/hydrogen carbonate anions and to chemically react them with each other. As described further below, the reaction method can be designed in various embodiments and performed with various reaction compounds.

It was further found that, because of the improved solubility due to the basicity of the acceptor medium, solutions with significantly higher concentrations, especially of salts of the reaction compounds (but also with non-salt compounds), can be prepared than is possible in pure water. In experiments on the gassing of an acceptor solution containing dissolved sodium, calcium or aluminum salts with a pure gas consisting of carbon dioxide or a gas mixture containing carbon dioxide, it was found that a milky suspension forms very rapidly. The resulting solid sediments spontaneously, so that complete phase separation can be achieved by an agitation-free settling phase or settling zone. However, phase separation can also be achieved by means of a centrifugal or filtrative separation method.

Carbonates or hydrogen carbonates produced in this way are chemically pure and are immediately available in the form of very small particles of <1 μm or can be dispersed into very small particles with little energy input.

The retention of anions of the dissolved salt in the acceptor solution, such as chloride ions, was found to be a disadvantage. It was found that it is possible with various prior art methods to bind or separate the anions of the salts dissolved in the acceptor solution. In one embodiment, separation of the anions of a salt is performed by electrodialysis following introduction of a salt or a solution of the salt into the aqueous acceptor medium or following contacting of the aqueous acceptor medium with a gas/gas mixture containing carbon dioxide.

Preferred is a method in which the acceptor compound present in an acceptor medium is regenerated again following the binding of a gaseous compound or the anionic form of the gaseous compound by purifying the acceptor medium of anionic compounds, except for hydroxide anions, by means of electrodialysis or contact with ion exchange compounds or adsorbents.

Therefore, the method is also directed to the production of chemically pure carbonates as well as hydrogen carbonates, which are obtainable in powder form. Preferably, the carbonates and hydrogen carbonates are present in amorphous form.

Preferred is a method in which carbonates and/or hydrogen carbonates are obtainable in chemically pure form by dissolving carbon dioxide or carbonate/hydrogen carbonate anions by means of an aqueous acceptor medium containing dissolved guanidino and/or amidino group-bearing compounds and bonding them therein and bringing them into contact with dissolved cationic/cationic compounds which can form carbonates or hydrogen carbonates.

Preferred is a method in which carbonates as well as hydrogen carbonates are obtainable in chemically pure form by dissolving cations/cationic compounds which can form carbonates or hydrogen carbonates in an aqueous acceptor medium containing dissolved guanidino and/or amidino group-bearing compounds and by bringing them into contact with carbon dioxide, respectively carbonate/hydrogen carbonate anions.

Preferred is a method for the preparation of carbonates as well as hydrogen carbonates.

It has been found that such carbonates as well as hydrogen carbonates can be produced by an absorption and dissolution of carbon dioxide released from a regenerative raw material source according to the invention, such as in a fermentation to a biogas or the combustion of wood. Provided that regenerative cations/cationic compounds, which are obtainable e.g. by one of the methods for the regeneration of organic and inorganic compounds, as well as a regenerative energy are used for the method performance, it is now possible to produce regenerative carbonates as well as hydrogen carbonates.

Preferred is a method for the production of regenerative carbonates as well as hydrogen carbonates.

Preferred are regenerative carbonates and hydrogen carbonates.

Thus, in another aspect of the invention, the method is also directed to providing carbon dioxide, or carbonate/hydrogen carbonate anions in a high concentration in an aqueous acceptor medium and chemically reacting them therein with other compounds.

Preferred is a method in which carbon dioxide, or carbonate/hydrogen carbonate anions, is/are provided in a high concentration in an aqueous acceptor medium and is/are chemically reacted therein with other compounds.

Thus, the method is also directed to a conversion method by which reaction products are obtainable by the conversion of organic and/or inorganic compounds using dissolved or dissolved and transported gases/gaseous compounds and/or derivatives thereof.

Preferred is a conversion method in which organic and/or inorganic compounds are contacted and reacted with dissolved or dissolved and transported gases/gaseous compounds and/or derivatives thereof.

Preferred are reaction products obtainable by a conversion of organic and/or inorganic compounds with a dissolved or dissolved and transported gases/gaseous compounds and/or derivatives thereof.

Preferred is a method for selective binding, transport, reaction activation, conversion and/or release of carbon dioxide.

Thus, the task is solved by a method in which carbon dioxide is dissolved in an aqueous medium containing dissolved guanidino and/or amidino group-bearing compounds and is stored and/or transported in it and/or reacted in it and/or released from it.

As mentioned above, it was surprisingly found that the solubility of carbon dioxide in an aqueous medium, by compounds having free guanidino and/or amidino groups dissolved therein, is significantly increased compared to pure water and that the carbon dioxide remains bound in the aqueous solution. Further surprising was the observation that with increasing amounts of bound carbon dioxide, the solubility of compounds having guanidino and/or amidino groups can be increased. For example, for arginine, for which the solubility limit in water is 0.6 mol/l at 20° C. (or, depending on the source, about 150 g/l at 20° C. and 150 g ~0.86 mol, M(arginine)=174.20 g/mol), it was found that more than 3 mol/l (522.6 g/l) can be dissolved, or go into solution, with the simultaneous introduction of carbon dioxide. The aqueous medium remains clear and has a pH between 10 and 12.5. It has been found that the carbon dioxide, or its reaction products in water, such as carbonate and hydrogen carbonate anions, are dissolved in an aqueous solution containing dissolved guanidino and/or amidino group-bearing compounds without pressure (at atmospheric pressure or normal pressure) and are bound therein, in a molar ratio of >/=1:1. Thus, by means of compounds having free guanidino and/or amidino groups dissolved in an aqueous medium without pressure (at atmospheric pressure or normal pressure), carbon dioxide or carbonate/hydrogen carbonate anions, respectively, can be bound herein without pressure (at atmospheric pressure or normal pressure) in a concentration of preferably >0.5 mol/l, more preferably >1.0 mol/l, more preferably >1.5 mol/l, more preferably >2.0 mol/l, more preferably >2.5 mol/l, more preferably >3.0 mol/l and even more preferably >3.5 mol/l.

In a preferred embodiment, the provision of the aqueous solution for the uptake, transport, conversion, release and/or storage of carbon dioxide is in the form of an acceptor solution. Preferably, the acceptor solution is provided in an acceptor chamber or acceptor device.

The acceptor device includes a device suitable for establishing for the largest possible exchange area between a gas/gas mixture and the acceptor medium and/or for bringing a gas/gas mixture into contact with the acceptor medium. Prior art methods are known for this purpose.

A gas scrubbing device (see also FIG. 1) or gas scrubbing column represents one form. A method comprising the step of contacting a gas containing carbon dioxide with the acceptor solution from step a) in a gas scrubbing apparatus or gas scrubbing column is therefore preferred.

In the case of a gas mixture containing non-gaseous components, it is preferred to first free the gas mixture from the non-gaseous components, e.g. by filtration or washing the gas with another liquid.

Methods for separating non-gaseous components from the prior art are known to the skilled person. In a preferred embodiment, the gas comprising carbon dioxide is filtered and/or washed prior to contact with an acceptor solution according to the invention to remove non-gaseous components. To remove undesirable gases such as H₂S and NH₃ or SO₂ and acid gases other than carbon dioxide, these can be washed out of the gas containing carbon dioxide in an upstream gas washing column.

Preferably, a gas mixture is further first subjected to scrubbing by means of an acidic solution. Surprisingly, it has been found that the carbon dioxide concentration of a gas/gas mixture can be reduced significantly faster when subsequently brought into contact with an acceptor solution than without prior activation of the gas mixture by bringing it into contact with an acid-containing solution.

The present invention preferably relates to a method for selectively binding, transporting and storing carbon dioxide in aqueous media, comprising the steps of:
a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or
storing and/or transporting the acceptor solution containing bound carbon dioxide/carbon dioxide derivatives from step b),
wherein the gas containing carbon dioxide is washed by means of an acidic solution prior to step b).

The present invention preferably relates to a method for selectively binding, transporting and storing carbon dioxide in aqueous media, comprising the steps of:
a) providing an aqueous acceptor solution containing at least one acceptor compound having a free guanidino and/or amidino group;
b) contacting a gas containing carbon dioxide with the acceptor solution of step a); and
c) storing and/or transporting the acceptor solution containing bound carbon dioxide/carbon dioxide derivatives from step b); and/or
transporting bound carbon dioxide/carbon dioxide derivatives in the acceptor solution from step b) through a separation membrane into an aqueous uptake and release medium,
wherein the gas containing carbon dioxide is washed by means of an acidic solution prior to step b).

Preferred is a method in which activation of a gas mixture is effected by bringing it into contact with an acidic solution, thereby improving the solubility of carbon dioxide in an acceptor medium. In a preferred embodiment, the gas containing carbon dioxide is washed by means of an acidic solution prior to contacting with an acceptor solution according to the invention. In principle, any acid or acid-forming compound can be used for this purpose. The preferred acids are HCl (hydrochloric acid), sulfuric acid or phosphoric acid. In a preferred embodiment, the gas containing carbon dioxide is washed using an acidic solution selected from hydrochloric acid, sulfuric acid or phosphoric acid prior to contacting with an acceptor solution according to the invention.

In addition to the methods already mentioned above for direct contacting of the aqueous acceptor medium with a gas/gas mixture, methods were investigated for indirect contacting of a gaseous and a liquid medium. It has been shown that carbon dioxide, or its water-soluble derivatives, can pass through solid or semi-solid separation media (gas/liquid separation membrane) separating a gas phase containing carbon dioxide and an aqueous acceptor solution, thereby providing highly efficient and selective transport of carbon dioxide or its derivatives into the aqueous acceptor medium. In a preferred embodiment, indirect contacting of a gas phase and a liquid phase is accomplished by means of a membrane contactor.

Preferred is a method comprising the step of contacting a gas comprising carbon dioxide with the acceptor solution from step a) by means of a membrane contactor.

In a membrane contactor, the phases to be brought into contact with each other are separated from each other by a membrane. In a preferred method embodiment, the contacting of an aqueous acceptor medium with a gas/gas mixture is carried out by means of a membrane contactor. Surprisingly, it was found that when open-pored membranes are used in such a membrane contactor, they allow a very high diffusion rate of water-soluble gases or gaseous compounds from the gas phase into the liquid phase. It was found that the high diffusion/transport rate for gaseous water-soluble compounds is due to the properties of the acceptor medium. For example, compared to prior art aqueous absorption media, such as solutions of alkanolamines, there is a surface tension of the aqueous acceptor solutions that is not different from water. In contrast, the surface tension is reduced for absorbent compounds that exhibit surfactant or alcoholic properties. Therefore, open-pored membranes are not applicable when using aqueous solutions with prior art absorbent compounds, since there is liquid leakage. It was shown that there was no leakage of the acceptor liquid through/out of an open-pored membrane, which had an average pore size of 200 μm, at atmospheric pressure conditions on either the gas side or the liquid side.

It was shown that by using the configuration possibilities of a membrane contactor, a complete extraction of carbon dioxide can be achieved in a membrane contactor device, which has much smaller spatial dimensions than a gas scrubbing device equipped with packing.

For example, a flat membrane module can be provided which, on the one hand, has very flat channels for the gas and liquid phases and, at the same time, has comparatively short channel lengths. This allows the design of membrane contactors that can be optimally adapted to individual gas/gas compositions and volume flows in terms of flow technology. Various designs are known in the prior art, such as wound modules or hollow fiber modules or tube modules.

The preferred membranes/solid separation media for the step of contacting the gas containing carbon dioxide with an acceptor solution according to the invention have a low build-up height (membrane thickness). This is preferably <300 μm, more preferably <200 μm, more preferably <150 μm, more preferably <100 μm, more preferably <50 μm and even more preferably <25 μm. Preferred, therefore, is a method comprising the step of contacting a gas containing carbon dioxide with the acceptor solution of step a) using a gas-liquid separation membrane having an average pore size of 200 μm at atmospheric pressure. Preferred, therefore, is a method comprising the step of contacting a gas containing carbon dioxide with the acceptor solution of step a) by means of a membrane having a membrane thickness of <300 μm, more preferably <200 μm, more preferably <150 μm, more preferably <100 μm, more preferably <50 μm and even more preferably <25 μm. Preferred, therefore, is a method comprising the step of contacting a gas containing carbon dioxide at atmospheric pressure with the acceptor solution of step a) by means of a membrane having an average pore size of 200 μm, wherein the membrane has a membrane thickness of <300 μm, more preferably <200 μm, further preferably <150 μm, more preferably <100 μm, further preferably <50 μm, and still further preferably <25 μm. Preferred, therefore, is a method comprising the step of contacting a gas containing carbon dioxide with the acceptor solution of step a) by means of a membrane having a mean pore size of >10 μm, more preferably >50 μm, more preferably >100 μm, more preferably >150 μm, more preferably >200 μm still more preferably >250 μm and most preferably >300 μm. Preferably, therefore, a method comprising the step of contacting a gas containing carbon dioxide with the acceptor solution of step a) at atmospheric pressure by means of a membrane having a mean pore size of >10 μm, more preferably >50 μm, more preferably >100 μm, more preferably >150 μm, more preferably >200 μm still further preferably >250 μm and most preferably >300 μm, wherein the membrane has a membrane thickness of <300 μm, more preferably <200 μm, further preferably <150 μm, more preferably <100 μm, further preferably <50 μm and still further preferably <25 μm. Preferred, therefore, is a method comprising the step of contacting a gas containing carbon dioxide with the acceptor solution of step a) by means of a membrane having a mean pore size of >10 μm, more preferably >50 μm, more preferably >100 μm, more preferably >150 μm, more preferably >200 μm still further preferably >250 μm and most preferably >300 μm, wherein the membrane has a membrane thickness of <300 μm, more preferably <200 μm, further preferably <150 μm, more preferably <100 μm, further preferably <50 μm and still further preferably <25 μm.

In this context, the membrane/foil may be attached to or bonded to a support material. Preferred are membranes/solid separation media that are open pore, i.e., exhibit continuous channels or channel-like structures that are open on both sides of the membrane/solid separation media. In the prior art, the average channel diameter or average pore size is reported. The preferred membranes/solid separation media have open channels with a mean channel diameter or mean pore size of >10 μm, more preferably >50 μm, more preferably >100 μm, more preferably >150 μm, more preferably >200 μm even more preferably >250 μm and most preferably >300 μm.

Preferred are membranes/solid separation media that have a high porosity (number of pores per unit area). Preferred are membranes/solid separation media with a porosity of >50%, more preferred of >60%, more preferred of >70%, more preferred of >80% and even more preferred of >90%. In principle, any material with which prior art membranes/solid separation media can be produced is suitable for a method according to the invention. The selection is preferably made according to the individual application purpose. For example, in an application in which a hot gas/gas mixture (e.g. >130° C.) is to be brought into contact with the membrane, a heat-resistant material is preferably to be selected. Suitable materials in this regard include PTFE (polytetrafluoroethylene) or PC (polycarbonate) or ceramic membranes. Preferred, therefore, is a method comprising the step of contacting a gas containing carbon dioxide with the acceptor solution from step a) by means of a membrane having a mean pore size of >10 μm, more preferably >50 μm, more preferably >100 μm, more preferably >150 μm, more preferably >200 μm still more preferably >250 μm and most preferably >300 μm, wherein the membrane has a membrane thickness of <300 μm, more preferably <200 μm, more preferably <150 μm, more preferably <100 μm, more preferably <50 μm and even more preferably <25 μm, wherein the membrane is selected from a polytetrafluoroethylene (PTFE) membrane, a polycarbonate (PC) membrane or a ceramic membrane.

Particularly suitable materials from which the membranes/solid separation media are made can be selected for different applications. For example, in a preferred method implementation in which air is used as the gas phase in order to remove the carbon dioxide content therein, a membrane is preferably used that has hydrophobic surface properties, measurable by a water contact angle of >90°. Preferably, this membrane additionally exhibits lipophilic surface properties, measurable, for example, by a contact angle with oleic acid of <10°. In a further preferred method embodiment, in which air is used as the gas phase, the membranes/solid separation media according to the invention are used, which are additionally given a hydrophilic surface coating. Preferably, the hydrophilic surface coating simultaneously exhibits hygrostatic properties.

It has been shown that membrane contactors can also be used to remove gases/gas components other than carbon dioxide from a gas/gas mixture, provided they are water-soluble and are absorbed by the acceptor medium according to the invention.

In a preferred method embodiment, high overflow rates of the liquid phase and/or the gas phase are set at the membranes/solid separation media of the membrane contactor in a membrane contactor.

The acceptor solution contains at least one acceptor compound that is readily soluble in water. This acceptor compound may be completely or incompletely dissolved. Preferably, dissolution and mixing of the acceptor solution of/with carbon dioxide is accomplished during the passage/contacting of a gas/gas mixture through/with the acceptor solution.

The at least one dissolved/soluble compound of the acceptor solution preferably causes the solution to have a basic pH. The pH of the acceptor solution is preferably between 7 and 14, more preferably between 8 and 13, and further preferably between 9 and 12.5. In other words, a pH between 7 and 14, more preferably between 8 and 13, and further preferably between 9 and 12.5 is established upon dissolution of the acceptor compound.

Preferred water-soluble acceptor compounds have at least one guanidino and/or amidino group. Preferred acceptor compounds having a guanidino and/or amidino group, further preferred are acceptor compounds having a free guanidino and/or amidino group. In some embodiments, acceptor compounds having an amidino group are preferred, further preferably having a free amidino group.

In some embodiments, acceptor compounds having a guanidino group are preferred, further preferably having a free guanidino group. Water-soluble compounds bearing free guanidino groups are particularly preferred.

The particularly preferred guanidino group-bearing compound is the amino acid arginine. The preferred concentration of the acceptor compound in the acceptor solution is between 10 μmol and 10 mol/l, more preferably between 10 mmol/and 5 mol/l and further preferably between 0.1 mol/and 3 mol/l. It should be noted that the solubility of the acceptor compound can be increased by the binding of carbon dioxide. Therefore, the acceptor compound can be added while contacting the gas containing carbon dioxide with the acceptor solution.

The temperature at which the acceptor solution is brought into contact with a gas/gas phase can in principle range from 0 to 100° C. The preferred temperature at which contacting of the gas/gas mixture with the acceptor solution is performed is between 1 and 60° C., more preferably between 1° and 35° C., and further preferably between 15 and 30° C.

Surprisingly, the acceptor solution is particularly suitable for pressureless (at atmospheric or normal pressure) storage of dissolved carbon dioxide. It has been shown that acceptor solutions containing dissolved and bound carbon dioxide remain stable over the course of 12 months, in particular there is no release/evolution of carbon dioxide or microbial colonization of the medium. Surprisingly, even at high concentrations of arginine, e.g. 3 mol/l, there is no crystallization of arginine or precipitate formation, even when stored at a temperature of 3° C.

The aqueous acceptor solutions according to the invention are preferably solutions of one, two or more amino acid(s) and/or peptide(s) which are present in the individual and/or total concentration in a range from 10 mmol/l to 15 mol/l, more preferably between 100 mmol/l and 10 mol/l and further preferably between 0.1 mol/and 5 mol/l. These may be L- or D-forms or racemates of the compounds. Preferred amino acids are arginine, further preferred are their derivatives. Particularly preferred are basic amino acids and peptides with cationic groups (positively charged functional groups). The peptides which can be used according to the invention may be di-, tri- and/or polypeptides. The peptides according to the invention have at least one functional group that binds or can bind a proton. The preferred molecular weight is thereby below 500 kDa, more preferably <250 kDa further preferably <100 kDa and particularly preferably <1000 Da. The preferred functional groups are thereby in particular a guanidine, amidine, amine, amide, hydrazine, hydrazone, hydroxyimine or nitro group. The amino acids may thereby have a single functional group or contain several of the same compound class or one or more functional group(s) of different compound classes.

Preferably, the amino acids and peptides according to the invention have at least one positive charge group (cationic groups/positively charged functional groups), or have an overall positive charge. Particularly preferred peptides contain at least one of the amino acids arginine, lysine, histidine in any number and sequential order.

Particularly preferred are amino acids and/or derivatives thereof having at least one guanidino and/or amidino group. However, other acceptor compounds having at least one guanidino and/or amidino group are also further preferred. The guanidino group is the chemical residue H₂N—C(NH)—NH— as well as cyclic forms thereof, and the amidino group is the chemical residue H₂N—C(NH)— as well as cyclic forms thereof. These guanidino compounds and amidino compounds preferably have a partition coefficient K_{OW} between n-octanol and water of less than 6.3 (K_{OW}<6.3).

Arginine derivatives are particularly preferred.

Arginine derivatives are defined as compounds having a guanidino group and a carboxylate group or an amidino group and a carboxylate group, wherein guanidino group and carboxylate group or amidino group and carboxylate group are spaced apart by at least one carbon atom, i.e. at least one of the following groups is located between the guanidino group or the amidino group and the carboxylate group: —CH2-, —CHR—, —CRR′—, wherein R and R′ independently represent any chemical residues. Of course, the distance between the guanidino group and the carboxylate group or the amidino group and the carboxylate group may be more than one carbon atom, for example, in the case of the following groups —(CH2)n-, —(CHR)n-, —(CRR′)n-, with n=2, 3, 4, 5, 6, 7, 8 or 9, as is the case, for example, in amidinopropionic acid, amidinobutyric acid, guanidinopropionic acid or guanidinobutyric acid. Compounds having more than one guanidino group and more than one carboxylate group include oligoarginine and polyarginine. Other examples of compounds falling under this definition are guanidinoacetic acid, creatine, glycocyamine.

Preferred compounds have as a common feature the general formula (I) or (II)

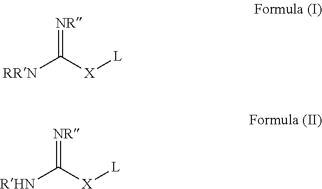

wherein
R, R′, R″, R′″ and R″″ independently of each other represent —H, —CH═CH₂, —CH₂—CH═CH₂, —C(CH₃)═CH₂, —CH═CH—CH₃, —C₂H₄—CH═CH₂, —CH₃, —C₂H₅, —C₃H₇, —CH(CH₃)₂, —C₄H₉, —CH₂—CH(CH₃)₂, —CH(CH₃)—C₂H₅, —C(CH₃)₃, —C₅H₁₁, —CH(CH₃)—C₃H₇, —CH₂—CH(CH₃)—C₂H₅, —CH(CH₃)—CH(CH₃)₂, —C(CH₃)₂—C₂H₅, —CH₂—C(CH₃)₃, —CH(C₂H₅)₂, —C₂H₄—CH(CH₃)₂, —C₆H₁₃, —C₇H₁₅, Cyclo-C₃H₅, cyclo-C₄H₇, cyclo-C₅H₉, Cyclo-C₆H₁₁, —C≡CH, —C≡C—CH₃, —CH₂—C≡CH, —C₂H₄—C≡CH, —CH₂—C≡C—CH₃,
or R′ and R″ together form the residue —CH₂—CH₂—, —CO—CH₂—, —CH₂—CO—, —CH═CH—, —CO—CH═CH—, —CH═CH—CO—, —CO—CH₂—CH₂—, —CH₂—CH₂—CO—, —CH₂—CO—CH₂— or —CH₂—CH₂—CH₂—;
X represents —NH—, —NR″″—, or —CH₂— or a substituted carbon atom; and
L represents a C1 to C8 linear or branched and saturated or unsaturated carbon chain having at least one substituent selected from the group comprising or consisting of —NH₂, —OH, —PO₃H₂, —PO₃H⁻, —PO₃²⁻, —OPO₃H₂, —OPO₃H⁻, —OPO₃²⁻, —COOH, —COO⁻, —CO—NH₂, —NH₃⁺, —NH—CO—NH₂, —N(CH₃)₃⁺, —N(C₂H₅)₃⁺, —N(C₃H₇)₃⁺, —NH(CH₃)₂⁺, —NH(C₂H₅)₂⁺, —NH(C₃H₇)₂⁺, —NHCH₃, —NHC₂H₅, —NHC₃H₇, —NH₂CH₃⁺, —NH₂C₂H₅⁺, —NH₂C₃H₇⁺, —SO₃H, —SO₃⁻, —SO₂NH₂, —C(NH)—NH₂, —NH—C(NH)—NH₂, —NH—COOH, or

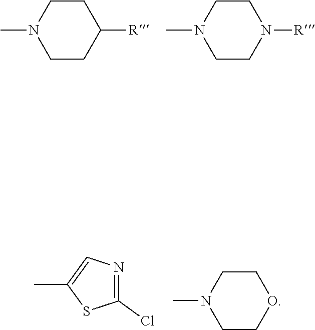

It is preferred that the carbon chain L is in the range of C1 to C7, more preferably in the range of C1 to C6, further preferably in the range of C1 to C5, and most preferably in the range of C1 to C4.

Preferably L represents —CH(NH₂)—COOH, —CH₂—CH(NH₂)—COOH, —CH₂—CH₂—CH(NH₂)—COOH, —CH₂—CH₂—CH₂—CH(NH₂)—COOH, —CH₂—CH₂—CH₂—CH₂—CH(NH₂)—COOH, or —CH₂—CH₂—CH₂—CH₂—CH₂—CH(NH₂)—COOH.

Preferred are compounds of general formula (III) having a free guanidino and/or amidino group, as shown below:

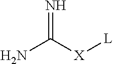

where the residues X and L have the meanings as disclosed herein.

Preferred compounds having a free guanidino and/or amidino group have the general formula (III) as a common feature:

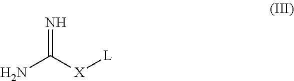

wherein
X represents —NH—, —NR″″—, or —CH₂— or a substituted carbon atom; and
L represents a C1 to C8 linear or branched and saturated or unsaturated carbon chain having at least one substituent selected from the group comprising or consisting of
—NH₂, —OH, —PO₃H₂, —PO₃H⁻, —PO₃²⁻, —OPO₃H₂, —OPO₃H⁻, —OPO₃²⁻, —COOH, —COO⁻, —CO—NH₂, —NH₃⁺, —NH—CO—NH₂, —N(CH₃)₃⁺, —N(C₂H₅)₃⁺, —N(C₃H₇)₃⁺, —NH(CH₃)₂⁺, —NH(C₂H₅)₂⁺, —NH(C₃H₇)₂⁺, —NHCH₃, —NHC₂H₅, —NHC₃H₇, —NH₂CH₃⁺, —NH₂C₂H₅⁺, —NH₂C₃H₇⁺, —SO₃H, —SO₃, —SO₂NH₂, —C(NH)—NH₂, —NH—C(NH)—NH₂, —NH—COOH, or

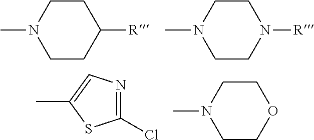

R′″ represents —H, —CH═CH₂, —CH₂—CH═CH₂, —C(CH₃)═CH₂, —CH═CH—CH₃, —C₂H₄—CH═CH₂, —CH₃, —C₂H₅, —C₃H₇, —CH(CH₃)₂, —C₄H₉, —CH₂—CH(CH₃)₂, —CH(CH₃)—C₂H₅, —C(CH₃)₃, —C₅H₁₁, —CH(CH₃)—C₃H₇, —CH₂—CH(CH₃)—C₂H₅, —CH(CH₃)—CH(CH₃)₂, —C(CH₃)₂—C₂H₅, —CH₂—C(CH₃)₃, —CH(C₂H₅)₂, —C₂H₄—CH(CH₃)₂, —C₆H₁₃, —C₇H₁₅, Cyclo-C₃H₅, cyclo-C₄H₇, cyclo-C₅H₉, Cyclo-C₆H₁₁, —C≡CH, —C≡C—CH₃, —CH₂—C≡CH, —C₂H₄—C≡CH, —CH₂—C≡C—CH₃

It is preferred that the carbon chain L is in the range of C1 to C7, more preferably in the range of C1 to C6, further preferably in the range of C1 to C5, and most preferably in the range of C1 to C4.

Preferably L represents —CH(NH₂)—COOH, —CH₂—CH(NH₂)—COOH, —CH₂—CH₂—CH(NH₂)—COOH, —CH₂—CH₂—CH₂—CH(NH₂)—COOH, —CH₂—CH₂—CH₂—CH₂—CH(NH₂)—COOH, or —CH₂—CH₂—CH₂—CH₂—CH₂—CH(NH₂)—COOH.

Preferred compounds having a free guanidino and/or amidino group have, as a common feature, the general formula (I)

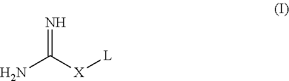

wherein
X represents —NH—, or —CH2- or a substituted carbon atom; and
L represents a C1 to C8 linear or branched and saturated or unsaturated carbon chain having at least one substituent selected from the group comprising or consisting of
—NH₂, —OH, —PO₃H₂, —PO₃H⁻, —PO₃²⁻, —OPO₃H₂, —OPO₃H⁻, —OPO₃²⁻, —COOH, —COO⁻, —CO—NH₂, —NH₃⁺, —NH—CO—NH₂, —N(CH₃)₃⁺, —N(C₂H₅)₃⁺, —N(C₃H₇)₃⁺, —NH(CH₃)₂⁺, —NH(C₂H₅)₂⁺, —NH(C₃H₇)₂⁺, —NHCH₃, —NHC₂H₅, —NHC₃H₇, —NH₂CH₃⁺, —NH₂C₂H₅⁺, —NH₂C₃H₇⁺, —SO₃H, —SO₃⁻, —SO₂NH₂, —C(NH)—NH₂, —NH—C(NH)—NH₂, —NH—COOH, or

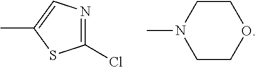

It is preferred that the carbon chain L is in the range of C1 to C7, more preferably in the range of C1 to C6, further preferably in the range of C1 to C5, and most preferably in the range of C1 to C4.

Preferably, L represents —CH(NH₂)—COOH, —CH₂—CH(NH₂)—COOH, —CH₂—CH₂—CH(NH₂)—COOH, —CH₂—CH₂—CH₂—CH(NH₂)—COOH, —CH₂—CH₂—CH₂—CH₂—CH(NH₂)—COOH, or —CH₂—CH₂—CH₂—CH₂—CH₂—CH(NH₂)—COOH.

The present invention preferably relates to a method for selectively binding, transporting and storing carbon dioxide in aqueous media, comprising the steps of:
(a) providing an aqueous acceptor solution containing at least one acceptor compound having a free guanidino and/or amidino group;
b) contacting a gas containing carbon dioxide with the acceptor solution of step a); and
c) transporting bound carbon dioxide/carbon dioxide derivatives in the acceptor solution of step b) through a separation membrane into an aqueous uptake and release medium; or
storing and/or transporting the acceptor solution containing bound carbon dioxide/carbon dioxide derivatives from step b),
wherein the acceptor compound has the general formula (I):

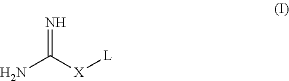

wherein
X represents —NH—, —NR″″—, or —CH₂— or a substituted carbon atom; and
L represents a C1 to C8 linear or branched and saturated or unsaturated carbon chain having at least one substituent selected from the group comprising or consisting of
NH₂, —OH, —PO₃H₂, —PO₃H⁻, —PO₃²⁻, —OPO₃H₂, —OPO₃H⁻, —OPO₃²⁻, —COOH, —COO⁻, —CO—NH₂, —NH₃⁺, —NH—CO—NH₂, —N(CH₃)₃⁺, —N(C₂H₅)₃⁺, —N(C₃H₇)₃⁺, —NH(CH₃)₂⁺, —NH(C₂H₅)₂⁺, —NH(C₃H₇)₂⁺, —NHCH₃, —NHC₂H₅, —NHC₃H₇, —NH₂CH₃⁺, —NH₂C₂H₅⁺, —NH₂C₃H₇⁺, —SO₃H, —SO₃⁻, —SO₂NH₂, —C(NH)—NH₂, —NH—C(NH)—NH₂, —NH—COOH, or

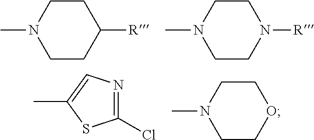

R′″ represents —H, —CH═CH₂, —CH₂—CH═CH₂, —C(CH₃)═CH₂, —CH═CH—CH₃, —C₂H₄—CH═CH₂, —CH₃, —C₂H₅, —C₃H₇, —CH(CH₃)₂, —C₄H₉, —CH₂—CH(CH₃)₂, —CH(CH₃)—C₂H₅, —C(CH₃)₃, —C₅H₁₁, —CH(CH₃)—C₃H₇, —CH₂—CH(CH₃)—C₂H₅, —CH(CH₃)—CH(CH₃)₂, —C(CH₃)₂—C₂H₅, —CH₂—C(CH₃)₃, —CH(C₂H₅)₂, —C₂H₄—CH(CH₃)₂, —C₆H₁₃, —C₇H₁₅, cyclo-C₃H₅, cyclo-C₄H₇, cyclo-C₅H₉, cyclo-C₆H₁₁, —C≡CH, —C≡C—CH₃, —CH₂—C≡CH, —C₂H₄—C≡CH, —CH₂—C≡C—CH₃,
L is in the range of C1 to C7, more preferably in the range of C1 to C6, further preferably in the range of C1 to C5, and most preferably in the range of C1 to C4, with L preferably representing —CH(NH₂)—COOH, —CH₂—CH(NH₂)—COOH, —CH₂—CH₂—CH(NH₂)—COOH, —CH₂—CH₂—CH₂—CH(NH₂)—COOH, —CH₂—CH₂—CH₂—CH₂—CH(NH₂)—COOH, or —CH₂—CH₂—CH₂—CH₂—CH₂—CH(NH₂)—COOH.

The acceptor solutions according to the invention can contain further compounds which do not have a guanidino and/or amidino group and have an advantageous effect on the method performance. These may, for example, be base-forming compounds, such as lysine and histidine.

Furthermore, the acceptor solution may contain compounds that, for example, have an antimicrobial effect or change the surface tension of the medium.

Preferred is a method in which the acceptor compound is an amino acid and the pH of the acceptor solution is in a range between 8 and 13.

In a further preferred method embodiment, the aqueous acceptor medium contains further compounds or additives. Preferred further compounds are in particular potassium hydroxide and sodium hydroxide. Surprisingly, it has been shown that the presence of these compounds allows the carbon dioxide bound in the acceptor medium, or the carbonate/hydrogen carbonate anions, to be separated with a low energy input when a DC voltage is applied.

Caustic solutions of potassium (KOH) or sodium (NaOH) improve the electrical conductivity (electrolyzability) of water in a concentration-dependent manner. The voltage above which electrolysis of water occurs is also reduced, ranging from 0.6 to 2 volts depending on the electrode configuration chosen. It was found that in a mixture of a solution containing arginine as an acceptor compound with a potassium or sodium hydroxide solution, electrolysis of water did not occur, while this was the case with aqueous potassium or sodium hydroxide solutions with an identical concentration without arginine. For example, after 30 minutes in the electrolysis apparatus, the generation of 18.2 ml of oxygen at the anode and 6.4 ml of hydrogen at the cathode occurred when a voltage of 12V was applied to a 3% NaOH solution. Using the same experimental setup, no gas formation was observed with a 2 molar arginine solution containing 3 wt % NaOH. Using the same experimental setup with a 2 molar arginine solution that was saturated with carbon dioxide, no gas formation was observed during a period of 30 minutes when a voltage of 12 V was applied. When NaOH was added to this solution so that a 3 wt % solution was present, 7.8 ml of gas formed at the cathode and no gas was formed at the anode under the same conditions (12V). The gas formed/evolved at the cathode was carbon dioxide. Thus, it could be shown that when a DC voltage is applied, hydrogen carbonate/carbonate anions, which are bound in the acceptor medium, can be released at the cathode in form of carbon dioxide in the presence of hydroxide ions. It was shown for DC voltages above 40V that even with a 4 wt % solution of NaOH or KOH in an aqueous solution containing arginine and dissolved carbon dioxide/hydrogen carbonate/carbonate anions, there was no electrolysis of the water leading to oxygen formation. However, with higher DC voltage a considerable amount of carbon dioxide evolved at the cathode.

Thus, surprisingly, it has been shown that the presence of a potassium and/or sodium hydroxide solution in an aqueous acceptor solution according to the invention results in the separation of hydrogen carbonate-carbonate anions and release of gaseous carbon dioxide at the cathode during the application of a DC voltage to the carbon dioxide-enriched acceptor solution, whereby no electrolysis of the water occurs, i.e. no production of oxygen and hydrogen. This allows very efficient utilization of the electrical power required to separate and recover carbon dioxide from an acceptor solution.

It was then found that the presence of an alkali lye in the acceptor liquid increases the acceptor solution's capacity to absorb carbon dioxide and there is no formation of potassium or sodium carbonate as solids, whereas this is the case when no acceptor compounds of the invention are present in the acceptor medium. This means that carbon dioxide advantageously reacts preferentially with the arginine.

It was further shown that the presence of an alkali lye has no effect on the storage properties of the acceptor solution. In particular, there is no spontaneous release of carbon dioxide from the acceptor solution in the presence of an alkali.

Therefore, an addition of sodium hydroxide solution or potassium hydroxide solution to the aqueous acceptor medium is a particularly preferred embodiment of the method according to the invention.

Preferably, NaOH and/or KOH is added to an aqueous acceptor solution forming a concentration between 0.01 and 10 wt %, more preferably between 0.5 and 8 wt %, more preferably between 1 and 6 wt % and more preferably between 2 and 5 wt %. In a further preferred method embodiment, an aqueous acceptor solution containing potassium hydroxide or sodium hydroxide is provided, with a pH between 12 and 14.

Preferred is a method wherein the aqueous acceptor medium containing a dissolved acceptor compound additionally contains a potash and/or sodium hydroxide solution.

Preferred is a method in which the addition of a potassium and/or sodium hydroxide solution to an acceptor solution containing dissolved carbon dioxide/hydrogen carbonate/carbonate anions results in electrolysis-free electrophoretic separation of hydrogen carbonate/carbonate anions and release with formation of gaseous carbon dioxide as gas phase.

The addition of NaOH or KOH results in corrosiveness of the acceptor medium with increasing concentration. For example, decomposition of electrode material made of carbon or aluminum occurred.

It was found that an improvement of the electrophoretic separation of carbon dioxide or its derivatives from an acceptor medium according to the invention is also possible by salts of sodium and/or potassium.

For example, it was shown that when sodium citrate or sodium sulfate or potassium tartrate were added to a 2 molar arginine solution, so that in each case an 8-14 wt % solution of the salts was present, the electrophoretic separation of carbon dioxide improved compared with the use of NaOH or KOH, while at the same time the pH of the solution remained <12.5.

Investigations into the binding capacity of the aqueous acceptor solution containing dissolved salts of sodium and/or potassium for carbon dioxide or its water-soluble derivatives showed that this could be increased as a function of concentration. Thus, by providing an aqueous acceptor solution containing, in addition to an acceptor compound according to the invention, dissolved salts of sodium and/or potassium, the absorption capacity of the acceptor solution for carbon dioxide or its derivatives can be improved. It was shown that neither the absorption of carbon dioxide nor desorption by an electrophoretic method resulted in the formation of solids.

The preferred concentration of sodium or potassium salts in an acceptor solution according to the invention is between 0.1 and 25 wt %, more preferably between 1 and 20 wt % and further preferably between 2 and 15 wt %. The preferred counterions of the salts are: sulfate SO₄²⁻, phosphate PO₄³⁻, acetate, citrate, tartrate, oxalate. The salts can be added individually or in any combination to the acceptor solution. The pH of the acceptor solution containing dissolved sodium and/or potassium salts is preferably between 8.0 and 13.5 more preferably between 8.5 and 13 and further preferably between 9 and 12.5. The preferred acceptor solutions containing sodium and or potassium salts are non-corrosive.

Preferred is a method in which an aqueous acceptor solution containing at least one dissolved acceptor compound and at least one dissolved sodium and/or potassium salt is provided for the absorption of carbon dioxide, and carbon dioxide, or derivatives thereof, is/are dissolved/bound therein.

It has been found that carbon dioxide is not spontaneously released under atmospheric pressure even from acceptor solutions containing sodium and/or potassium salts which have been loaded with carbon dioxide to saturation.

Preference is given to a method in which carbon dioxide can be bound without pressure (at atmospheric pressure or normal pressure) over the course of more than 12 months by means of an aqueous acceptor solution.

It has been found that this property also results in the ability to transport carbon dioxide in the aqueous acceptor solution in a pressureless manner (at atmospheric pressure or normal pressure).

Preferred is a method in which carbon dioxide can be transported pressureless (at atmospheric pressure or normal pressure) by means of an aqueous acceptor solution.

Preferred is a process in which carbon dioxide/carbon dioxide derivatives bound in an acceptor solution can be transported and/or stored Thus, the task is solved by a method for selective binding, transport and storage of carbon dioxide in aqueous media which is characterized by the steps:
a) providing an aqueous acceptor solution containing at least one acceptor compound having a free guanidino and/or amidino group,
b) contacting a gas containing carbon dioxide with the acceptor solution of step a) until a carbon dioxide concentration of the gas of <100 ppm is reached,
c) transporting and/or storing the acceptor solution containing bound carbon dioxide/carbon dioxide derivatives of step b).

Preferably, the method is one in which the acceptor compound is an amino acid and the pH of the acceptor solution is in a range between 8 and 13.

Preferably, the acceptor solutions are prepared using deionized water (DI water). The one or more acceptor compound(s) is/are preferably completely dissolved in the water. In this method, the solution may be heated to increase the solubility of the one or more compound(s).

Since it has surprisingly been found that the solubility of acceptor compounds can be significantly increased by bringing carbon dioxide into contact with the acceptor solution during or following a heat-induced dissolution method of a portion of the acceptor compound, in a preferred embodiment the dissolution method of acceptor compounds is performed while introducing carbon dioxide. In this way, undissolved acceptor compounds can be dissolved/go in solution, or a further increase in the concentration of the acceptor compound(s) is possible. Using arginine as an example, it was shown that concentrations of 5 mol/l and more can be achieved.

Furthermore, these solutions remain stable, i.e. no crystallization of the acceptor compound(s) develops.

Preferred is a method in which the solubility of an acceptor compound is increased by contacting the acceptor medium, in which the acceptor compound is present in dissolved and/or undissolved form, with a gas/gas mixture consisting of or containing carbon dioxide.

Preferred is a method in which contacting of the acceptor medium with a gas/gas mixture containing at least one gaseous compound which forms a water-soluble compound on contact with water is performed, and in which the water-soluble compounds are present in ionic or ionizable form in the acceptor medium, with formation of a reversible bond of the dissolved compound with the dissolved acceptor compound.

Preferably, the contacting of the gas phase with the acceptor medium is performed until the content of the gas/gaseous compound dissolved in the acceptor medium is <100 ppm.

It has been shown that extraction of carbon dioxide according to the invention is possible for a wide variety of gases/gas mixtures, resulting in very beneficial effects. For combustion gases from diesel and gasoline engines as well as from coal blast furnaces, it was shown that the carbon dioxide content contained therein, which was between 10 and 25 wt. %, can be reduced to <0.01 vol. %, e.g. by bringing the gas into contact with an acceptor solution by means of a static mixer. Removal of the carbon dioxide content, which was present in an amount of 52 vol % in a gas mixture from a biogas production, was possible, obtaining a biomethane with a purity of >98.5 vol %. It was found that gases or gaseous compounds which do not form an acid on contact with water are not bound to the acceptor compound(s) according to the invention and thus there is no discharge from the gas/gas mixture brought into contact with an acceptor solution, nor is it present in the acceptor solution in a higher concentration than is the case at the given partial pressure established when the gas phase and the acceptor medium are brought into contact. For example, there is no enrichment in the acceptor solution for oxygen, nitrogen, carbon monoxide, noble gases or hydrocarbons, such as methane or butane.

Preferred is a method for the production of a methane pure gas.

Preferred is a method for producing a bio-methane pure gas.

It has been found that, by means of the acceptor solutions according to the invention, gases/gaseous compounds which form an acid upon contact with water can be bound in an aqueous acceptor solution. Where selective extraction and/or recovery of carbon dioxide is desired, it is advantageous to remove other gases/gaseous compounds that also form an acid in water and thus may compete with the absorption of carbon dioxide from a gas/gas mixture before it is contacted with one of the acceptor compounds according to the invention. Preferably, removal or reduction of compounds from those gases/gas mixtures including components such as SO₂, H₂S, NO, NO₂, as well as other nitrogen oxides or Cl₂ or HCl. This can be done with prior art methods, such as catalysts, adsorbents or aqueous gas scrubbing.

The gas/gas mixture to be contacted with the acceptor solution preferably has a temperature between 0 and 100° C., more preferably between 1° and 85° C. and further preferably between 15 and 70° C. In principle, the acceptor solution can also be used to cool a gas/gas mixture, so that higher temperatures of a gas/gas mixture are also possible. In order to avoid evaporation of the aqueous acceptor medium, in this case cooling of the solution should preferably be provided. The gas/gas mixture obtainable after contacting with an aqueous acceptor medium may contain water vapor as well as water in droplet form, depending on the temperature, composition, volume flow or type of contacting.

It is possible that acceptor solution and thus acceptor compounds are lost as a result. Therefore, it is preferable to remove as much residual water as possible from the treated gas/gas mixture. This can be done with methods from the prior art, such as a device for condensate separation. The separated water phase is then returned to the acceptor solution. The acceptor compounds according to the invention are not consumed in the method performance according to the invention and are not subject to an autocatalytic method. Therefore, the method is directed to an economical method performance in which the acceptor compound is reused without loss in a recirculation method.

Preferred is a process-economic method in which loss-free reuse of the acceptor compound is performed.

It has been found that when a membrane contactor is used, bringing even hot and dry gas streams into contact does not result in a relevant loss of aqueous acceptor solution. This is possible by selecting a suitable membrane/solid separation medium. For example, it is possible to treat gases with a temperature up to 150° C. in a membrane contactor that has a polycarbonate membrane as an interface. If ceramic films are used, gas streams with a temperature of >200° C. can also be treated. Therefore, in a preferred process design, extraction of water-soluble gases/gas components of a gas stream is performed by bringing the acceptor medium into contact with the gas stream in a membrane contactor. In a particularly preferred process embodiment, the contacting of a gas stream containing at least one water-soluble gas component, which has a temperature of up to 350° C., with an aqueous acceptor medium is performed in a membrane contactor. Therefore, in a preferred embodiment of the process, use is made of a membrane contactor for contacting an acceptor liquid (acceptor solution) with a gas stream having or consisting of at least one water-soluble gas fraction and preferably introduced into the membrane contactor in a temperature range between 1° and 400° C., more preferably between 5° and 350° C., and further preferably between 7° and 300° C.

Preferred is a method in which a gas stream containing at least one water-soluble gas component and having a temperature of up to 350° C. is contacted with an aqueous acceptor medium in a membrane contactor.

Gaseous carbon dioxide is taken up very rapidly and completely at the interface with an acceptor medium as long as acceptor compounds are still present therein which have not been involved in binding carbon dioxide/carbonate/hydrogen carbonate anions. A carbon dioxide-saturated acceptor solution in which carbon dioxide is completely dissolved is clear and there is no spontaneous release/evolution of gas.

In this context, completely dissolved means that in a closed vessel containing the dissolved carbon dioxide/carbonate/hydrocarbonate anion(s) at 20° C., no vapor pressure greater than 2 kPa develops due to carbon dioxide.

It was found that degassing (evolution of CO2 as a gas phase) can be done, for example by lowering the pH of the acceptor medium. This can be done, for example, by adding an acid.

In the analysis of the gas stream obtained by degassing the aqueous acceptor solution containing guanidino and/or amidino group bearing compounds and carbon dioxide dissolved therein in saturated form, no compound other than carbon dioxide could be detected upon the addition of an acid (e.g. HCl).

It has been shown that the release/evolution of the carbon dioxide dissolved in the acceptor medium of the invention or of the bound hydrogen carbonate/carbonate anions in the form of a pure carbon dioxide gas phase can be achieved by methods which lead to protonation of the acceptor liquid (acceptor solution). In one embodiment of the method, for example, an acid from the prior art can be used.

These can be organic or inorganic acids. Preferred organic acids are formic acid or acetic acid. Preferred inorganic acids are hypochlorous acid (HCl) or sulfuric acid. The concentration of the acid and the volume ratio in which it is added to the acceptor liquid are in principle freely selectable. Concentrated acids are preferred. By adding the acid, a pH of the acceptor liquid is adjusted which is preferably in the range between 2 and 7, more preferably in the range 3 to 6, and more preferably in the range between 3.5 and 5. Thereby, a removal of carbon dioxide dissolved/bound in the acceptor liquid, or its water-soluble derivatives, of preferably >70 wt %, more preferably >80 wt % and more preferably >90 wt % is achieved and is obtainable as a pure carbon dioxide gas phase.

Preferred is a method in which an aqueous acceptor medium is saturated with a water-soluble gas and subsequently a release/evolution of the water-soluble gas bound in the acceptor liquid (acceptor solution) is effected by adjusting the pH of the acceptor medium to a range between 2 and 7.

Preferred is a method in which an aqueous acceptor medium is saturated with a water-soluble gas and subsequently a release/evolution of the water-soluble gas bound in the acceptor liquid (acceptor solution) is effected by adjusting the pH of the acceptor medium to a range between 2 and 7 by adding an acid.

Addition of an acid to the acceptor medium causes the introduction of anions, the retention of which in the acceptor liquid has a detrimental effect on the reabsorption capacity of the acceptor compounds towards water-soluble gases, or its derivatives. Therefore, in a preferred form of method execution, following the introduction of anions that do not correspond to one of the water-soluble forms of the water-soluble gas/gas component with which the acceptor liquid (acceptor solution) has been treated, the added anions are separated before the acceptor liquid (acceptor solution) is exposed again to a water-soluble gas/gas component. Prior art methods are known for this purpose. For example, removal of anions such as Cl⁻ (chloride) or SO₄²⁻ (sulfate) is possible by means of electrodialysis. However, such electrophoretic methods can also be used to remove organic acid residues, whereby regeneration of the acceptor liquid (acceptor solution) can also be achieved. In a further and preferred method embodiment, a caustic solution, such as potassium hydroxide solution or sodium hydroxide solution, is added to the acceptor liquid (acceptor solution) to which an inorganic acid has been added. Preferably, the caustic solution is metered such that the addition produces an equimolar ratio between the anions that have been added to the acceptor medium on the one hand and the cations that are added by the addition of the caustic solution on the other.

Preferably, this is followed by a separation of the resulting salt. This can preferably be done by means of an electrophoretic method, e.g. electrodialysis. The acceptor liquid (acceptor solution) regenerated in this way can then be used for the renewed uptake of water-soluble gases/gas components or its water-soluble derivatives.

However, other cationic compounds are also known in the prior art, which can be used as an alternative to an alkali in order to bind or dissolve the free anions as well as the anions bound to the acceptor compound, which have been added to release the water-soluble gas, in order to then remove them from the aqueous acceptor medium using one of the method types listed herein, so that the acceptor liquid (acceptor solution) is available for the renewed absorption of water-soluble gases/gas components.

Preferred is a method in which an aqueous acceptor medium is saturated with a water-soluble gas and subsequently the water-soluble gas bound in the acceptor liquid (acceptor solution) is released/evolved by the addition of an acid and subsequently the acceptor liquid (acceptor solution) is regenerated by the addition of a lye and subsequently the salt formed is separated by electrophoretic separation.

In a further preferred method embodiment, the pH of the acceptor liquid (acceptor solution) saturated with a water-soluble gas/gas component, or its water-soluble derivatives, is lowered by means of an electrochemical method. This can be accomplished, for example, by introducing the acceptor liquid (acceptor solution) containing a dissolved water-soluble gas/gas fraction, or its derivatives, into an electrodialysis device. Preferably, an arrangement of the electrodialysis chambers is selected in which an electrolyte chamber is connected to the acceptor chamber on the anode side. Preferably, there is a cation-selective membrane between the chambers. The water-soluble derivatives of carbonic acid are then released/evolved in the acceptor chamber as carbon dioxide.

Preferred is a method in which an aqueous acceptor medium is saturated with a water-soluble gas and then release/evolution of the water-soluble gas bound in the acceptor liquid is achieved by adjusting the pH of the acceptor medium to a range between 2 and 7 by an electrochemical method.

Preferred is a method in which, contacting a gas containing carbon dioxide with the acceptor solution is performed until the gas reaches a carbon dioxide concentration of <100 ppm, or after transport and/or storage of the acceptor solution containing bound carbon dioxide/carbon dioxide derivatives, the following method step is carried out: Release/evolution of the carbon dioxide bound in the acceptor medium as gas phase.

In a further preferred method embodiment, the release of the water-soluble gas/gas fraction dissolved and bound in the aqueous acceptor medium, or its derivatives, is performed following a spatial separation from the acceptor medium. In a preferred method embodiment, the dissolved and bound carbon dioxide/carbonate/hydrogen carbonate anion(s) are transported by an electrophoretic method into an uptake and release medium. It has been shown that in an uptake and/or release medium according to the invention, into which carbonate/hydrogen carbonate anions have been transported, a gas phase spontaneously forms. In the gas phase that forms, only carbon dioxide could be detected. Thus, without applying any pressure, it is possible to selectively remove carbon dioxide from a gas mixture and release it in isolated form into a collection vessel.

Surprisingly, it was found that the dissolved carbon dioxide/carbonate/hydrogen carbonate—anions can be separated from the acceptor solution very easily using a membrane method. This does not require any change in the pH of the acceptor solution. Thus, it was found that membranes permeable to gaseous compounds and/or anions are suitable for selective transport of carbon dioxide/carbonate/hydrogen carbonate anions. However, it was found that open-pored membranes/separating media are also suitable for allowing non-selective passage of carbon dioxide/carbonate/hydrogen carbonate anions.

Surprisingly, open-pore membranes are particularly suitable for the separation of dissolved carbon dioxide/carbonate/hydrogen carbonate anions from the aqueous media of the invention. Microporous or mesoporous membranes are preferred. However, macroporous and nanoporous membranes can also be used. The outer and inner membrane surfaces can be hydrophilic or hydrophobic. Hydrophobic membrane surfaces are preferred. It has been shown that, compared to anion exchange membranes or bipolar membranes consisting of a closed polymer film, a significantly larger mass/volume flow of the electrophoretically transported carbon dioxide/carbonate/hydrogen carbonate anion(s) is possible.

Preferred is a method in which the separation of dissolved carbon dioxide/carbonate/hydrogen carbonate anions is performed by means of open-pore membranes. The open-pored membranes are preferably microporous and/or mesoporous and have hydrophobic surface properties.

Preferred transport modes for carbon dioxide/carbonate/hydrogen carbonate anions are based on a diffusive method, a concentration gradient, or a thermal or electrical gradient, as well as combinations thereof. Preferred are open-pored membranes, i.e., a solid or semisolid separation medium (separation membrane) suitable to retain an aqueous medium without pressure and having open pores connecting the two sides of the membrane and permeable to a gas and/or anions. Preferably, the open pores have an average diameter between 10 nm and 1 mm, more preferably between 100 nm and 500 micrometers, and more preferably between 1 micrometer and 200 micrometers. The preferred membranes exhibit hydrophilic or hydrophobic electrostatic properties on their inner and/or outer surfaces.

Due to the saturation of the acceptor medium according to the invention, carbon dioxide is completely bound, so that there was no separation and thus there was no pressure build-up in an acceptor chamber. This is particularly advantageous because it allows a separation method for separating dissolved carbon dioxide or its reaction products with water to be performed with an open-pored separation membrane without the need for pressure equalization between the vessels containing the acceptor medium or an uptake and/or release medium. Hereby, the receiving device for the uptake and/or release medium can be open to atmospheric pressure. In a preferred embodiment, the receiving devices (chambers) for the acceptor medium and for the uptake and/or release medium are open to atmospheric pressure.

Surprisingly, confluent gas bubbles formed very rapidly on both sides of such a separation membrane when an aqueous solution containing an acid was placed in the chamber unit adjacent to the acceptor chamber. Thus, by a diffusive method, carbonate/hydrogen carbonate anions pass through the separation medium (separation membrane) into the chamber unit adjacent to the acceptor chamber where an acid was placed, releasing carbon dioxide. In the following, this chamber unit is referred to as an uptake and release chamber. Consequently, the medium contained in an uptake and release chamber is called uptake and release medium.

As will be discussed below, it is possible that other separation media may also be used to allow transport of carbon dioxide/carbonate/hydrocarbonate anions from an aqueous acceptor medium in an uptake and release medium.

Preferred is a method in which a separation of carbon dioxide/carbonate/hydrocarbonate anions from an aqueous acceptor medium is performed through a separation medium (separation membrane) and is/are thereby taken up and/or released in an uptake and release medium.

Preferred is a method in which a separation of carbon dioxide/carbonate/hydrocarbonate anions from an aqueous acceptor medium is performed by a separation medium (membrane) based on a diffusive, osmotic and/or electrophoretic method.

Preferred is a method in which the separation medium for separating carbon dioxide/carbonate/hydrocarbonate anions from an aqueous acceptor medium is a solid or semisolid separation medium (separation membrane) which is capable of retaining an aqueous medium without pressure (atmospheric pressure) and has open pores that connect both sides of the membrane and are permeable to a gas and/or anions.

Preferred is a method in which the solid or semi-isolated separation medium (separation membrane) for separating carbon dioxide/carbonate/hydrocarbonate anions is a separation membrane.

Preferred is a method in which the separation membrane for separation of carbon dioxide/carbonate/hydrocarbonate anions is an anion-selective or bipolar polymer membrane.

Surprisingly, dissolved carbon dioxide, or carbonate/hydrocarbonate anions can be separated very efficiently from the acceptor solution of the invention using electrophoretic techniques.

Preferably, electrodialysis is performed for the separation of dissolved carbon dioxide/hydrogen carbonate anions. In this regard, electrodialysis can be performed using prior art methods and devices.

It has been found that the electrophoretically transported carbon dioxide/carbonate/hydrogen carbonate anion(s) separate(s) in the uptake and/or release medium containing anionic amino acids and are released as gaseous carbon dioxide.

In a preferred method embodiment, separation of carbon dioxide/carbonate/hydrocarbonate anions from an aqueous acceptor medium is performed by filling the acceptor medium containing carbon dioxide/carbonate/hydrocarbonate anions into an acceptor chamber, which is separated by a separation medium (separation membrane) from an uptake and release chamber adjacent thereto. The uptake and release chamber preferably contains an uptake and/or release medium. This is preferably an aqueous medium. Preferably, this has a pH in the range between 1 and 7, more preferably between 2 and 6 and more preferably between 3 and 5. In a particularly preferred embodiment, compounds having acid groups are dissolved in the uptake and/or release medium. Particularly preferred are compounds bearing at least one acid group and having an isoelectric point in the range between 3 and 5, or more preferably between 3.5 and 4.5. Particularly preferred are amino acids bearing acid groups, especially aspartic acid and glutamic acid. The preferred concentration is in a range between 1 mmol/l and 3 mol/l. Further preferred are organic acids that have more than one acid group and have good water solubility, such as citric acid or ascorbic acid. In principle, inorganic acids are also suitable, such as sulfuric acid or diphosphoric acid. When inorganic acids are used, aqueous solutions of these acids with a concentration between 1 and 50 wt % are preferred. Furthermore, mixtures of different acids are preferred. The temperature range in which the uptake and release medium is used can in principle be freely selected between 1 and 99° C. Preferred is a temperature range between 3° and 80° C., further preferred between 4° and 75° C. and still further preferred between 5° and 70° C.

Preferred is a method in which the uptake and release chamber contains an uptake and/or release medium in which at least one compound is present which has at least one acid group and has an isoelectric point in the range between 3 and 5.

Preferred is a method in which the uptake and/or release medium is an aqueous solution of an organic and/or inorganic acid.

Surprisingly, it has been found that this method embodiment is suitable for enabling selective transport of carbon dioxide or carbonate/hydrogen carbonate anions into the uptake and release chamber or the uptake and/or release medium, whereby the carbon dioxide is released/evolved from the uptake and/or release medium and gaseous carbon dioxide is formed from the carbonate/hydrogen carbonate anions by cleavage of water, so that a gas phase is formed in which only carbon dioxide is present. Thus, it is possible to selectively bind and transport carbon dioxide and to selectively release it at any desired location.

In a preferred method embodiment, there is a continuous or discontinuous flow of the uptake and release medium through the uptake and release chamber, preferably with a high overflow velocity at the surface of the release medium (separation membrane), whereby gas evolution at the surface of the separation medium (separation membrane) can be completely or almost completely prevented and an uptake of hydrogen carbonate/carbonate anions into the uptake and release medium is accomplished, with which these are preferably introduced into a separate container, in which the outgassing/release is then performed. It has been found that it is particularly advantageous if the release/removal of carbon dioxide is as complete as possible in this separate release vessel and the uptake and release medium is then returned to the uptake and release chamber, whereby the transport performance both through the separation medium and in the uptake and release medium can be significantly increased (see FIG. 1). Efficient degassing of the uptake and release medium can be achieved, for example, by flowing over surfaces. Preferably, these are hydrophobic surfaces made of materials such as PTFE or graphite. Furthermore, degassing can be achieved by known techniques, such as applying a vacuum, applying ultrasound, applying shear forces to generate cavitation, and/or heating the uptake and release medium.

In a preferred embodiment, the separation of carbon dioxide/carbonate/hydrogen carbonate anions from the aqueous acceptor medium is performed by an electrodialysis method. In this method, the acceptor solution in which carbon dioxide or its reaction products with water are present in solution is fed to an acceptor chamber of an electrodialysis unit. In the simplest case, the electrodialysis unit consists of an acceptor chamber and an uptake and release chamber, which are separated from each other by a separating medium (separating membrane).

The electrodes can be located directly in the process media, i.e. the anode can be located in the uptake and/or release medium and the cathode can be located in the acceptor solution. More preferred are electrodialysis devices in which the electrodes are located in an anode or cathode chamber (electrode chambers) and in which the acceptor chamber or uptake and release chamber are separated from the electrode chambers by an ion-selective membrane, the anode and cathode chambers being filled with a medium suitable for electron transport, e.g. an electrolyte solution (see FIG. 1). In a further preferred embodiment, multiple chamber units consisting of acceptor chambers and uptake and release chambers are joined together in a repeating arrangement, the chamber stacks being terminated at both ends by the anode and cathode chambers, respectively, and electrically conductively connected thereto. In a preferred process arrangement, the first acceptor chamber is adjacent to the cathode chamber and the last uptake and release chamber is adjacent to the anode chamber. In a further preferred process embodiment, the acceptor chambers are each separated from the uptake and release chambers by a bipolar membrane.

Preferably, the transport of carbon dioxide or carbonate/hydrogen carbonate anions is performed by applying a DC electrical voltage between the cathode and anode. The voltage and current at which electrodialysis according to the invention is performed depend on specific process parameters, such as the distance between the electrodes, the number of chamber units, the resistance of the membranes and of the process solutions, and the cross-sectional area, and are thus to be determined individually.

In a preferred embodiment, the carbon dioxide transported through the separation medium (separation membrane) is released as a gas in the uptake and release chamber containing the uptake/release medium. In a further preferred embodiment, the carbon dioxide or carbon dioxide derivatives transported through the separation medium (separation membrane) is taken up in the uptake/release medium and is released as a gas in a release device.

Preferred is a method in which step b) or c) is followed by step c1) or d1): Release of the carbon dioxide bound in the acceptor medium as a gas phase.

Preferred is a method in which the acceptor medium from step b) is located in or introduced into an acceptor chamber of an electrodialysis device and the transport of carbon dioxide/carbon dioxide derivatives according to step c) is performed by means of an electrical gradient established between the acceptor chamber and an uptake and release chamber, the acceptor chamber(s) and the uptake and release chamber(s) being separated from each other by a separation medium (separation membrane).

Preferred is a method in which carbon dioxide/carbon dioxide derivatives are transported through a separation medium (separation membrane), wherein the separation medium is a membrane permeable to ions and/or gas molecules.

Preferred is a method, for electrodialysis of an acceptor medium and transport of carbon dioxide/carbon dioxide derivatives according to step c) by means of an electrical gradient established between the acceptor chamber and an uptake and release chamber, wherein the separation medium is a membrane permeable to ions and/or gas molecules.

Preferred is a method in which a release/evolution of the carbon dioxide/carbon dioxide derivative(s) transported through the separation medium (separation membrane) is performed in the uptake and release chamber in the form of pure carbon dioxide gas.

Preferred is a method in which the carbon dioxide/carbonate/hydrocarbonate anion(s) transported through the separation medium (separation membrane) is/are released in the form of pure carbon dioxide gas in the uptake and release chamber.

Preferred is a method in which step b) or c) is followed by step b2) or c2): Separation of carbon dioxide/carbonate/hydrocarbonate anions from the acceptor medium through a separation medium (separation membrane) by means of a diffusive, osmotic or electrophoretic method and transport into an uptake/releasing medium, wherein a release of carbon dioxide as a pure gas phase is accomplished in the uptake/releasing medium.

Preferred is a method in which step b) or c) is followed by step b3) or c3): Separation of carbon dioxide/carbonate/hydrocarbonate anions from the acceptor medium through a separation medium (separation membrane) by means of a diffusive, osmotic or electrophoretic method and transport into an uptake/release medium, wherein the release of carbon dioxide as a pure gas phase from the uptake/release medium is accomplished in a release device.

Preferred is a method in which step c) is followed by steps c3′) and c3): c3′) introducing the aqueous uptake and release medium containing bound carbon dioxide/carbon dioxide derivatives from step c) into a release device; and c3): Releasing carbon dioxide as a gaseous phase from the uptake and release medium containing bound carbon dioxide/carbon dioxide derivatives from step c3′) in the release chamber.

Preferred is a method in which the acceptor medium from step b) is located in or introduced into a cathode chamber of an electrodialysis device and the transport of carbon dioxide/carbon dioxide derivatives according to step c) is performed by means of an electrical gradient established between the cathode chamber and an anode chamber, the cathode chamber(s) and the anode chamber(s) being separated from each other by an ion- or gas-permeable separation medium (separation membrane).

In a preferred embodiment, the chambers in which carbon dioxide is or can be released are provided with a collection device for a gas, which preferably allows no pressure build-up to take place in this chamber.

In a preferred embodiment, the carbon dioxide which is released after one of the methods following a binding in an acceptor medium is collected in a gas collection device and from there is supplied to a further use (see FIG. 1).

A method in which carbon dioxide is released again as a gas phase following binding/transport or storage in an acceptor medium and is fed to a further use is preferred.

In a further preferred embodiment of the method according to the invention, a process arrangement according to the invention is used to produce hydrogen and oxygen in addition to the separation of water-soluble gases/gas components and the selective release. In a preferred process embodiment, in which an electrodialysis device is used for the transport of carbon dioxide/carbonate/hydrogen carbonate anions, there is electrolysis of water in the electrode chambers, since a voltage must generally be applied that causes electrolysis in the respective selected electrolyte solutions. It was found that a chamber arrangement consisting of an acceptor chamber and an uptake and release chamber can be introduced into a process arrangement for electrolysis, whereby the energy efficiency of the method according to the invention can be significantly increased. Due to the additional availability of hydrogen and oxygen, a very high energy efficiency of the method can be achieved, which is preferably >90%, more preferably >95% and further preferably >98%.

In a further preferred method embodiment, the release/evolution of water-soluble gas/gas fraction dissolved in an aqueous acceptor medium is performed at a cathode. Surprisingly, it was found that the acceptor solutions according to the invention are suitable to suppress electrolysis of water leading to a formation of oxygen and hydrogen when a DC voltage is applied, although there is a current flow due to the conductivity of the acceptor solution. This phenomenon was found particularly when arginine was used as the acceptor compound. Thus, a there is molecular charge transfer takes place. It was found that molecular charge transfer takes place preferentially over electrolysis with increase in the distance between the anode and cathode. Thus, even when a voltage of 40V and a low-amperage current flow (<200 mA) was applied, no gas formation was observed. Also unexpected was the observation that in the presence of a potassium or sodium hydroxide solution in an acceptor solution containing dissolved arginine, there was also no electrolysis of the water that resulted in hydrogen or oxygen production, while electrolysis of the water was present at the same voltage and current setting with pure potassium or sodium hydroxide solutions of identical concentrations.

Thus, preferential charge transfer is accomplished via the dissolved acceptor compound. It was then found that when the acceptor solution was loaded with a water-soluble gas, with formation of water-soluble derivatives in the acceptor solution, gas formation was evident exclusively at the anode upon application of a DC voltage. In the case where carbon dioxide was used as the water-soluble gas to which the acceptor liquid acceptor solution was exposed, the gas formed at the cathode consisted of pure carbon dioxide. Thus, a method was found by which a water-soluble form of a water-soluble gas can be selectively released/evolved as a gas at the cathode via an internal charge transfer in an acceptor solution when a DC voltage is applied.

Preferred is a method in which an aqueous solution containing dissolved arginine, upon application of a DC voltage to the aqueous solution, causes suppression of electrolysis of the water that results in formation of hydrogen or oxygen.

Preferred is a method wherein a solution containing dissolved arginine, when a DC voltage is applied to the aqueous solution, effects a molecular charge transfer.

Preferred is a method wherein electrolysis can be suppressed by providing an acceptor solution when a DC voltage is applied. Preferred is a method in which a gas dissolved in an aqueous acceptor solution, or its water-soluble derivatives, can be released/evolved as a gas phase at a cathode under application of a DC voltage, with no electrolysis that results in the formation of hydrogen or oxygen.

Thus, a method can be provided in which a separation of water-soluble derivatives of water-soluble gases can be accomplished as a gas phase at a cathode, with the application of a DC voltage and without electrical loss by electrolysis leading to the formation of oxygen or hydrogen.

In principle, this method execution can be performed with devices for electrodialysis from the prior art. It has been shown that, depending on the energy density that is generated at the electrodes when a DC voltage is applied, the distance between the electrodes should be chosen to be large enough so that oxygen is not formed (evident by the absence of gas formation at the anode). Accordingly, for a given configuration of electrodes and a given distance between them, the voltage can be chosen so that there is no gas formation at the electrodes when the electrical voltage is applied to an unloaded acceptor solution. It is advantageous to use electrodes with a large surface area. It is further advantageous if the surface area of the anode is larger than that of the cathode. In an advantageous embodiment, the anode and cathode chambers are separated by a separating medium (membrane), resulting in an electrically interconnected anode and cathode chamber. It is advantageous if the separating medium (membrane) has the lowest possible electrical resistance. Preferably, the separation medium (membrane) should be open-pored but prevent gas passage. In a preferred embodiment, there is a direct and open connection between the chambers so that the acceptor fluid can pass through freely, below the electrode level, at the electrode level, or both. In a further preferred embodiment, flow through the electrode chambers is effected by introducing the acceptor liquid loaded with a water-soluble gas into the cathode chamber and passing the solution consecutively through the anode chamber. The solution is passed through the open connections and/or the separating medium (separating membrane), which can be passed by a liquid and is located between the electrode chambers. It has been found that this allows the segregation/evolution of a gas phase of the gases dissolved in the aqueous acceptor medium, or their water-soluble derivatives, to be significantly increased.

In principle, the electrode material can be freely selected. If, in addition to the acceptor compounds according to the invention, potassium hydroxide or sodium hydroxide is present in the acceptor medium, the selection must be adapted accordingly. Preferred electrode materials are graphite, nickel, stainless steel, platinum or gold. Combinations of the materials for anode and cathode as well as mixed alloys are also preferred. The electrical DC voltage that is preferably applied between the anode and cathode depends on the electrode configuration and the distance between the electrodes and must therefore be determined individually. The maximum possible voltage that does not lead to hydrogen and oxygen formation can be determined on the basis of a test of the formation of oxygen at the anode; in this context, the selected voltage should be below the voltage at which oxygen is formed as a gas phase.

In this respect, the method according to the invention is also directed to a cathodic segregation/evolution of carbon dioxide or other water-soluble gases as a pure gas phase from an aqueous acceptor medium.

Preferred is a method in which a cathodic segregation of a water-soluble gas is performed from an aqueous acceptor medium.

Preferred is a method in which a gas dissolved therein, or its water-soluble derivatives, is separated in the form of a pure gas phase from an aqueous acceptor medium by performing a cathodic segregation in the aqueous acceptor medium.

In a further preferred embodiment, one or more compounds are present in the acceptor and/or release medium which react with the carbon dioxide, or carbonate/hydrogen carbonate anions, transported from the acceptor solution, and or bind this/these. These compounds, hereinafter referred to as reaction compounds, may have a liquid, solid or gaseous state. Furthermore, reaction-promoting compounds, such as catalysts, may be present in the uptake and release medium. In this regard, the uptake and release medium may be at a different temperature than the acceptor medium. In a further preferred embodiment, reaction and/or binding of carbon dioxide/carbonate/hydrogen carbonate anions dissolved in the acceptor medium is accomplished with/due to suitable compounds present therein. Preferred is the use of reaction compounds for the reaction and/or binding of carbon dioxide and/or carbonate/hydrogen carbonate anions which are present in the acceptor solution and/or the uptake and release medium.

Preferred is a method in which one or more reaction compounds for reacting and/or binding carbon dioxide and/or carbonate/hydrogen carbonate—anions are present in the acceptor solution and/or the uptake and/or release medium.

Surprisingly, the reaction conditions present in an acceptor solution in which carbon dioxide and/or carbonate/hydrogen carbonate anions are present in high concentration are particularly suitable for the synthesis of carbon compounds. For example, syntheses of carboxylic acids can be accomplished. Examples include a reaction with the Grignard reagent or telomerization with a palladium catalyst. Preferred carbon compounds include, but are not limited to, formic acid, methanol, carbon monoxide (CO), and formaldehyde. It has been shown that the enrichment of carbon dioxide and its water-soluble derivatives made possible by the method can enable chemical syntheses of organic compounds under normal pressure conditions. It was also shown that carboxylic acids synthesized in an aqueous acceptor medium can be continuously separated by electrodialysis.

The electrophoretically separated carboxylic acids are preferably taken up in an aqueous medium and released from it. It has been shown that, in turn, a solution containing dissolved arginine is excellently suited to be used as an uptake and/or release medium for the transported carboxylic acids in this method embodiment.

Preferred is a method in which one or more reaction compounds for reacting and/or binding carbon dioxide and/or carbonate/hydrocarbonate anions are present in the acceptor solution and/or the uptake and/or release medium.

Preferred is a method in which, after step b), the carbon dioxide bound in the acceptor solution is reacted by means of a reaction compound to form a carbon compound.

In a particularly preferred method embodiment, an anion exchange membrane permeable to anions with a molecular weight of up to 400 Da is used for the selective electrophoretic transport of short-chain carboxylic acids.

It has been shown that the total carbon dioxide content of a flue gas can be separated, transported and chemically converted by means of one of the methods described herein.

### Conversion Method

Preferred is a method wherein, after step b), the carbon dioxide bound in the acceptor solution is converted to a carbon compound by means of a reaction compound.

Preferred is a method in which, after step c), the carbon dioxide bound in the acceptor and/or release medium or the carbon dioxide transported and released is converted into a carbon compound by means of a reaction compound.

Thus, it could be shown that it is possible to increase the content/concentration of carbon dioxide and of carbonate/hydrogen carbonate anions in the aqueous acceptor medium under normal pressure conditions and, at the same time, to establish optimal reaction conditions such that an immediate chemical conversion by immobilized reaction-promoting compounds in the acceptor solution can be performed. Furthermore, it was shown that by using a method arrangement according to the invention, it is possible to continuously remove the reactants resulting from the chemical conversion, such as carboxylic acids, at the same time, which can be done, for example, with an anion exchange membrane. Furthermore, it has been shown that in such a method embodiment, in turn, a solution containing guanidino- or amidino-group-bearing compounds dissolved in an uptake and release medium is suitable for uptake and transport of carboxylic acids resulting from the previous reaction and which have been transported by means of electrodialysis.

Preferred is a method for the production of carbon compounds from carbon dioxide.

In a further preferred embodiment, chemical conversion of carbon dioxide bound in the aqueous acceptor medium in the form of carbonate/hydrocarbonate anions to carbonates is performed. Surprisingly, it was found that by absorbing carbon dioxide according to the invention, as well as its reaction products with water, a chemical conversion can be performed with various method arrangements. As an example, 3 possible types of conversion methods will be listed here.

### Conversion Method 1

Surprisingly, it was found that the carbon dioxide dissolved in the aqueous acceptor medium as well as the carbonate and hydrogen carbonate anions can be reacted directly in or with the acceptor solution to form carbonates. For this purpose, a solution in which cationic compounds suitable for the production of carbonates are present in dissolved (ionized) form is added to the acceptor solution in which carbon dioxide or its water-soluble derivatives are already present in dissolved/bonded form.

In this case, the chemical conversion is accomplished when the solution containing reaction compounds is introduced into the preferably saturated acceptor solution.

In another preferred embodiment of this conversion method, there is carbonate production when the acceptor solution in which the salt of the cation/cationic compound used for carbonate/hydrogen carbonate production is already dissolved, comes into contact with carbon dioxide.

In another method embodiment, the acceptor solution in which carbon dioxide or its water-soluble derivatives are already present in dissolved/bound form is added to a solution in which cations/cationic compounds suitable for carbonate production are present in dissolved (ionized) form. The chemical conversion is effected when the saturated acceptor solution is introduced.

In all method variants, a milky suspension develops rapidly, from which solids separate spontaneously by sedimentation. However, phase separation can also be achieved by prior art filtrative or centrifugal methods.

### Conversion Method 2

In a further preferred method embodiment, the addition of cation/cationic compounds suitable for the production of carbonates/hydrocarbonates to the acceptor solution is performed during the contacting of the acceptor solution with the water-soluble gas/gas component, such as carbon dioxide, or subsequently thereto by means of an electrophoretic method. Preferably, this is done by electrodialysis. Preferably, this is performed in a method arrangement in which the acceptor chamber adjoins an electrolyte chamber on the anode side and is separated from the latter by a cation-selective membrane. In the electrolyte chamber, cations/cationic compounds are present in dissolved (ionized) form, which are suitable for the production of carbonates/hydrogen carbonates. By applying a DC voltage, electrophoretic transport of cation/cationic compounds is effected through the cation-selective membrane into the acceptor solution, where they are then spontaneously converted to the corresponding carbonate. In this method, the acceptor solution may already be saturated with carbon dioxide or is brought into contact with carbon dioxide during electrodialysis or subsequently thereto.

In a further preferred embodiment of the method, a cation/cationic compound suitable for the production of carbonates/hydrogen carbonates is present in ionic form in an uptake and release medium. Carbon dioxide/carbonate/hydrogen carbonate anions are transported through an anion-selective separation medium (separation membrane) from the acceptor chamber into the uptake and release medium. Then, there is formation of the corresponding carbonates then in this medium. It was found that most of this reaction takes place directly at the separation medium (separation membrane). Surprisingly, this reaction proceeded more rapidly and homogeneously in the aqueous uptake and release medium when one of the acceptor compounds of the invention was dissolved therein. It was shown that bipolar membranes can also be used for this purpose. In this method, it is advantageous if no inorganic acids and only a low content of organic acids are present in the uptake and release medium.

### Conversion Method 3

In a further preferred embodiment of the method, a chemical conversion of carbon dioxide and/or carbonate and/or hydrogen carbonate anions is accomplished in the uptake and release medium, whereby, on the one hand, carbon dioxide and/or carbonate and/or hydrogen carbonate anions is/are transported from an acceptor chamber through a separation medium (separation membrane) into the uptake and release chamber and, on the other hand, cations/cationic compounds, which are suitable for the production of carbonates/hydrogen carbonates, are transported from an electrolyte chamber, in which at least one cation/cationic compound is present in ionic or ionizable form, into the uptake and release chamber.

The uptake and release chamber adjoins the acceptor chamber on the cathode side and an electrolyte chamber on the anode side. Preferably, the mass transfer is effected electrophoretically, with a bipolar or anion-selective membrane being used as the separating medium (separating membrane) between the acceptor chamber and the uptake and release chamber and a cation-selective membrane being used between the uptake and release chamber and the electrolyte chamber. In this method embodiment, it is advantageous and preferred that at least one acceptor compound is present in dissolved form in the uptake and release medium. It is preferred that no inorganic acids and only a low content of organic acids are present in the uptake and release medium.

In all embodiments of the conversion processes, it is advantageous to agitate the aqueous solution in which the chemical conversion is performed in order to prevent localized segregation processes. In the process embodiment according to the invention, no or practically no carbon dioxide is released as a gas phase during the chemical conversion. Segregation can be caused by concentration of the counterions of the compounds used for carbonate production. Therefore, removal of the counterions from the process solution in which the chemical conversion of carbon dioxide and/or carbonate and/or hydrogen carbonate anions is performed is advantageous.

Preferably, a removal of counterions (anions) of the compounds used to provide cations/cationic compounds for the preparation of carbonates is performed during or following the performance of one of the conversion processes. These are, for example, Cl⁻ or SO₄²⁻. For this purpose, in a preferred method embodiment, the chamber unit in which the counterion accumulates is connected on the anode side to either the anode chamber or a rinsing chamber by means of an anion-selective membrane. In the rinsing chamber there is an aqueous electrically conductive medium which absorbs the counterions and either adsorbs them therein or the rinsing liquid is recirculated through the anode chamber. In a preferred embodiment, an acid, such as hydrochloric acid or sulfuric acid, is formed in the anode chamber, which may be further concentrated and used to produce a solution containing cations/cationic compounds suitable for carbonate production. For example, aluminum chloride or ferrous sulfate can be produced from metallic aluminum or iron by this method, which can then be used for further carbonate/hydrogen carbonate production.

The implementation of conversion methods 2 and 3 are particularly advantageous in this respect, since no solid aggregates are formed in the acceptor medium and no further anions are introduced which could compete with the uptake of carbonate/hydrogen carbonate anions. This allows the acceptor solution to be circulated for the uptake and release of carbon dioxide and/or carbonate and/or hydrogen carbonate anions, which are chemically reacted in a secondary circulation method. In conversion method 1, a continuous or discontinuous separation of anions other than carbonate and/or hydrogen carbonate anions can be performed by adsorptive methods or an electrodialysis method. Thus, recirculation of the acceptor solution can also be ensured in conversion method 1.

It has also been found that the separation of counterions, such as Cl⁻ or SO₄²⁻ which remain in an acceptor solution following carbonate production, can be accomplished with a lower energy input in the course of electrodialysis if a potassium hydroxide solution or sodium hydroxide solution is added to this solution.

Preferably, the dosage is titrated up to the pH of the solution at which the counterions are completely dissolved from the acceptor compound. It has been found that this is further particularly advantageous, as this converts cations remaining in the acceptor solution, which have been added during recirculation of the acceptor solution for absorption of a water-soluble gas, into their hydroxide form, e.g. Ca(OH)₂, whereby they become a solid and are very easy to separate and as a result there is no formation of solids (carbonate formation) in the gas scrubbing device during recirculation of the acceptor solution. Following the separation of solids formed after titration with a potassium or sodium hydroxide solution, the acceptor solution is purified by electrodialysis from the salt components it contains (e.g. Na⁺, K⁺, Cl⁻ or SO₄²⁻). Subsequently, the acceptor solution can be used to reabsorb a water-soluble gas/gas component, with the absorption capacity corresponding to that of the initially used acceptor solution.

The conversion methods according to the invention are preferably performed in a temperature range between 5 and 70° C., more preferably between 1° and 60° C. and further preferably between 15 and 50° C. The pH of the aqueous solution in which the carbonate/hydrogen carbonate production is performed is preferably in a range between 5 and 13, more preferably between 6 and 12.5 and further preferably between 7 and 12. The carbonate/hydrogen carbonate production is preferably performed under normal pressure conditions.

In a further preferred embodiment, a chemical conversion, according to one of the conversion methods, is performed by performing the conversion at an elevated pressure and/or elevated temperature and/or in the presence of a catalyst.

However, the conversion methods are also suitable for contacting other compounds with carbon dioxide and/or carbonate and/or hydrogen carbonate anions and chemically reacting them with each other. Therefore, in a preferred method embodiment, one or more compounds, hereinafter also referred to as reaction compounds, are added to the aqueous acceptor medium to be contacted with carbon dioxide and/or carbonate and/or hydrogen carbonate anions before and/or during and/or following an absorption of carbon dioxide in the acceptor solution with the one or more reaction compound(s) and to react them with each other. In a further preferred method embodiment, a chemical conversion of carbon dioxide and/or carbonate and/or hydrogen carbonate anions is performed in a carbon dioxide and/or carbonate and/or hydrogen carbonate anion absorption process that is run in parallel with or following the carbon dioxide and/or carbonate and/or hydrogen carbonate anion absorption process according to the invention, via transport of carbon dioxide and/or carbonate and/or hydrogen carbonate anions into a uptake and release medium in which the one or more reaction compound(s) are contained or transported into.

Preferred is a method in which at least one reaction compound is present in an aqueous acceptor medium and a reaction with carbon dioxide and/or carbonate and/or hydrogen carbonate anions is effected during and/or after absorption of carbon dioxide in the acceptor solution.

Preferred is a method in which absorption of carbon dioxide in the acceptor solution is performed by means of an aqueous acceptor medium and the aqueous absorption medium containing carbon dioxide and/or carbonate and/or hydrogen carbonate anions is brought into contact with at least one reaction compound and a reaction with carbon dioxide and/or carbonate and/or hydrogen carbonate anions with the at least one reaction compound is performed.

Preferred is a method in which at least one reaction compound is present in the uptake and release medium for carbon dioxide and/or carbonate and/or hydrogen carbonate anions and a reaction with carbon dioxide and/or carbonate and/or hydrogen carbonate anions is accomplished therein, which has/have been transported through a separating medium (membrane) between the acceptor chamber and the uptake and release chamber.

Preferred is a method in which at least one reaction compound and at least one acceptor compound are present in the uptake and release medium and a chemical reaction with carbon dioxide and/or carbonate and/or hydrogen carbonate anions, which has been transported through a separation medium (membrane) between the acceptor chamber and the uptake and release chamber, is performed in the uptake and release medium.

Preferred is a method in which absorption of carbon dioxide in the acceptor solution is effected by means of an aqueous acceptor medium and in which the absorbed carbon dioxide and/or carbonate and/or hydrogen carbonate anion(s) is/are transported through a separation medium (membrane) into a reaction chamber containing at least one dissolved reaction compound and reacted therein with the reaction compound.

Preferred is a method in which an absorption of carbon dioxide in an acceptor solution is effected by means of an aqueous acceptor medium and in which the absorbed carbon dioxide and/or carbonate and/or hydrogen carbonate anions is/are transported through a separating medium (membrane) into a reaction chamber and in which, before and/or during and/or after the transport of carbon dioxide and/or carbonate and/or hydrogen carbonate anions into the reaction chamber, at least one reaction compound is transported into the reaction chamber from an electrolyte chamber in which at least one reaction compound is present in dissolved form, the transport of the compounds being performed electrophoretically.

The residual amounts of acceptor compounds and/or anions of the reaction compounds used, contained in the solid obtained by phase separation, can be completely removed, for example, by a rinsing method.

It has been found that the solid obtained can be dried very easily. This can be achieved, for example, on a porous ceramic membrane, with the water being very rapidly absorbed and transported by the membrane. The carbonates or hydrogen carbonates dried in this way are then immediately available as a fine powder or can be made into one very easily by a grinding method. In this case, the average diameter of the particles is <1 μm. The carbonates or hydrogen carbonates obtained in this way are immediately available in chemically pure and amorphous form. In this context, pure means that the carbonates or hydrogen carbonates are present in a purity of >95 wt %, more preferably of >98 wt % and further preferably of >99.5 wt %.

Surprisingly, the method according to the invention can also be used to produce carbonates with metal ions, such as iron, aluminum and copper ions.

Surprisingly, aluminum carbonate could be produced by the listed conversion methods. This was possible, for example, by dissolving aluminum chloride in a solution containing arginine at a concentration of 0.3 mol/l, to obtain a 10% aqueous solution of the aluminum chloride. This solution was slowly added under agitation to an acceptor solution (arginine solution 2 mol/l), which had been saturated with carbon dioxide, in a ratio of 1:4, whereby a whitish turbidity developed. After completion of the addition and agitation of the suspension, whitish solid material that sedimented was separated by centrifugation and then rinsed 2 times with deionized water. The pasty material was convectively dried and then mechanically comminuted, yielding a whitish powder. The powder could be completely decomposed by concentrated hydrochloric acid, producing carbon dioxide and a solution of aluminum chloride. Surprisingly, there was no gas formation or heating either during the dissolution of the aluminum chloride salt in the acceptor solution or when the solutions were brought into contact.

Surprisingly, it was found that when ammonium ions are simultaneously present in a solution according to the invention in which a production of carbonates is accomplished, the production of hydrogen carbonates proceeds preferentially. In a preferred embodiment, ammonia is added to the solution in which production of carbonates/hydrogen carbonates is accomplished. This can be done before, during or after bringing the solution into contact with a water-soluble gas/gas component. Preferably, this method embodiment is performed in the case of an acceptor solution according to the invention. However, an addition can also be performed in conversion methods 2 and 3, in which case the addition is performed in the reaction chamber and/or the uptake and release chamber. It has been found that even low concentrations of ammonia in one of the solutions in which the conversion to hydrogen carbonates/carbonates is performed are sufficient to allow the preferential formation of hydrogen carbonates over carbonates to take place. The preferred concentration of ammonia in the solution in which hydrogen carbonate/carbonate production is accomplished is between 0.001 and 5.0 wt %, more preferably between 0.005 and 3.0 wt %, and further preferably between 0.01 and 1.5 wt %. Since the preferred formation of hydrogen carbonates depends on the concentration of the introduced anions (e.g. Cl⁻ or SO₄²⁻), which are bound by ammonium ions, the optimum concentration of ammonia must be determined individually. The resulting hydrogen carbonates are separated and purified using the same separation technique as described herein. In a preferred method embodiment, the production of hydrogen carbonates or carbonates is performed at a method temperature that is preferably <50° C., more preferably <35° C., further preferably <20° C. and even more preferably <10° C. In a preferred method embodiment, separation of the ammonium salts present in the acceptor or reaction solution is performed. Preferably, this can be done by electrodialysis.

It was further found that it is particularly advantageous to separate the anions, or anionic compounds, from an electrolyte solution in which cations, or cationic compounds suitable for the production of carbonates or hydrocarbonates, and anions, or anionic compounds, are present, by means of a reaction with ammonium. It has been found that in addition to a higher conversion rate and conversion amount of cations or cationic compounds to carbonates or hydrogen carbonates, impurities that may be present in an electrolyte solution can also be removed very easily. This could be demonstrated, for example, with aluminum materials (including aluminum foil) that were recycled and contained organic compounds. Acid hydrolysis was performed using concentrated hydrochloric acid. A gray solid with a pH of 1 was formed, which could be completely dissolved in water. Mixing in a 25 wt % ammonia solution resulted in flocculation starting at a pH of 2.5, which intensified with further addition of ammonia solution. At a pH of 4, the solution was centrifuged. It was found that a dark brown solid had also been deposited on a white centrifugate. The supernatant was transparent and had no odor of ammonia at a pH of 4. The supernatant was added to a 2 molar arginine solution saturated with carbon dioxide, which immediately produced a white solid. Compared to an experiment with a solution in which no ammonia was added, more than three times the amount of solid could be separated from the acceptor solution, which was also due to the fact that more than twice the volume of the electrolyte solution pretreated with ammonia could be added to the acceptor solution until a pH of the acceptor solution was reached at which there was no further formation of carbonates or hydrogen carbonates. Pure aluminum hydrogen carbonate was found in the solid analysis.

It was also shown that sulfate anions can also be removed from an electrolyte solution by such a process and that the sulfate-poor electrolyte solution enables a greater conversion of cationic compounds than with the sulfate or anion-rich electrolyte solution. In another application, a regenerate liquid (pH 7) of a cation exchanger used to produce deionized water was studied. The regeneration has been performed with a NaCl solution. It was found that mixing in ammonia resulted in flocculation, which was separable by centrifugation. The clear supernatant (pH 9) was added to a carbon dioxide saturated acceptor solution where solids formed. A mixture of calcium and magnesium hydrogen carbonates was documented in the solid analysis.

Preferred is a method for preparing hydrogen carbonates in which ammonium ions are added to an electrolyte solution and then the mixture is combined and mixed with an aqueous acceptor solution saturated with carbon dioxide or its water-soluble derivatives.

A preferred method for the preparation of carbonates and/or hydrogen carbonates is one in which anions or anionic compounds are complexed and separated by ammonium ions from an electrolyte solution containing cations or cationic compounds and anions or anionic compounds, and then the anion-poor electrolyte liquid is combined and mixed with an aqueous acceptor solution saturated with carbon dioxide or its water-soluble derivatives, with spontaneous formation of the carbonates and/or hydrogen carbonates.

Thus, in principle, carbonates and hydrogen carbonates can be prepared from carbon dioxide or its derivatives, which are present in a reactive form in an acceptor solution or are brought into a reactive form by acceptor compounds, or are present bound to such a reactive form, by bringing them into contact with elements or compounds which are present as cation/cationic compounds, i.e. in ionic form, resulting in a chemical conversion. Hereby it is possible to obtain carbonates (hydrogen carbonates) and to produce them in pure and non-crystalline form, such as sodium carbonate, calcium carbonate, barium carbonate, magnesium carbonate, lithium carbonate, cobalt carbonate, iron carbonate, copper carbonate, aluminum carbonate, silicon carbonate, zinc carbonate, silver carbonate, lead carbonate, as well as ammonium carbonate, and the corresponding hydrogen carbonates.

The preferred hydrogen carbonates and carbonates produced by a method according to the invention have a mean particle diameter of preferably <2 μm, more preferably <1.5 μm, further preferably <1 μm and even more preferably <0.5 μm.

Preferred is the preparation of hydrogen carbonates and carbonates that are in amorphous form.

Preferred is a method for low energy production of carbonates and/or hydrogen carbonates.

Preferred is a method for the low energy production of carbonates and/or hydrogen carbonates from renewable raw materials.

Preferred are regenerative carbonates and hydrogen carbonates produced by a method according to the invention.

Preferred is a method for the production of aluminum carbonate.

Preferred is aluminum carbonate produced by a method according to the invention.

Preferred is a method for the preparation of aluminum hydrogen carbonate.

Preferred is aluminum hydrogen carbonate, produced by a method according to the invention.

Preferred is aluminum carbonate, prepared by a method according to the invention, wherein the reaction compound is an aluminum salt, preferably aluminum chloride.

Preferred is aluminum hydrogen carbonate prepared by a method according to the invention, wherein the reaction compound is an aluminum salt, preferably aluminum chloride.

The reaction compound in the form of an aluminum salt for the preparation of aluminum carbonate and/or aluminum hydrogen carbonate is not itself aluminum carbonate and/or aluminum hydrogen carbonate.

The pH of the acceptor solution, which is preferred for the preparation of carbonates or hydrogen carbonates according to one of the embodiments of the invention, is in the range between 7 and 13.5, more preferably between 8 and 12.5, and more preferably between 8.5 and 12.

Preferably, aqueous solutions of salts of the cations/cationic compounds to be used for carbonate/hydrogen carbonate production are prepared and added to an acceptor solution saturated with carbon dioxide. In principle, the concentration of the salt solution can be freely selected. Preferably, the pH of the acceptor solution should not be lowered below 4 by the addition of the salt solution, otherwise a release/evolution of bound carbon dioxide will result. In another preferred embodiment, the introduction of the dissolved salt solution is performed under pressure. To avoid local lowering of the pH, the introduction of the salt solution should preferably be performed under agitation. The anion of the salt can in principle be freely selected. Preferably, a low molecular weight compound should be used. Preferred anions are chloride, hydroxyl, sulfate and citrate ions.

By introducing the salt into the acceptor solution, the anions used accumulate, which are electrostatically bound to a guanidino or amidino group of the acceptor compound. Therefore, removal of the anions from the acceptor solution is advantageously performed by prior art methods. This can be done continuously, e.g. by means of electrodialysis, or discontinuously, e.g. with an anion exchange compound, or an adsorption/complexation agent.

Thus, the method is also directed to the production and obtainment of carbonates and hydrogen carbonates. Therefore, a method characterized by the following steps is preferred:
(a) providing an aqueous acceptor solution containing at least one acceptor compound having a free guanidino and/or amidino group,
b) contacting a gas containing carbon dioxide with the acceptor solution of step a),
c) conversion of the carbon dioxide contained and bound in the acceptor solution and/or the carbon dioxide derivatives of step b), which is achieved by
adding to the acceptor solution of step b) at least one cationic compound and dissolving and mixing it therein, or by
d2)—the carbon dioxide and/or the carbon dioxide derivatives contained and bound in the acceptor solution is/are electrophoretically transported into an uptake and release chamber or a reaction chamber and is/are contacted and mixed therein with at least one cationic compound,
d) obtaining the reaction product with the carbon dioxide and/or the carbon dioxide derivatives of step c) which is obtainable in the chamber in which the reaction was performed, and after the reaction product is separated by means of a separation method and dried.

Thus, the method is also directed to the production and obtainment of carbonates and hydrogen carbonates. Therefore, a method characterized by the following steps is preferred:
(a) providing an aqueous acceptor solution containing at least one acceptor compound having a free guanidino and/or amidino group,
b) Contacting a gas containing carbon dioxide with the acceptor solution of step a) until a carbon dioxide concentration of the gas of <100 ppm is reached,
c) conversion of the carbon dioxide and/or the carbon dioxide derivatives contained and bound in the acceptor solution from step b), which is achieved by
   adding at least one cationic compound to the acceptor solution of step b) and dissolving and mixing it therein, or by
d2)—the carbon dioxide and/or the carbon dioxide derivatives contained and bound in the acceptor solution is/are electrophoretically transported into an uptake and release chamber or a reaction chamber and is/are contacted and mixed therein with at least one cationic compound,
d) obtaining the reaction product with the carbon dioxide and/or the carbon dioxide derivatives from step c) which is obtainable in the chamber in which the reaction has been performed, and after the reaction product has been separated by means of a separation method and dried.

Thereby, the method embodiments described herein are further preferably applicable in further method types, in particular:
preferred is a method in which the reaction in step c) is a chemical reaction with a reaction compound;
preferred is a method in which the reaction compound is dissolved in an aqueous solution containing an acceptor compound and/or an uptake and release compound to produce a reaction solution;
preferred is a method in which the reaction in step c) is performed in the acceptor solution obtainable from step b) and/or in an uptake and release medium and/or in a reaction medium;
preferred is a method in which a reaction medium contains at least one acceptor compound;
preferred is a method in which the conversion in step c), in the acceptor solution obtainable from step b) or in a uptake and release medium after transport of carbon dioxide and/or the carbon dioxide derivatives from the acceptor medium according to step b) into the uptake and release medium, is performed by combining the dissolved or undissolved reaction compounds;
preferred is a method in which the conversion in step c), which is performed in an uptake and release medium and/or in a reaction medium, is performed during or following a transport of carbon dioxide and/or the carbon dioxide derivatives from the acceptor solution obtainable from step b) into the respective medium;
preferred is a method in which the transport of carbon dioxide and/or the carbon dioxide derivatives from the acceptor solution, obtainable from step b), into an uptake and release medium and/or into a reaction medium, is performed by an electrophoretic method;
preferred is a method in which the chemical conversion in step c) is performed with a cation/cationic compound which allows the formation of a carbonate or hydrogen carbonate; preferred is a method in which chemically pure carbonates and/or hydrogen carbonates are obtained in amorphous form in step d).

Surprisingly, it has been found that the method of the invention for dissolving and transporting carbon dioxide, in conjunction with any of the conversion methods disclosed herein, allows/allow carbon dioxide and or derivatives thereof to be converted to methane as well as to other hydrocarbon compounds.

In a particularly preferred embodiment, the conversion method 3 is used for this purpose. In one embodiment, this is performed in an electrodialysis apparatus in which one or more chamber sequences are stacked in series between a cathode chamber and an anode chamber, with the arrangement: acceptor chamber/reaction chamber/electrolyte chamber. Preferably, the electrolyte solution circulating through the anode chamber flows through the electrolyte chamber.

Preferably, at least one compound that facilitates or catalyzes electrolysis is present in the electrolyte solution. Preferably, a medium suitable for taking up and reversibly binding anions and cations is present in the reaction chamber. In one embodiment, ionic liquids are used for this purpose. Preferred are ionic liquids in which the salt compounds can bind hydrogen ions (protons) in a molar ratio of >/=1. This can be done, for example, by one or more tertiary or quaternary nitrogen compounds. In a further embodiment, compounds suitable for binding hydrogen ions (protons) are dissolved in the ionic liquid. In a further embodiment, compounds that have a catalytic or reaction-promoting property are present in the ionic liquid. In a further preferred embodiment, circulation of the electrolyte solution is provided between the electrolyte chambers and the cathode chamber. Preferably, there is an open-pored membrane or a bipolar membrane between the acceptor chamber and the reaction chamber and a cation-selective membrane between the electrolyte chamber and the reaction chamber. It has been shown that with such an arrangement, during application of a DC between the anode and the cathode, methane is formed in the reaction chamber and is spontaneously evolved therefrom.

Advantageously, in a process performance according to the invention, the hydrogen produced in the electrodialysis process, during or following a process executed according to the invention, can be made directly available for one of the reactions of the conversion methods disclosed herein and converted in the process.

Thus, the method is also directed to the production and obtainment of carbon compounds.

Thus, a method characterized by the following steps is preferred:
a) providing an aqueous acceptor solution containing at least one acceptor compound having a free guanidino and/or amidino group,
b) contacting a gas containing carbon dioxide with the acceptor solution of step a),
c) conversion of the carbon dioxide contained and bound in the acceptor solution and/or the carbon dioxide derivatives of step b) or
transport of the carbon dioxide contained and bound in the acceptor solution and/or the carbon dioxide derivatives according to step b), and d2) conversion in an uptake and release medium or a reaction medium,
d) obtaining the reaction product with the carbon dioxide and/or the carbon dioxide derivatives of step c), by phase separation or an electrophoretic mass separation.

Thus, the method is also directed to the recovery and production of carbon compounds.

Therefore, a method characterized by the following steps is preferred:
a) providing an aqueous acceptor solution containing at least one acceptor compound having a free guanidino and/or amidino group,
b) contacting a gas containing carbon dioxide with the acceptor solution of step a) until saturation of the acceptor medium with carbon dioxide is achieved,
c) conversion of the carbon dioxide contained and bound in the acceptor solution and/or the carbon dioxide derivatives of step b) or transport of the carbon dioxide and/or the carbon dioxide derivatives contained and bound in the acceptor solution according to step b) and d2) conversion in an uptake and release medium or a reaction medium,
d) obtaining the reaction product with the carbon dioxide and/or the carbon dioxide derivatives of step c), by phase separation or an electrophoretic mass separation.

Thus, extremely advantageous effects can be obtained by using an acceptor solution containing at least one dissolved acceptor compound having at least one guanidino or amidino group. In particular, highly effective and selective removal of carbon dioxide from a gas/gas mixture can be achieved at normal pressure and room temperature. Carbon dioxide bound in the acceptor medium as well as carbonate and/or hydrogen carbonate anions remain therein pressureless (at normal pressure) for a period of at least 6 months and can be transported in this form.

Furthermore, an acceptor medium in which carbon dioxide and carbonate and/or hydrogen carbonate anions are present in solution can be used to provide a reaction solution in which a chemical conversion of the carbon dioxide and carbonate and/or hydrogen carbonate anions can be performed immediately. In addition, the acceptor medium is suitable for dissolving and transporting carboxylic acids resulting from a conversion of carbon dioxide. Furthermore, the acceptor solution can be saturated with carbon dioxide any number of times and then these can be removed without any consumption or loss of the acceptor compound.

### Definitions

### Acceptor Medium

The term “acceptor medium” refers to a liquid or solvent in which at least one dissolved compound capable of binding carbon dioxide/carbon dioxide derivatives is present. This compound is also referred to herein as an “acceptor compound”. The acceptor compound has at least one free guanidino and/or amidino group. The acceptor compound may comprise reaction compounds and also other compounds. If the liquid or solvent in which at least one dissolved compound is present is water, the “acceptor medium” is also referred to herein as “aqueous acceptor medium” or as “acceptor solution”. The terms “aqueous acceptor medium” and “acceptor solution” or even “aqueous acceptor solution” are used interchangeably herein.

### Acceptor Solution

As used herein, an “acceptor solution” is understood to be an aqueous medium containing at least one dissolved compound capable of binding carbon dioxide, carbon dioxide derivatives. This compound is also referred to herein as an “acceptor compound”. The acceptor compound has at least one free guanidino and/or amidino group. The acceptor compound may comprise reaction compounds and also other compounds.

### Acceptor Compound

The term “acceptor compound” as used herein refers to a chemical compound having a free guanidino and/or amidino group. The acceptor compound is particularly preferably arginine.

### Cationic Groups

The term “cationic groups” as used herein refers to functional chemical groups that have a positive electronic charge after proton uptake. “Cationic groups” therefore represent positively charged functional groups. “Cationic groups” are also referred to herein as positive “charge groups”. Preferred chemical compounds having “cationic groups” herein are preferably amino acids and/or derivatives thereof containing at least one guanidino and/or amidino group.

### Cationic Compounds

The term “cationic compounds” as used herein refers to substances that have a positive electrical charge. In particular, salts of alkali metals and alkaline earth metals are referred to herein as “cationic compounds.” In particular, of alkali metals and alkaline earth metals that can form carbonates and hydrogen carbonates, respectively. Preferred “cationic compounds” are inorganic and organic salts of alkali metals and alkaline earth metals which form carbonates or hydrogen carbonates which are practically insoluble or sparingly soluble in water. By adding “cationic compounds” to an aqueous acceptor solution containing bound carbon dioxide or to an aqueous acceptor solution containing bound carbon dioxide, alkali metal and alkaline earth metal carbonates or hydrogen carbonates can be selectively obtained. In addition to the alkali metal and alkaline earth metal salts, other metal cations may be used to react with carbonate anions or hydrogen carbonate anions as disclosed herein. Examples of “cationic compounds” preferred herein include, but are not limited to, calcium chloride, ferric chloride, and aluminum chloride. Examples of substances with which carbonates or hydrogen carbonates such as sodium carbonate, calcium carbonate, barium carbonate, magnesium carbonate, lithium carbonate, cobalt carbonate, iron carbonate, copper carbonate, aluminum carbonate, silicon carbonate, zinc carbonate, silver carbonate, lead carbonate, and ammonium carbonate, as well as the corresponding hydrogen carbonates, as well as aluminum carbonate or aluminum hydrogen carbonate can be obtained, include, but are not limited to, sodium, calcium, barium, magnesium, lithium, cobalt, iron, copper, aluminum, silicon, zinc, silver and lead. Salts of sodium, calcium, barium, magnesium, lithium, cobalt, iron, copper, aluminum, silicon, zinc, silver and lead may be used as cationic compounds herein. Particularly preferred cationic compounds herein are aluminum salts such as aluminum chloride.

### Carbon Dioxide Derivatives

The term “carbon dioxide derivatives” is used herein to refer to all compounds that are or may be formed by a dissolution process of carbon dioxide in water. In particular, these include H₂CO₃, HCO₃⁻, CO₃²⁻. Carbon dioxide (CO₂) forms carbonic acid in water. Carbonic acid (H₂CO₃) is an inorganic acid and the reaction product of its acid anhydride carbon dioxide (CO₂) with water.

### Reaction Compounds

The term reaction compounds refers to those compounds that undergo or cause a reaction with carbon dioxide and/or carbon dioxide derivatives. In this process, carbon dioxide and/or the carbon dioxide derivatives are chemically reacted and/or bound. “Reaction compounds” preferred herein are the “cationic compounds” defined above.

### Uptake and Release Medium

By the term “uptake and release medium” is meant a gas, liquid or solid which adsorbs, absorbs, physiosorbs or binds carbon dioxide and or carbon dioxide derivatives or in which these are reacted and/or released/evolved. Preferably, said medium includes compounds that effect one or more of the aforementioned properties. In this regard, the uptake and release medium may contain reaction compounds, acceptor compounds and also other compounds. Preferred herein are, in particular, aqueous uptake and release media. The term “uptake and release medium” as used herein refers to a medium in which the bound carbon dioxide can be released/evolved. In this regard, the release/evolution of carbon dioxide may occur directly upon entry of the carbon dioxide derivatives, such as carbonate/hydrocarbonate anions, into the uptake and release medium. Preferably, the release/evolution of carbon dioxide from the uptake and release medium is performed after it has been introduced into a release device or release chamber.

### Elements or Element Molecules

The term “element,” as used herein, refers to the known chemical elements arranged in the periodic table (PTE) by increasing atomic number. “Element molecules” are molecules consisting of only two or more atoms of a single chemical element. In contrast to element molecules, all other molecules consist of at least two atoms of different chemical elements (such as carbon dioxide (CO₂) made of carbon and oxygen). “Gaseous elements” or “gaseous element molecules” are those elements or element molecules which are gaseous under normal conditions. These are the six noble gases He, Ne, Ar, Kr, Xe, Rn and the other five elements which are gaseous under normal conditions: Hydrogen (H₂), Nitrogen (N₂), Oxygen (O₂), Fluorine (F₂) and Chlorine (Cl₂).

### Molecular Compounds

The term “molecular compounds” refers to molecules of at least two atoms of different chemical elements (such as carbon dioxide (CO₂) from carbon and oxygen). The term “gaseous molecular compounds” or “gaseous compounds” for short refers to molecular compounds that are gaseous under normal conditions. Examples of “gaseous molecular compounds” that are gaseous under normal conditions include, but are not limited to carbon dioxide (CO₂), methane (CH₄), ammonia (NH₃), carbon monoxide (CO), nitrogen monoxide (NO), nitrogen dioxide (also referred to as nitrous oxide) (N₂O), sulfur dioxide (SO₂), hydrogen chloride (HCl), ethane (CH₃CH₃), propane (CH₃CH₂CH₃), butane (CH₃CH₂CH₂CH₃), acetylene (CH≡CH), etc.

### Gas/Gas Phase

As used herein, the terms “gas” or “gas phase” refer to a gaseous phase of an element or chemical compound that exists as a pure substance or as a mixture. Examples of a pure gas are gaseous carbon dioxide, methane or hydrogen. Examples of gas mixtures are air, combustion/smoke gas, biogas, sewage gas or acidic natural gas. Besides solid and liquid, gaseous is one of the three classical states of aggregation. For some elements and compounds, the standard conditions (temperature 20° C., pressure 101,325 Pa) are already sufficient for them to exist as a gas. In this context, the term “air” refers to the gas mixture of the earth's atmosphere. Dry air consists mainly of the two gases nitrogen (about 78.08% by volume) and oxygen (about 20.95% by volume). In addition, there are the components argon (0.93 vol. %), carbon dioxide (0.04 vol. % or 400 ppm) and other gases in trace amounts in concentrations of less than 0.002 vol. % or 20 ppm such as neon (Ne), helium (He), methane (CH₄), krypton (Kr), nitrous oxide (N₂O), carbon monoxide (CO), xenon (Xe), various chlorofluorocarbons (CFCs) such as dichlorodifluoromethane, trichlorofluoromethane, chlorodifluoromethane, trichlorotrifluoroethane, 1,1-dichloro-1-fluoroethane, 1-chloro, 1-1-difluoroethane, as well as carbon tetrachloride, sulfur hexafluoride, bromochlorodifluoromethane, and bromotrifluoromethane.

### Water-Soluble Gases

In the dissolution of gases in liquids, the term solubility refers to a coefficient that indicates the amount of gas dissolved in the liquid at a given pressure of the gas when the gas is in diffusion equilibrium between the gas phase and the liquid, i.e., exactly as much diffuses in as diffuses out. Solubility depends on temperature, pressure and, for some compounds on the pH. The term “water-soluble gases,” as used herein, means in this context that the gaseous molecular compound reacts chemically with water on contact with it, e.g., to form an acid anhydride or acid. It is then present in water as an organic or inorganic acid or as an anion. Preferred “water-soluble gases” herein are in particular those gases which fall under the term “acid gases”, which form an acid or a weak acid when dissolved in water.

The gases covered by the term “water-soluble gases” are to be distinguished from gases which do not react chemically with water on contact with water. Methane (CH₄), for example, has a solubility of 36.7 ml/I water at normal pressure and at 20° C. It does not react with water and is therefore not a water-soluble gas.

### Water-Soluble Gas

The term “water-soluble gas component” includes all gaseous compounds that are present in a gaseous phase and which, when contacted and/or mixed with water, form a water-soluble compound with water. Examples include carbon dioxide, sulfur dioxide, hydrogen sulfide, nitrogen monoxide, nitrous oxide, hydrogen chloride, or chlorine dioxide. The “water-soluble gas fraction” therefore includes “water-soluble gases” and in particular “acid gases”.

### Acid Gases

The term “acid gas,” as used herein, refers to a gas or even mixture of gases that forms an acid or weak acid when dissolved in water. Acid gases are often corrosive and caustic, as well as toxic, and in this respect pose a hazard to humans and the environment. Acid gases may be of natural origin or they may be produced as desired or undesired reaction gases in industrial processes. Examples of acid gases include, but are not limited to, carbon dioxide (CO₂) (forms carbonic acid and hydrogen carbonates in water), sulfur dioxide (SO₂) (forms sulfurous acid in water), hydrogen sulfide (H₂S), hydrogen chloride (HCl) (forms hydrochloric acid in water), nitrogen dioxide (N₂O) (forms nitric acid in water), hydrogen cyanide (HCN) (forms hydrogen cyanide in water), hydrogen bromide (HBr) (forms hydrobromic acid in water), selenium dioxide (SeO₂) (forms selenous acid in water).

### Basic Amino Acids

The term “basic amino acids” as used herein refers to amino acids that have an amino group or N atoms with free electron pairs in the amino acid residue (side chain). When these N atoms accept a proton, a positively charged side chain is formed. The amino acids histidine, lysine and arginine belong to the basic amino acids. Preferred herein according to the invention are basic amino acids having at least one guanidino and/or amidino group, and particularly preferred is the basic amino acid arginine.

### Electrophoretic Separation

The term “electrophoretic separation” as used herein refers to an electrochemical separation by means of a separation membrane in an electrochemical process such as electrodialysis.

In the electrolysis process, electrolysis is performed in an electrolysis cell. An electrolytic cell consists of two electrodes made of carbon or platinum, for example, and a conductive liquid. The electrode connected to the positive pole is called the anode, and the electrode connected to the negative pole is called the cathode. The cations migrate to the negatively charged cathode and the anions migrate to the positively charged anode. The “electrophoretic separation cell” as used herein to accomplish the “electrophoretic separation” consists of at least two chambers separated by a separating membrane. The “acceptor chamber” contains the aqueous acceptor solution according to the invention, containing at least one acceptor compound having a free guanidino and/or amidino group. The bound carbon dioxide/carbon dioxide derivatives are transported across the separation membrane into an uptake and release medium in the “uptake and release chamber” when a DC voltage is applied to the “electrophoretic separation cell”. The “electrophoretic separation” is based on the principle of the electrodialysis process.

### Electrodialysis

Electrodialysis is a process for separating ions in salt solutions. The necessary separation of ions is achieved by an electric field applied across the anode and cathode and ion exchange membranes or semi-permeable, ion-selective membranes. Electrodialysis is an electrochemically driven membrane process in which ion exchange membranes are used in combination with an electric potential difference to separate ionic species from uncharged solvents or impurities. One of the most common membrane materials is polystyrene (PS). To achieve ion selectivity, it can be modified at the surface by incorporating quaternary amines for anion-selective membranes and carboxylic acid or sulfonic acid groups for cation-selective membranes. Some membrane types are mechanically reinforced by polyvinyl chloride (PVC), polypropylene (PP) or polyethylene terephthalate (PET).

### Separating Medium

The term “separation medium” as used herein refers to a medium over which selective mass transfer can be accomplished. A “separation medium” as used herein may therefore also be referred to as a separation membrane or a transport membrane.

### Separation Membrane

A “separation membrane” or “membrane” for short, as used herein, generally refers to a thin layer of a material that affects mass transport through that layer. In separation technology, membranes are used as separation layers. Membranes can be permeable in different ways: impermeable, selectively permeable, unidirectionally permeable, or omnipermeable. The majority of commercial membranes are made of polymers. A large number of different plastics are used, with very different requirements depending on the area of application. The two most common forms are wound membranes and hollow fibers. Lipophilic polymer membranes can allow the passage of some gases or organic substances, but are impassable to water and aqueous solutions. However, in polymer layers, ionic groups in a polymer can also prevent the passage of ions through the membrane. Such membranes are used in electrodialysis, for example. Other membranes are permeable only to water and certain gases. Commonly used membrane materials are: polysulfones, polyethersulfone (PES) cellulose, cellulose esters (cellulose acetate, cellulose nitrate), regenerated cellulose (RC), silicones, polyamides (“nylon”, more precisely: PA 6, PA 6.6, PA 6.10, PA 6.12, PA 11, PA 12), polyamide imide, polyamide urea, polycarbonates, ceramics, stainless steel, silver, silicon, zeolites (aluminosilicates), polyacrylonitrile (PAN), polyethylene (PE), polypropylene (PP), polytetrafluoroethylene (PTFE), polyvinylidene fluoride (PVDF), polyvinyl chloride (PVC), polypiperazine-amide. Ceramic membranes are used primarily in areas that place either high chemical or thermal demands on the filter.

### Separating Membranes for Electrophoretic Separation

The term “separation membrane” as used herein relates to a separation medium used in electrophoretic separation or electrolysis. Preferably, the separation membrane is an open-pored membrane, further preferably an open-pored mesoporous membrane. In some embodiments, the separation membrane is a ceramic filter plate. In some embodiments, the separation membrane is an anion-selective membrane. All suitable separation membranes from the prior art may be used as the separation membrane. From the prior art ion selective separation membranes and bipolar separation membranes are well known.

Separation Membranes for Contacting Gas Containing Carbon Dioxide with Acceptor Medium.

As used herein, separation media for contacting carbon dioxide-containing gas with acceptor medium refer to “separation membranes” suitable for mass transfer between a gas and liquid phase.

These separation media are also referred to herein as “gas-liquid separation membrane”. Contacting carbon dioxide-containing gas with acceptor medium is also referred to herein as “indirect contacting”. The gas-liquid separation membrane may be provided in the form of a membrane contactor. Membrane contactors are preferably used herein for indirectly contacting a gas containing carbon dioxide with acceptor medium. A membrane film can also be provided as a gas-liquid separation membrane, which is attached to a support material. Such gas-liquid separation membranes are known from the prior art. Preferred gas-liquid separation membranes have an average pore size of >10 μm, more preferably >50 μm, more preferably >100 μm, more preferably >150 μm, more preferably >200 μm. Gas-liquid separation membranes with an average pore size of 200 μm are particularly preferred. Preferred gas-liquid separation membranes have a membrane thickness of <300 μm, more preferably <200 μm, more preferably <150 μm, more preferably <100 μm, more preferably <50 μm, and even more preferably <25 μm. Preferred gas-liquid separation membranes have open channels with an average channel diameter of >10 μm, more preferably >50 μm, further preferably >100 μm, more preferably >150 μm, further preferably >200 μm even more preferably >250 μm and most preferably >300 μm. Preferred gas-liquid separation membranes have a porosity of >50%, more preferably >60%, more preferably >70%, more preferably >80% and even more preferably >90%. Porosity is defined as the number of pores per unit area. Suitable materials for gas-liquid separation membranes include, but are not limited to, PTFE (polytetrafluoroethylene) or PC (polycarbonate) or ceramics.

### Gas Scrubbing

When a gas or air stream is passed through a scrubbing liquid, it is referred to as gas scrubbing or absorption. In this process, the gas components to be absorbed (to be absorbed—unbound, already absorbed—bound) are bound in the scrubbing liquid (absorb—unloaded, absorbate—loaded).

### Salts

The term “salts” as used herein refers to chemical compounds composed of positively charged ions (cations) and negatively charged ions (anions). Ionic bonds are present between these ions. In “inorganic salts,” the cations are often formed by metals and the anions are often formed by nonmetals or their oxides. “Organic salts” are all compounds in which at least one anion or cation is an organic compound; with the exception of carbonates, which are derived from carbonic acid (H₂CO₃), which is inorganic by definition.

### Normal Conditions

The term “normal conditions” or STP (standard temperature and pressure) conditions refers herein to a “standard pressure” of 101.325 Pa=1.01325 bar=1 atm=760 Torr and to a “standard temperature” of 293.15 K≙20° C. The term “atmospheric pressure” refers to the air pressure at any location in the Earth's atmosphere. The standard mean atmospheric pressure (the “atmospheric pressure”) at sea level is 101,325 Pa=101.325 kPa=1013.25 hPa≈1 bar. The terms “atmospheric pressure” and “standard pressure” are used interchangeably herein. The term “unpressurized” as used herein also refers to the terms “atmospheric pressure” and “normal pressure”. Where a process step is described in this application as being performed “unpressurized”, this corresponds to a process step being performed under “atmospheric pressure” and “normal pressure”. The term “no pressurization” as used herein also refers to the terms “atmospheric pressure” and “normal pressure”. Where this application describes a process step as being performed “without pressurization”, this corresponds to a process performance under “atmospheric pressure” and “normal pressure”.

### Gas Scrubbers

A gas scrubber, wet separator, or absorber is a process apparatus in which a gas stream is brought into contact with a liquid stream to absorb constituents of the gas stream in the liquid. The components of the gas stream that are transferred can be solid, liquid or gaseous substances. Gas scrubbing devices known in the prior art can be used to separate CO₂ from flue gases or biogases. A gas scrubbing device may comprise a pre-scrubbing gas scrubbing column. A distinction is made between fixed bed columns, packed columns, tray columns and spray columns.

### Clean Gas

The term “clean gas” as used herein results from the division into the following purity classes:

Raw gas (also crudum, crd.)—unpurified quality.

Technical gas—The gas is used for general technical purposes, usually produced on a large scale, and may have extraneous odor and color.

Gas for synthesis—The gas contains smaller amounts of impurities, which usually do not interfere with syntheses, since during production of the synthesized product a purification takes place.

Pure gas (purum)—chemically pure quality with substance content >98.5% by volume, unless otherwise specified. Corresponds largely to the relevant literature in terms of color and characteristic data. Suitable for synthesis and laboratory purposes.

Purest gas (purissimum, puriss.)—particularly pure quality with substance content of at least >99.5 Vol %. No impurities can be detected by common analytical methods. Appearance and characteristic data correspond to the relevant literature.

### Applications

The process is particularly suitable for the selective removal of a carbon dioxide component from a gas or gas mixture. Preferred gases/gas mixtures are those with a high carbon dioxide content, such as flue/combustion gases. Furthermore, gas mixtures that are produced during technical processes/syntheses or by a fermentative process, such as biogas production. This also includes so-called digester gases, which are produced, for example, during the decomposition of sewage residues. Furthermore, the process is suitable for purifying mineral or technically produced gases. Therefore, the process is suitable for the purification of gases/gas mixtures containing water-soluble gas components.

The extraction of the water-soluble components of a gas/gas mixture achievable with the process can further be used to purify anaerobic gas phases, such as digester gas or biogas, from water-soluble gas components in order to obtain a technically pure or purest gas, e.g. as methane or bio-methane. In this respect, the process can be used to produce technical gases/gas mixtures.

The process is also suitable for the production, recovery and conversion of hydrogen.

The method is further suitable for extracting gas components from gases/gas mixtures, transporting them, storing them and making them obtainable. In particular, the method can be used to obtain pure gaseous carbon dioxide, which can be used in a variety of industrial applications. For example, the extracted carbon dioxide can be used as technical gas, as propellant (e.g. for dispensers), for enrichment of carbonic acid (e.g. in food or concrete) or for dry ice production. Therefore, the method is suitable for the production of pure and purest carbon dioxide.

In particular, the method makes it possible to obtain regenerative carbon dioxide, with/by which regenerative products can be produced. Examples of applications include plant breeding or the production of a regenerative carbon cycle economy, whereby cycle components can be produced, such as synthetic fuel compounds or synthetic carbon compounds. Therefore, the method is suitable for producing regenerative carbon dioxide.

The method is further suitable to store the captured carbon dioxide for long periods of time or to transport it.

Furthermore, the method enables the bound carbon dioxide to be chemically converted directly and without further energetic input, whereby important starting materials for organosynthesis (production of carbon compounds) can be produced directly and separated by simple means. The method is thus suitable for the production of organic compounds.

Furthermore, carbonates and hydrocarbonates can be obtained in pure form with little technical effort. Thus, the method is suitable for the production of carbonates and hydrocarbonates.

Carbonates and hydrogen carbonates are important basic materials, for example as fillers in building materials or in the paper industry, but also dietary supplements for humans and animals, and ingredients of tablets or dentifrices.

In particular, the method embodiments according to the invention are suitable for producing regenerative and sustainable products.

### FIGURE DESCRIPTION

FIG. 1: Schematic of a device for adsorption, transport and release of water-soluble gases.

Herein is: 1) any gas/gas mixture containing a water-soluble gas or gaseous component, 1a) represents the inlet device for the gas/gas mixture 1) to be purified; 2) represents a gas scrubbing device in which gas 1) is brought into contact with the acceptor solution; through the outlet 3), gas 1) exits after extraction of the water-soluble gas component; 4) represents the collection device for the acceptor solution brought into contact with gas 1) in the gas scrubbing device 2); 5) represents a circulation circuit of the acceptor medium existing between the gas scrubbing device and the acceptor chamber 7) of the electrodialysis device, wherein from 4) the acceptor solution saturated with the soluble gas is supplied to the acceptor chamber 7) through an inlet, and wherein the acceptor solution from which the soluble gas has been withdrawn and exits from an outlet of the acceptor chamber and is supplied through a conduit into the gas scrubbing device 2); the electrodialysis device is composed of the individual components: 6) the cathode chamber, 7) the acceptor chamber, 8) the uptake and release chamber, 9) the anode chamber, and 10) the separation medium (membrane) (not shown are the ion-selective separation membranes that close off the electrode chambers); 11) represents a circulation of the uptake and release medium, in which, after uptake of the electrophoretically transported gas from the acceptor chamber, the uptake and release medium is conveyed through an outlet into the release device 12), in which degassing of the uptake and release medium and release of the transported gas takes place, and for which the degassed uptake and release medium is then reintroduced via an inlet into the chamber 8); the gas released in 12) is collected in the gas collection device 13) and can be stored therein.

### EXAMPLES

All investigations were performed with deionized water (DI water) at normal pressure conditions (101.3 kPa) and room temperature (20° C.), unless otherwise stated.

### Example 1

A 0.5 molar arginine solution prepared using deionized water is placed in a gas wash device. A constant flow of carbon dioxide gas is passed through the device for 10 hours, and the pH of the solution is continuously determined. When the pH of the solution fell below 9, arginine in powdered form was added to the liquid and dissolved using a mixing unit placed in the device. This was repeated until a total molar concentration of arginine of 3 mol/l was present in the solution. Upon reaching a pH of 8, which was associated with the simultaneous presence of a clear liquid without solids, gas introduction was terminated. A part of the solution was removed for long-term experiments and stored in a device for closed containment of a gas under ambient pressure conditions (101.3 kPa) at a temperature of 20° C. Here, the volume of gas released/evolved from the solutions that had been stored for a period of 3 and 6 months was determined. At the end of the long-term experiments, as well as in the case of the sample that was present after the end of the experiment, these solutions were filled into a gas collection device and HCl was added and mixed until a pH of 1 was reached. The molar mass was determined from the determined volume of the gas released/evolved and the concentration of carbon dioxide present in it, and the relation to the molar concentration of the arginine present in the solution was calculated. The experiments were repeated 3 times. Subsequently, the solutions were purified in an electrodialysis unit from the chloride and hydrogen ions present herein until a solution pH of 12.5 was obtained. These solutions were used for further repeat experiments, with loading of carbon dioxide into the acceptor solution, until a solution pH of 8 was reached. This is followed by determination of the amount of carbon dioxide gas that was bound in the solution on 3 samples using the procedure described previously.

### Results

The molar ratio present at a solution pH at 8 between carbon dioxide and arginine bound in the solution ranged from 0.96 to 1.01. Over the course of 3 and 6 months, a carbon dioxide fraction between 0.1 and 0.3 vol % was released/evolved. The solutions remained clear during the course. When the experiment was repeated with the arginine solutions regenerated by electrodialysis, the proportions of carbon dioxide bound were not different from those in the first experiment.

### Example 2

Flue gases from a cement production plant and from a wood chip combined heat and power (CHP) plant with carbon dioxide contents of 11.2 and 16.9 vol % were passed through a gas scrubbing column.

Before entering the scrubbing column, the flue gases were passed through a soot filter. The first section of the scrubbing column contained as scrubbing medium a 50% ammonium nitrate solution acidified with nitric acid to a pH of 5. The gas stream was then passed through an aerosol filter. The second section of the gas scrubbing column had a gas inlet device filled with an arginine solution, with gas discharge into the acceptor liquid through a nanoporous finned ceramic membrane (Kerafol, Germany) with a total surface area of 60 m², located at the bottom of the chambers and through which the flu gases were introduced, with the average size of the gas bubbles discharged ranging from 1 to 20 μm.

This column section consisted of 10 consecutively arranged chamber segments, in each of which the gas phase that collected above the liquid level was fed via a pipe to the inlet of the gas inlet device of the next chamber segment. The acceptor solution in the scrubbing column was passed through the segments in a countercurrent process. The purified gas mixture was collected and the concentration of carbon dioxide determined. The experiments were carried out with different concentrations of arginine between 0.1 and 0.5 mol/l and volume flows from 100 ml to 1,000 ml/min. Furthermore, the volume flow of the flue gas to be purified was varied between 200 cm³ and 1 m³/minute. The contact time was calculated within which a depletion of the carbon dioxide to a concentration range of <0.01 Vol % (100 ppm) was achieved. The contact time therefor was calculated for an average gas bubble size of 10 μm.

### Results

Removal of carbon dioxide content to <100 ppm was achieved for both flue gas mixtures. This was possible under all experimental conditions, with a mean contact time between the acceptor solution and the gas mixture to be purified, which depended on the selected arginine concentration and ranged from 1 second to 33 seconds.

### Example 3

A continuous separation of carbon dioxide from gas mixtures was performed, which was carried out by a process arrangement consisting of a separation unit for carbon dioxide and a release unit for carbon dioxide. For this purpose, a flue gas, a gas mixture from biogas production and technical gases with carbon dioxide concentrations between 3.5 and 65 vol % were used. These were passed through the scrubbing column described in Example 2 at a flow rate of between 500 cm³ and 1.5 m³/hour. The gas that has been passed through was collected and the concentration of carbon dioxide was determined. In the acceptor solution, arginine was present dissolved at a concentration of 0.5 mol/l (deionized water was used for dissolution). The acceptor solution enriched with carbon dioxide in the scrubbing column was fed into an electrodialysis unit composed of 12 consecutive dialysis chamber units, each consisting of an acceptor chamber and an uptake and release chamber. The introduction was made into the cathode chamber, where the cathode was located. The acceptor liquid was passed consecutively through the adjacent acceptor chamber. The acceptor liquid discharged on the anode side was returned to the gas scrubbing column for acceptor liquid inlet. Thus, a circulation was established between the gas scrubbing column and the electrodialysis unit, with a flow rate between 500 ml and 1.5 l/min. The uptake and release chambers of the electrodialysis unit were interconnected so that a constant filling of the chambers with the uptake and release medium could be ensured. Above the liquid level of the uptake and release medium, there was a reservoir for releasing/evolving gas, which was conducted into a large-volume external gas reservoir. Between the cathode chamber and the acceptor chamber, as well as between the uptake and/or release chamber, there were mesoporous ceramic separation membranes that were hydrophobically surface-coated (water contact angle >120°). The adjacent dialysis chamber unit was separated in a pressure-stable manner by an electron-conducting membrane (bipolar membrane), which was clamped between the acceptor chamber and the uptake and release chambers. The other chamber units were arranged accordingly. The uptake and release medium contained a) glutamic acid (10 g/l) or b) citric acid (100 g/l) in solution. The pH of the uptake and release medium was monitored during electrodialysis. A DC voltage of 20V was applied between the cathode and the anode. The volume of gas released in the uptake and release chambers was determined and the gaseous compounds contained therein were analyzed.

Furthermore, the carbon dioxide concentration present in the gas mixture that had passed through the gas collection device was determined. The contact times required to achieve a reduction of the carbon dioxide concentration to <100 ppm in the gas mixture that had passed through the gas scrubbing column in the respective test setups were calculated. The experimental runs were performed at 20° C. and under normal pressure conditions.

### Results

For all gas mixtures investigated that had been treated by means of the device arrangement, the carbon dioxide concentration could be reduced to <100 ppm. The contact time required for this ranged from 0.5 seconds to 2 minutes and was largely dependent on the carbon dioxide concentration of the initial gas mixture and the flow rate of the acceptor fluid through the electrodialysis unit. The gas released in the uptake and release chambers of the electrodialysis unit had a carbon dioxide content of >99 vol %. The calculated mass of carbon dioxide that was in the separated gas volume was equal to the calculated mass of carbon dioxide that had been removed from the initial gas mixtures.

### Example 4

The chemical convertibility of carbon dioxide or carbonate/hydrogen carbonate anions, which were present dissolved or bound in an acceptor medium, was investigated. For this purpose, aqueous solutions containing the acceptor compounds arginine and lysine or histidine in a concentration of 0.1 to 0.5 mol/l were used as acceptor solutions, the solution being made with deionized water. Carbon dioxide was introduced by means of a gas scrubbing column according to example 2, applying a flue gas with a carbon dioxide content of 22% by volume for the extraction of carbon dioxide. As a variation from the experimental procedure in Example 2, according to Example 1, with continuous recording of the pH, the acceptor compounds used were added in solid (powder) form if the pH of the acceptor solution had dropped by more than 1 compared with the output due to the uptake of carbon dioxide. The addition was terminated when a total of 3 mol/l of the respective acceptor compound was completely dissolved and a clear solution was present. A catalyst (ruthenium complex immobilized on MCM-41) was affixed on PU meshes using an adhesive. These nets were mounted in the acceptor chambers of the electrodialysis units according to Example 3 so that they were circumflushed by the acceptor medium flowing through the acceptor chambers. In deviation from Example 3, an anion exchange membrane with a cut-off of 400 Da was used as the separating membrane between the acceptor chamber and the uptake and release chambers. In this experiment, an arginine solution with a concentration of 0.3 mol/l was used as the uptake and release medium. Furthermore, as a variation from Example 3, the uptake and release medium was circulated in a secondary circuit in which the medium passed through a separating device in which calcium carbonate was added to the solution and then passed into a settling tank in which complexes of the carboxylic acid and calcium complexes transported into the uptake and release medium settled. After passing through a column containing a cation exchange resin, the solution was returned to the anode chambers. Discontinuous removal of the settled solids from the settling tank of the separating device was performed, and the solids were dewatered by centrifugation. The organic acids bound in the centrifugate (white solid) were prepared by extraction with ethanol followed by methylation, followed by gas chromatographic analysis.

During the passage of the acceptor solutions containing carbon dioxide and carbonate/hydrocarbonate anions through the acceptor chambers, electrodialysis was performed with 20V DC voltage applied between the anode and cathode.

### Results

The flue gas could be purified from the carbon dioxide content to a level of <100 ppm. The uptake and transport was carried out by means of acceptor solutions in which basic amino acids were present in solution. The concentration of these amino acids in the solution could be increased significantly above the respective solubility limit of the amino acids used in neutral water by the uptake of carbon dioxide into the solutions. This allowed high concentrations of carbon dioxide and carbonate/hydrogen carbonate anions in the aqueous acceptor solutions to be obtained.

By means of an alcoholic extraction from the separated calcium complexes of the secondary circuit, formic acid could be detected, which was present in high concentrations. It could thus be shown that, on the one hand, a chemical conversion of the carbon dioxide present in the acceptor solution as well as its derivatives was achieved and, and on the other hand, that the resulting carboxylic acids had been transported into the uptake and release medium by means of electrodialysis.

### Example 5

Investigation into the conversion of carbon dioxide to carbonates.

Preparations are made of 1 liter of a 2 molar arginine solution with deionized water, and 200 g of sodium chloride (A) and calcium chloride (B), respectively, is added and dissolved. Carbon dioxide is added to the solutions in a gassing apparatus according to Example 2. The pH of the solution is monitored. The gas application is stopped after 30 minutes and the solutions are allowed to stand for 24 hours. The supernatant was then completely decanted and the resulting solid was suspended with 100 ml of deionized water. The suspension was then centrifuged. The washing step was repeated 2 more times. The obtained centrifugates are spread on ceramic filter plates and dried at room temperature. The dried solids are subjected to solid-state NMR analysis. In addition, to detect the presence of carbonates, chemical decomposition was performed using a concentrated HCl solution added to the respective powder (3 g) in a glass flask under a nitrogen atmosphere. The resulting gas was passed through a CO₂ analyzer. The decanted supernatants were treated by electrodialysis using an anion selective membrane.

### Results

The solutions were transparent initially. After a gas application period of 2 minutes, a milky, turbid acceptor solution was evident and rapidly continued in intensity. The pH decreased during gas application from 12.4 (A) and 11.8 (B) to 8.6 (A) and 8.3 (B), respectively. After 24 hours, a white solid layer had sedimented in both reaction vessels, and the supernatant was clear in each case. The solids were obtained as fine white powders after drying. Carbon dioxide was released during acid catalytic decomposition. In NMR analysis, sodium carbonate (A) as well as calcium carbonate (B) were found, and no other elements or compounds were present. Electrodialysis of the supernatants resulted in removal of the chloride ions contained herein with release of chlorine at the anode. The pH of the respective supernatant solutions thereby rose to the level of the respective starting solution.

### Example 6

Investigation into the conversion of carbon dioxide to carbonates.

In each case, 1 liter of a 2 molar arginine solution was prepared. These were each gassed for 1 hour with carbon dioxide according to Example 2. Furthermore, 1 liter of a 1 molar arginine solution was prepared in each case and (A) aluminum chloride or (B) ferric chloride, respectively, was dissolved in it until the pH of the solution was 8.

The solutions were each added to one of the arginine solutions saturated with carbon dioxide under stirring. This was followed by centrifugation. The supernatant was then completely decanted and the resulting solid was suspended in 100 ml of deionized water. The suspension was then centrifuged. The washing step was repeated 2 more times. The obtained centrifugates were dried on ceramic filter plates at room temperature. Chemical decomposition of 2 g of each of the powders was performed according to Example 5. The dried solids were decomposed at 900° C. and the residues were subjected to elemental analysis.

### Results

When the solutions containing aluminum or iron ions were mixed into an acceptor solution saturated with carbon dioxide, white or rust-colored solids formed. These could be completely separated by centrifugation, and the supernatant was clear. After washing out soluble compounds and drying, dried solid aggregates were obtained, which could be ground to a fine powder in a mortar. Acid catalytic decomposition released carbon dioxide. Thermal decomposition released the bound carbon dioxide. In the elemental analysis, only aluminum oxide (A) or iron oxide (B) could be detected.

### Example 7

Investigation on the recovery of pure gases.

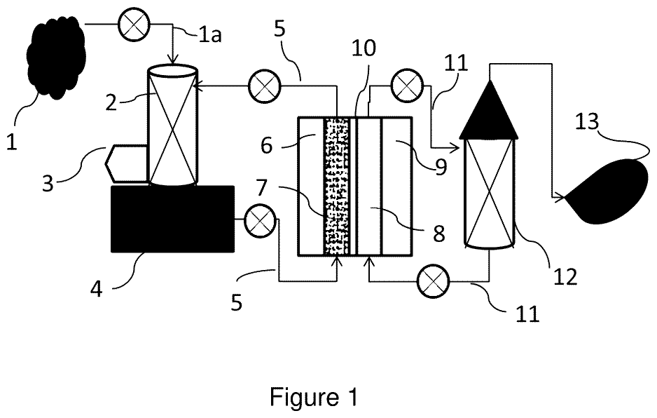

For the absorption and extraction of carbon dioxide, a gas scrubbing apparatus containing packed beds continuously sprayed with an acceptor solution was used (FIG. 1: 2)). A partial flow of a biogas with a volume flow of 100 m³/h was passed through this apparatus (FIG. 1: 2)). The packing was subjected to a volume flow of the acceptor solution of 1001/min. For this purpose, the acceptor solution from feed tank 1 was used (FIG. 1: 4)). The acceptor solution used for gas scrubbing was fed from the gas scrubbing unit to an electrodialysis unit for desorption of the carbon dioxide bound in the acceptor solution (FIG. 1: 5)). This consisted of a catholyte (FIG. 1: 6)) and an anolyte chamber (FIG. 1: 9)) as well as an alternating arrangement of a chamber for receiving the acceptor solution (FIG. 1: 7)) and a chamber for receiving the uptake and release medium (FIG. 1: 8)). The latter were separated by a bipolar membrane (FIG. 1: 10)), while the anode chamber was connected to the first acceptor chamber with an anion-selective membrane and the cathode chamber was connected to the last uptake and release chamber with a cation-selective membrane, respectively. The total area of the bipolar membranes was 10 m².

An arginine solution with a concentration of 2 mol/l was chosen as the acceptor solution. The acceptor solution was heated to a temperature between 34 and 56° C. during the absorption process. A 10 wt % citric acid solution was used as the uptake and release medium. The volume ratio between the acceptor medium and the uptake medium flowing through the dialysis unit was 2:1. A DC voltage of 20V was applied between the anode and the cathode.

The chamber devices for receiving the uptake and release media were provided with an outlet for gases which were connected to an initial evacuated gas collection device. The storage vessel for the uptake and release medium was also connected to this collecting device, so that gas that evolved could be collected therein without pressure. The CO₂ content of the gas streams that passed through the gas scrubber and of the gas that was collected in the gas collection device were continuously determined.

### Results

The treated biogas had a CO₂ content of 48% by volume. The gas that has passed through the gas scrubber had a CO₂ content of 0.002 vol % and a methane content of 99.1 vol %.

During the continuous gas scrubbing and passage of the acceptor medium through the electrodialysis unit, CO₂ was released (evolved) in both the uptake and release chambers and in the storage vessel for the uptake and release medium. The CO₂ content of the released and collected gas was >98.5 vol %; methane was not detected herein. Continuous operation was possible for more than 8 hours without any disturbances. There was no relevant heating of the process media.

### Example 8

Investigation on the production of carbonates.

Five liters of a 2 molar arginine solution were prepared with deionized water; 500 g iron(Ill) chloride was completely dissolved in this solution. Gaseous CO₂ was passed through the reddish-brown clear solution according to Example 2. Thereby the pH decreased from 9.2 to 8.5. The solution was then clear and contained no solids. Deionized water was then added to the solution at a 1:1 volume ratio and mixed. A flocculent light brown solid immediately formed which slowly sedimented. The decanted supernatant was transparent and had a slight reddish tint. The sediment phase was centrifuged and the supernatant was combined with the previously decanted supernatant (WP 1). The centrifugate was suspended in 3 liters each of deionized water and stirred for one hour. Phase separation by centrifugation was then performed in each case. The brown-reddish mass was spread on ceramic filter plates with an average pore size of 200 μm. The filter plates were spread on an absorbent material until the material was completely dry. The crumbly brown material was crushed in a mortar; 480 g of a brown powder was obtained. A sample was suspended in water and agitated therein. Sedimentation of the powder followed. The supernatant was subsequently clear and colorless, and the pH was 6.8, thus unchanged from baseline. A 10% HCl solution was added to another sample of the powder. Foaming occurred, with the release of CO₂. The solution was subsequently red-brownish, and no solid remained. No nitrogen was detected in the analysis of this decomposition solution. Thus, the powder obtained corresponded to iron carbonate. WP1 was passed through an electrodialysis unit. An anion-selective membrane was used to terminate the donor chambers on the anode side, and a cation-selective membrane was used to seal the cathode side. A DC voltage of 10V was applied. It was shown that chlorine gas was released in the anode chamber and hydrogen in the cathode chamber. Following electrodialysis, the solution was gassed with CO₂. Following the gassing, the CO₂ bound in the solution could be released/evolved again by changing the pH using an acid (HCl).

### Example 9

Production of carbonates in a secondary loop process.

A partial gas stream (10 m³/h) of a bioreactor of a municipal wastewater treatment plant was withdrawn by means of a water jet pumping device and brought into contact with the aqueous acceptor medium. The water/gas mixture was fed via a pipe to and passed through a static mixer. The mixture then entered a collection tank from which the gas was allowed to escape freely into the atmosphere. The aqueous acceptor medium was present as a 2 molar arginine solution. From the collection tank, the acceptor medium loaded with carbon dioxide was continuously pumped into a secondary circuit. The secondary circuit consisted of an electrodialysis device consisting of an anode chamber, a cathode chamber and 10 consecutive chamber units in the arrangement: acceptor chamber/reaction chamber/electrolyte chamber. The acceptor chambers were consecutively perfused by the acceptor medium and then fed to the water jet pumping device.

The reaction medium and the electrolyte solution were each taken from a storage tank and passed through the reaction chambers and the electrolyte chambers, respectively.

The acceptor chambers were separated from the reaction chambers on the anode side by an anion-selective membrane. On the cathode side, they were separated from the electrolyte chambers by a bipolar membrane. The reaction chambers and the electrolyte chambers were separated by a cation-selective membrane. The chamber units for the reaction medium were adjacent to the electrolyte chambers on the anode side. Different reaction media were investigated. For this purpose, the following reaction solutions were prepared from a 1 molar arginine solution in each case: a) 30% magnesium chloride solution, b) 20% copper chloride solution, c) 15% aluminum chloride solution. The reaction medium was continuously recirculated from a settling tank through the reaction chambers in each case. The reaction chambers were designed so that the reaction medium flowed vertically through the chamber and was discharged through a conical bottom outlet into the collection tank, thereby discharging any solids generated along with it. After each experimental run, which was performed for 5 hours each, no further agitation of the reaction medium was performed for 12 hours. The aqueous supernatant was then drained through an outlet placed above the sediment phase, after which the sediment was removed and rinsed 2 times with deionized water and then dried on a contact belt dryer.

The electrolyte solution was fed in a tertiary circuit to another electrodialysis unit, where chloride ions were separated.

Detection of the respective carbonates obtained as solids was performed according to the procedures in Example 6.

### Results

The temperature range of the acceptor medium ranged between 45 and 75° C. The sewage gas had a carbon dioxide content of 26 vol %. By bringing the sewage gas into contact with the acceptor medium, the carbon dioxide content was reduced to <0.01 vol %. After the acceptor medium began to flow through the electrodialysis unit, the reaction solutions rapidly became milky and a continuous precipitation of solids occurred in each case. Analysis of the rinsed and dried solids showed that they were the carbonates of the cations of the electrolyte used in each case. Thus, magnesium carbonate, copper carbonate and aluminum carbonate were formed.

### Example 10

Investigation into the utilization of residual materials of organic and inorganic origin by conversion with carbon dioxide/carbon dioxide derivatives in a regenerative cycle process to obtain regenerative raw material fractions.

Used aluminum cans (100 g) in crushed form were completely decomposed in 200 ml of concentrated sulfuric acid by adding deionized water proportional to the amount of hydrogen and water vapor that escaped. The vapor/gas mixture was collected and the hydrogen separated. The solution obtained was gray-brownish and highly turbid. The solution was filtered using a glass frit and mixed with 600 ml of a 1 molar solution of arginine. This mixture was stirred in portions into a 3 molar arginine solution that was saturated with carbon dioxide from the gas mixture of a biogas plant. After incorporation, the suspension was centrifuged and the centrifugate was rinsed 2 times with deionized water and dried after centrifugation.

A 200 g sample of purified chicken egg shells were decomposed in 500 ml of a 60 wt % hydrochloric acid solution. The evolving carbon dioxide was collected and adsorbed in a 2 molar arginine solution using a device according to Example 2. Organic material, such as eggshell membrane, was present in the resulting turbid solution. This was filtered off and the resulting solution was passed through the electrolyte chamber of an electrodialysis device according to Example 9. The acceptor chamber and the reaction chamber were filled with, and flushed by, the acceptor and reaction media, respectively, according to Example 9. In this process, the acceptor solution had become saturated with the carbon dioxide obtained from the decomposition of the eggshells. The solid formed in the reaction chamber was separated and rinsed 2 times with deionized water and dried convectively after centrifugation. The electrolyte solution of the anode chamber, which was available at the end of the investigation, was concentrated by means of a membrane distillation and used for another experimental procedure. The acceptor solution was also used for the absorption of carbon dioxide during the decomposition of bones. The energy was obtained from solar power during the investigations.

The analysis of the obtained solids was conducted according to Example 6.

### Results

The solid fractions obtained in the two process designs were aluminum carbonate and calcium carbonate. These were present as a chemically pure powder form in the form of amorphous particles. The compounds (acids) used to decompose the starting materials could be regenerated in a secondary circuit and reused for a new test run. The acceptor solution could also be regenerated and reused. Thus, it was possible to recycle inorganic residues, using regenerative carbon dioxide and renewable energy, while enabling a sustainable cycle of the compounds used.

### Example 11

For experimental procedure 1), 50 g of crushed aluminum foil is hydrolyzed with 300 ml of a 35% HCl solution. There is complete conversion at a pH of 1 resulting in a light gray mass. The mass is completely dissolved in 1 liter of deionized water (1A). From this, 150 ml is separated and titrated to a pH of 4 with an ammonia solution under stirring. After 10 minutes, the solution is centrifuged and the supernatant is decanted (1Ü).

For experiment 2), 100 g of aluminum sulfate is dissolved completely in 300 ml of deionized water (2A). Of this, 150 ml is separated and titrated to a pH of 3 with an ammonia solution under stirring. After 10 minutes, the solution is centrifuged and the supernatant decanted (2Ü).

A 2 molar arginine solution (prepared with deionized water) is circulated through a static mixer in which carbon dioxide is added to the solution as a gas phase upstream to the static mixer. Gas is applied without pressure until the acceptor solution reaches a pH of 8.

The chemical conversion is carried out by mixing each of the clear and colorless electrolyte solutions 1A, 1Ü, 2A and 2Ü, respectively, into 1000 ml of the acceptor solution by means of a metering pump until a pH of 7 is reached. If the electrolyte solution in the preparation could not be completely consumed/reacted, the mixing process was continued with fresh saturated acceptor solution. Fifteen minutes after mixing was complete, the reaction mixtures were centrifuged. The supernatants were decanted and combined (V1). The centrifugates obtained for each series of investigations were suspended in 1000 ml of deionized water and agitated in this for 15 minutes. Phase separation by centrifugation was then performed. This procedure was repeated 2 more times. The centrifugates were spread on mesoporous ceramic membranes and left hereon at room temperature for 24 hours. The subsequently dry material was weighed and samples were taken for analysis, which was performed according to examples 5 and 6.

The arginine concentration was determined spectroscopically after addition of a ninhydrin reagent.

### Results

A clear solution was prepared from the hydrolysate obtained from aluminum foil (Experimental Procedure 1). The addition of ammonia resulted in flocculation. The resulting solid could be completely separated by centrifugation. The centrifugate 2 had different color portions: a pure white, somewhat glassy mass at the bottom with a gray-brown solid mass above. In experiment 2, flocculation also occurred when ammonia was added to the electrolyte solution, but the centrifugate was uniformly white and had a gel-like consistency.

With all electrolyte solutions, a white solid could be produced by mixing with the saturated acceptor solution. Visually, the centrifugate phases did not differ from each other. For the mixing according to protocol it was necessary to use 1.6 times (experiment 1) and 1.8 times (experiment 2) of the volume of the acceptor solution for the electrolyte solutions that had not been pretreated with ammonia compared to those that had been pretreated with it, in order to convert the respective total volume of the electrolyte solutions. On the other hand, for 1A and 2A, only 80 and 75 wt % of the amount of solid which could be obtained from 1Ü and 2Ü, respectively, was obtainable.

Chemical analysis showed that the solids obtained were aluminum carbonate and aluminum hydrogen carbonate.

The supernatants after the first centrifugation were purified from electrolytes present herein by electrodialysis. Subsequently, by means of membrane distillation, the volume of liquid was reduced so that the initial concentration of the arginine solution was re-established. This was used to reabsorb carbon dioxide and then to repeat the experimental procedure. Aluminum carbonate and aluminum hydrogen carbonate were obtained with the same efficiency.

### Example 12

Investigation on the cathodic release of gas phases from an aqueous acceptor medium.

A 2 molar arginine solution was prepared with deionized water. Of this, 2 liters were separated and stored under exclusion of air (A0). The remaining acceptor solution was loaded with a gas stream of carbon dioxide according to Example 7. The degree of saturation with carbon dioxide, or its water-soluble derivatives, was monitored via conductivity measurements. The acceptor medium was loaded with carbon dioxide until a conductivity of 150 mSi was reached (A1).

A 20 wt % solution of KOH (K) and NaOH (N) were prepared as stock solutions. From each of these, 2 liters of a) 1 wt %, b) 2 wt %, c) 3 wt % and d) 4 wt % solution were prepared.

To each 2 liters of A1, KOH (A1K) as well as NaOH (A1N) was added as a solid and dissolved so that each of these existed as a) 1 wt %, b) 2 wt %, c) 3 wt % and d) 4 wt % solution. A rectangular glass vessel able to hold 500 ml of liquid was constructed such that a separation device could be mounted in the center to separate the 2 chambers in the vessel from each other. The separation device was a perforated polycarbonate disk with a diameter of 2 mm and a porosity of 70%. A graphite electrode was placed in each of the chambers in a holder that allowed axial displacement of the electrodes, which were arranged in parallel with the separation device. The vessel was sealed gas-tight at the top, with an outlet on the lid for each chamber. These outlets were each connected to a gas collection device, which allowed pressure-less discharge of a gas that formed in the respective chamber. The respective gas volume could thus be quantified.

The vessel had an inlet and outlet at both front ends for filling and for the passage of liquids, respectively. The electrodes were connected to a rectifier.

The vessel was filled consecutively with the various test solutions so that no air remained in it. In the test series 0) the solutions K) and N) were filled into the vessel in the concentrations a)-d), respectively. First, the DC voltage at which a current flow began (Smin) was determined for each solution. Then the voltage at which gas bubbles formed at both electrodes was determined, thus resulting in gas formation. In the experimental series I), the solutions A0 and A1 as well as A1K and A1N were then studied consecutively in the concentrations a)-d). A constant voltage was applied to each of the solutions for 10 minutes, which was at least 1 volt higher than Smin and was a multiple of 2. Every 10 minutes, the voltage was increased by 2 volts up to a voltage of 32 volts. The formation of gas bubbles at the electrodes, the current flow (mA) present at each time, and the amount of gas generated during the current delivery were recorded.

In the experimental series II), for each of the solutions, the test was repeated with the voltage previously determined for the respective solution at which no gas formation had occurred at the cathode, wherein the vessel containing the respective solution was perfused so that there was a flow through the separation medium from the cathode chamber to the anode chamber. The gas released and collected in the cathode chamber was analyzed for chemical composition.

### Results (See Table 1a and Table 1b)

In experimental series I), electrolysis occurred in a concentration-dependent manner for solutions K and N, resulting in hydrogen and oxygen formation starting at a voltage between 2-4V. In the case of solution A0, there was no current flow up to 24 V and there was no electrolysis leading to the formation of a gas phase up to 32V. In case of solution A1, current flow was present starting at 12V; gas formation at the cathode began at a voltage of 20V. Gas formation at the anode did not occur even at a voltage of 32V. For solutions A1K and A1N, there was a decrease in Smin with increasing concentration. Furthermore, as a function of concentration, the voltage which led to the formation of gas at the cathode decreased. Also with these solutions, no measurable amount of oxygen was formed at the anode. The gas formed at the cathode in solutions A1 and A1K and A1N corresponded to carbon dioxide. Here, the amount of gas that became available at an identical voltage system was considerably greater for A1K and A1N than for A1 and increased with the concentration of the added electrolyte.

In the series of experiments II), the amount of carbon dioxide released at the cathode increased by 20-40 Vol % due to the perfusion of the vessel with the solutions A1, A1K and A1N.

TABLE 1a

| V-no. | V | AL native | AL-CO2 | NaOH | K | A |
|---|---|---|---|---|---|---|
| V0 | 2 | 1 | | 1% | 0 | 0 |
| V0 | 4 | 1 | | 1% | 1.2 | 0.4 |
| V0 | 6 | 1 | | 1% | 6.5 | 2.2 |
| V0 | 8 | 1 | | 1% | 12 | 4.5 |
| V0 | 2 | 1 | | 2% | 0 | 0 |
| V0 | 4 | 1 | | 2% | 5 | 1.6 |
| V0 | 6 | 1 | | 2% | 8.2 | 3.2 |
| V0 | 8 | 1 | | 2% | 18.5 | 5.5 |
| V0 | 2 | 1 | | 3% | 0.7 | 0.3 |
| V0 | 4 | 1 | | 3% | 10.8 | 4.2 |
| V0 | 6 | 1 | | 3% | 18.2 | 7.4 |
| V0 | 8 | 1 | | 3% | 28 | 10 |
| V0 | 2 | 1 | | 4% | 1.2 | 0.5 |
| V0 | 4 | 1 | | 4% | 11 | 5.8 |
| V0 | 6 | 1 | | 4% | 23 | 8.8 |
| V0 | 8 | 1 | | 4% | 36 | 12.8 |
| A1 | 2-20 | 1 | | | 0 | 0 |
| A1N a)-d) | 2-20 | 1 | | 1%-4% | 0 | 0 |
| A1 | 2-20 | | 1 | | 0 | 0 |
| A1 | 32 | | 1 | | 4.2 | 0 |
| A1N a) | 2-14 | | 1 | 1% | 0 | 0 |
| A1N a) | 16 | | 1 | 1% | 4.8 | 0 |
| A1N a) | 24 | | 1 | 1% | 10.2 | 0 |
| A1N b) | 2-6 | | 1 | 2% | 0 | 0 |
| A1N b) | 8 | | 1 | 2% | 7.2 | 0 |
| A1N b) | 12 | | 1 | 2% | 12.4 | 0 |
| A1N c) | 2-4 | | 1 | 3% | 0 | 0 |
| A1N c) | 6 | | 1 | 3% | 6.8 | 0 |
| A1N c) | 12 | | 1 | 3% | 18.2 | 0 |
| A1N d) | 2 | | 1 | 4% | 0 | 0 |
| A1N d) | 4 | | 1 | 4% | 2.6 | 0 |
| A1N d) | 6 | | 1 | 4% | 8.8 | 0 |
| A1N d) | 8 | | 1 | 4% | 16.8 | 0 |

V-no. = experiment number, V = applied DC voltage in volts; AL native = acceptor solution without loading with carbon dioxide; AL-CO2 = acceptor solution loaded with carbon dioxide; NaOH = concentration of sodium hydroxide in the acceptor solution in wt %; KOH = concentration of potassium hydroxide in the acceptor solution in wt %; K = gas volume formed in the cathode chamber within the experimental period in ml at normal pressure; A = gas volume formed in the anode chamber within the experimental period in ml at normal pressure.

TABLE 1b

| V-no. | V | AL native | AL-CO2 | KOH | K | A |
|---|---|---|---|---|---|---|
| V0 | 2 | 1 | | 1% | 0 | 0 |
| V0 | 4 | 1 | | 1% | 1.6 | 0.6 |
| V0 | 6 | 1 | | 1% | 11.2 | 4.4 |
| V0 | 8 | 1 | | 1% | 16.5 | 6.7 |
| | | 1 | | | | |
| V0 | 2 | 1 | | 2% | 0 | 0 |
| V0 | 4 | 1 | | 2% | 5.8 | 2.6 |
| V0 | 6 | 1 | | 2% | 12.8 | 6.3 |
| V0 | 8 | 1 | | 2% | 22.4 | 9.5 |
| | | 1 | | | | |
| V0 | 2 | 1 | | 3% | 1.1 | 0.6 |
| V0 | 4 | 1 | | 3% | 12.3 | 6 |
| V0 | 6 | 1 | | 3% | 18.2 | 7.4 |
| V0 | 8 | 1 | | 3% | 28.1 | 12.9 |
| V0 | 2 | 1 | | 4% | 1.6 | 0.7 |
| V0 | 4 | 1 | | 4% | 14.3 | 6.2 |
| V0 | 6 | 1 | | 4% | 22.5 | 11.1 |
| V0 | 8 | 1 | | 4% | 32.2 | 16.2 |
| A1 | 2-20 | 1 | | | 0 | 0 |
| A1K a)-d) | 2-20 | 1 | | 1%-4% | 0 | 0 |
| A1 | 2-20 | | 1 | | 0 | 0 |
| A1 | 32 | | 1 | | 4.2 | 0 |
| A1K a) | 2-8 | | 1 | 1% | 0 | 0 |
| A1K a) | 10 | | 1 | 1% | 1.4 | 0 |
| A1K a) | 12 | | 1 | 1% | 4.6 | 0 |
| A1K a) | 14 | | 1 | 1% | 8.4 | 0 |
| A1K b) | 2-4 | | 1 | 2% | 0 | 0 |
| A1K b) | 6 | | 1 | 2% | 5.2 | 0 |
| A1K b) | 8 | | 1 | 2% | 10.6 | 0 |
| A1K b) | 10 | | 1 | 2% | 14.8 | |
| A1K c) | 2-4 | | 1 | 3% | 0 | 0 |
| A1K c) | 6 | | 1 | 3% | 7.8 | 0 |
| A1K c) | 8 | | 1 | 3% | 14.2 | 0 |
| A1K c) | 10 | | 1 | 3% | 19.4 | |
| A1K d) | 2 | | 1 | 4% | 0 | 0 |
| A1K d) | 4 | | 1 | 4% | 3.6 | 0 |
| A1K d) | 6 | | 1 | 4% | 11.4 | 0 |
| A1K d) | 8 | | 1 | 4% | 22.5 | 0 |

V-no. = experiment number, V = applied DC V0ltage in V0lts; AL native = acceptor solution without loading with carbon dioxide; AL-CO2 = acceptor solution loaded with carbon dioxide; NaOH = concentration of sodium hydroxide in the acceptor solution in wt %; KOH = concentration of potassium hydroxide in the acceptor solution in wt %; K = gas V0lume formed in the cathode chamber within the experimental period in ml at normal pressure; A = gas V0lume formed in the anode chamber within the experimental period in ml at normal pressure.

1-15. (canceled)

16. A method for selectively binding, transporting and storing carbon dioxide in aqueous media, characterized by the steps of:
(a) providing an aqueous acceptor solution containing at least one acceptor compound having a free guanidino and/or amidino group,
b) contacting a gas containing carbon dioxide with the acceptor solution from step a),
c) storing the acceptor solution containing bound carbon dioxide/carbon dioxide derivatives from step b) for at least 6 months without pressurization of the acceptor solution.

17. The method according to claim 16, wherein the acceptor compound is an amino acid and the pH of the acceptor solution is in a range between 8 and 13.

18. The method according to claim 16, wherein in step b) the contacting is performed without pressurization of the acceptor solution.

19. The method according to claim 16, wherein step c) is followed by: releasing the carbon dioxide bound in the acceptor solution as a gas phase.

20. The method according to claim 16, wherein step c) comprises:
c) storing the acceptor solution containing bound carbon dioxide from step b) in a storage container,
wherein the acceptor solution from step c) is stored at atmospheric pressure in the storage container.

21. The method according to claim 16, wherein step c) is followed by
transporting bound carbon dioxide/carbon dioxide derivatives in the acceptor solution through a separation membrane into an aqueous uptake and release medium.

22. The method according to claim 20, wherein the acceptor solution from step c) is introduced into an acceptor chamber of an electrodialysis device and the transport of carbon dioxide/carbon dioxide derivatives is performed by means of an electrical gradient established between the acceptor chamber and an uptake and release chamber, wherein the acceptor chamber(s) and the uptake and release chamber(s) are separated from each other by a separation membrane.

23. The method according to claim 21, wherein the separation membrane is a membrane permeable to ions and/or gas molecules.

24. The method according to claim 22, wherein a release of the carbon dioxide/carbon dioxide derivatives transported through the separation membrane in form of a pure carbon dioxide gas with >98.5 vol. % carbon dioxide is performed in the uptake and release chamber.

25. The method according to claim 22, wherein the uptake and release chamber contains an uptake and release medium containing at least one compound having at least one acid group and having an isoelectric point in the range between 3 and 5.

26. The method according to claim 16, wherein, after step c), the carbon dioxide bound in the acceptor solution is converted to a carbon compound by means of a reaction compound.

27. The method according to claim 21, wherein the carbon dioxide bound in the uptake and release medium is converted into a carbon compound by means of a reaction compound.

28. The method according to claim 21, wherein step c) is followed by steps c3′) and c3):
c3′) introducing the aqueous uptake and release medium containing bound carbon dioxide/carbon dioxide derivatives from step c) into a release device; and
c3) releasing carbon dioxide as a gas phase from the uptake and release medium containing bound carbon dioxide/carbon dioxide derivatives from step c3′) in the uptake and release chamber.

29. The method according to claim 16 in which cathodic separation of carbon dioxide as a pure gas phase from the aqueous acceptor solution is performed.

30. The method according to claim 16 wherein the gas containing carbon dioxide is washed by means of an acidic solution before step b).

31. The method according to claim 16, wherein step b) further comprises:
depressurizing the acceptor solution containing bound carbon dioxide/carbon dioxide derivatives at atmospheric pressure or at reduced pressure.

32. The method according to claim 26, wherein the reaction compound is an aluminum salt.

33. The method according to claim 26, wherein the reaction compound is aluminum chloride.

34. The method according to claim 27, wherein the reaction compound is an aluminum salt.

35. The method according to claim 27, wherein the reaction compound is aluminum chloride.
